(19) United States
(12) Patent Application Publication
(10) Pub. No.: US 2020/0054166 A1
(43) Pub. Date: Feb. 20, 2020

(54) AUTOMATED, COMPUTER-CONTROLLED, COOKING SYSTEM AND METHOD

(71) Applicant: GENIE ENTERPRISE LTD, Rishpon (IL)

(72) Inventors: Doron MARCO, Tel Aviv (IL); Ayelet CARASSO, Tel Aviv (IL)

(73) Assignee: GENIE ENTERPRISE LTD, Rishpon (IL)

(21) Appl. No.: 16/485,689

(22) PCT Filed: Feb. 15, 2017
(86) PCT No.: PCT/IL17/50195

§ 371 Date: Aug. 13, 2019

(51) Int. Cl. A47J 36/32; A47J 27/00; A47J 36/16; A47J 27/06; A47J 27/024

(52) U.S. Cl. CPC A47J 36/321; A47J 27/004; A47J 27/024; A47J 27/06; A47J 36/165

(57) ABSTRACT

An automated, computer-controlled, cooking system for use with user selectable ones of a plurality of different pre-sealed computerized cooking containers containing dry contents (PSCCCCDC) useful in preparing corresponding different food products, the system including a microwave heater, a PSCCCCDC support for supporting a user-selected one of the plurality of different PSCCCCDCs during cooking, a computer-controlled liquid supply subsystem for supplying liquid to the user selected one of the plurality of different PSCCCCDCs, a computer-controlled stirrer subsystem for producing stirring of the dry contents of the PSCCCCDC together with the liquid and a computer controller operative to control operation of at least the computer-controlled liquid supply subsystem, the computer-controlled stirrer subsystem and the microwave heater in a predetermined sequence corresponding to and specifically adapted for cooking the contents of the user-selected one of the plurality of different PSCCCCDCs.

### REFERENCE TO RELATED APPLICATIONS

Reference is hereby made to the following U.S. Patent Applications, the disclosures of which are hereby incorporated by reference:

U.S. patent application Ser. No. 14/208,670 entitled AUTOMATED ON DEMAND BAKING SYSTEM, filed Mar. 13, 2014; and

U.S. patent application Ser. No. 14/942,149 entitled APPARATUS FOR RAPID HEATING OF LIQUIDS, filed Nov. 16, 2015.

### FIELD OF THE INVENTION

The present invention relates to automated cooking systems and methodologies generally and to meal precursors specifically constructed for use in such automated cooking systems and methodologies.

### BACKGROUND OF THE INVENTION

Various types of automated cooking systems and methodologies are known.

### SUMMARY OF THE INVENTION

The present invention seeks to provide improved automated cooking systems and methods.

There is thus provided in accordance with a preferred embodiment of the present invention an automated, computer-controlled, cooking system for use with user selectable ones of a plurality of different pre-sealed computerized cooking containers containing dry contents (PSCCCCDC) useful in preparing corresponding different food products, the system including a microwave heater, a PSCCCCDC support for supporting a user-selected one of the plurality of different PSCCCCDCs during cooking, a computer-controlled liquid supply subsystem for supplying liquid to the user selected one of the plurality of different PSCCCCDCs, a computer-controlled stirrer subsystem for producing stirring of the dry contents of the PSCCCCDC together with the liquid and a computer controller operative to control operation of at least the computer-controlled liquid supply subsystem, the computer-controlled stirrer subsystem and the microwave heater in a predetermined sequence corresponding to and specifically adapted for cooking the contents of the user-selected one of the plurality of different PSCCCCDCs.

Preferably, the predetermined sequence defines a computer implementable cooking protocol which includes a sequence of cooking sub-protocols each of which defines at least one parameter relating to operation of the microwave heater and at least one of a parameter relating to operation of the computer-controlled liquid supply subsystem and at least one parameter relating to operation of the computer-controlled stirrer subsystem. Additionally or alternatively, the predetermined sequence defines a computer implementable cooking protocol which includes a sequence of cooking sub-protocols each of which defines at least one parameter relating to operation of the microwave heater and at least one parameter relating to operation of the computer-controlled liquid supply subsystem.

In accordance with a preferred embodiment of the present invention the predetermined sequence defines a computer implementable cooking protocol which includes a sequence of cooking sub-protocols each of which defines at least one parameter relating to operation of the microwave heater and at least one parameter relating to operation of the computer-controlled stirrer subsystem. Alternatively or additionally, the predetermined sequence defines a computer implementable cooking protocol which includes a sequence of cooking sub-protocols each of which defines at least one parameter relating to operation of the microwave heater, at least one parameter relating to operation of the computer-controlled liquid supply subsystem and at least one parameter relating to operation of the computer-controlled stirrer subsystem.

In accordance with a preferred embodiment of the present invention the computer-controlled liquid supply subsystem for supplying liquid to the user selected one of the plurality of different PSCCCCDCs includes a first water pump for pumping cold water and at least one second water pump for pumping heated water. Additionally or alternatively, the computer-controlled liquid supply subsystem for supplying liquid to the user selected one of the plurality of different PSCCCCDCs includes a heated water and/or steam generator.

Preferably, the computer-controlled stirrer subsystem for producing stirring of the dry contents of the PSCCCCDC together with the liquid is operative to effect stirring of contents of the user selected PSCCCCDC only by moving the PSCCCCDC. Preferably, the computer-controlled stirrer subsystem for producing stirring of the dry contents of the PSCCCCDC together with the liquid includes a rotary drive motor and a linkage which are together operative to displace the PSCCCCDC support in reciprocal motion. Additionally or alternatively, the computer-controlled stirrer subsystem for producing stirring of the dry contents of the PSCCCCDC together with the liquid includes a PSCCCCDC rotator which is operative to displace the PSCCCCDC in rotational motion relative to the PSCCCCDC support.

There is also provided in accordance with another preferred embodiment of the present invention an automated, computer-controlled, cooking system for use with user selectable ones of a plurality of different pre-sealed computerized cooking containers containing dry contents (PSCCCCDCs) useful in preparing corresponding different food products, the system including a microwave heater and a PSCCCCDC support for supporting a user selected one of the plurality of different PSCCCCDCs during cooking and including a passive, microwave heatable portion, which is positioned for conduction heating of the PSCCCCDC.

Preferably, the passive, microwave heatable portion includes a layer of silicon carbide. Additionally or alternatively, the automated, computer-controlled, cooking system also includes a computer-controlled liquid supply subsystem for supplying heated liquid to the user selected one of the plurality of different PSCCCCDCs.

In accordance with a preferred embodiment of the present invention the automated, computer-controlled, cooking system also includes a computer-controlled stirrer subsystem for producing stirring of the dry contents of the PSCCCCDC together with the liquid by moving the PSCCCCDC support. Alternatively or additionally, the automated, computer-controlled, cooking system also includes a computer controller operative to control operation of at least the microwave heater in a predetermined sequence corresponding to and specifically adapted for cooking the contents of the user-selected one of the plurality of different PSCCCCDCs.

Preferably, the PSCCCCDC support includes a passive, microwave heatable portion, which is positioned for conduction heating of the PSCCCCDC. Additionally, the passive, microwave heatable portion includes a layer of silicon carbide.

In accordance with a preferred embodiment of the present invention the automated, computer-controlled, cooking system also includes a computer-controlled liquid supply subsystem for supplying heated liquid to the user selected one of the plurality of different PSCCCCDCs.

In accordance with a preferred embodiment of the present invention the automated, computer-controlled, cooking system also includes a computer-controlled stirrer subsystem for producing stirring of the dry contents of the PSCCCCDC together with the liquid by moving the PSCCCCDC support.

Preferably, the automated, computer-controlled, cooking system also includes a computer controller operative to control operation of at least the microwave heater in a predetermined sequence corresponding to and specifically adapted for cooking the contents of the user-selected one of the plurality of different pre-sealed PSCCCCDCs.

There is further provided in accordance with yet another preferred embodiment of the present invention an automated, computer-controlled, cooking system for use with user selectable ones of a plurality of different pre-sealed computerized cooking containers containing dry contents (PSCCCCDC) useful in preparing corresponding different food products, the system including a microwave heater, a PSCCCCDC support for supporting a user selected one of the plurality of different PSCCCCDCs during cooking, a computer-controlled liquid supply subsystem for supplying liquid to the user selected one of the plurality of different PSCCCCDCs and a computer-controlled stirrer subsystem external of the PSCCCCDC support for accelerating the PSCCCCDC and thus producing stirring of the dry contents of the PSCCCCDC together with the liquid.

Preferably, the computer-controlled stirring subsystem is operative to accelerate the PSCCCCDC to a computer-controlled extent and with timing, which is computer coordinated with operation of the microwave heater.

In accordance with a preferred embodiment of the present invention the automated, computer-controlled, cooking system also includes a computer controller operative to control operation of the microwave heater, the computer-controlled liquid supply subsystem for supplying liquid to the user selected one of the plurality of different PSCCCCDCs and the computer-controlled stirrer subsystem external of the PSCCCCDC support in a predetermined sequence corresponding to and specifically adapted for cooking the contents of the user-selected one of the plurality of different PSCCCCDCs.

In accordance with a preferred embodiment of the present invention the computer-controlled stirrer subsystem is operative for accelerating the PSCCCCDC and thus producing stirring of the dry contents of the (PSCCCCDC) together with the liquid. Additionally, the computer-controlled stirring subsystem is operative to accelerate the PSCCCCDC to a computer-controlled extent and with timing, which is computer coordinated with operation of the microwave heater.

Preferably, the automated, computer-controlled, cooking system also includes a computer controller operative to control operation of the microwave heater, the computer-controlled liquid supply subsystem for supplying liquid to the user selected one of the plurality of different PSCCCCDCs and the computer-controlled stirrer subsystem external of the PSCCCCDC support in a predetermined sequence corresponding to and specifically adapted for cooking the contents of the user-selected one of the plurality of different PSCCCCDCs.

In accordance with a preferred embodiment of the present invention the automated, computer-controlled, cooking system also includes a computer-controlled stirrer subsystem operative for accelerating the PSCCCCDC and thus producing stirring of the dry contents of the (PSCCCCDC) together with the liquid. Additionally, the computer-controlled stirring subsystem is operative to accelerate the PSCCCCDC to a computer-controlled extent and with timing, which is computer coordinated with operation of the microwave heater.

In accordance with a preferred embodiment of the present invention the automated, computer-controlled, cooking system also includes a computer controller operative to control operation of the microwave heater, the computer-controlled liquid supply subsystem for supplying liquid to the user selected one of the plurality of different PSCCCCDCs and the computer-controlled stirrer subsystem external of the PSCCCCDC support in a predetermined sequence corresponding to and specifically adapted for cooking the contents of the user-selected one of the plurality of different PSCCCCDCs.

There is even further provided in accordance with still another preferred embodiment of the present invention an automated, computer-controlled, cooking system for use with user selectable ones of a plurality of different PSCCCCDCs containing dry contents useful in preparing corresponding different food products, the system including a microwave cooking chamber including a microwave heater, a PSCCCCDC support for supporting a user selected one of the plurality of different PSCCCCDCs during cooking, a computer-controlled liquid supply subsystem for supplying liquid to the user selected one of the plurality of different PSCCCCDCs and a computer-controlled PSCCCCDC support displacer for displacing the PSCCCCDC support into and out of the microwave cooking chamber and locking the PSCCCCDC support inside the microwave cooking chamber during operation of the microwave heater.

Preferably, the microwave cooking chamber has a maximum side-to-side dimension which is less than 200 mm. Additionally or alternatively, the computer-controlled PSCCCCDC support displacer includes a computer controlled latch and interlock subsystem for locking the PSCCCCDC support inside the microwave cooking chamber during operation of the microwave heater.

In accordance with a preferred embodiment of the present invention the system includes a computer-controlled PSCCCCDC support displacer for displacing the PSCCCCDC support into and out of the microwave cooking chamber and locking the PSCCCCDC support inside the microwave cooking chamber during operation of the microwave heater. Additionally, the computer-controlled PSCCCCDC support displacer includes a computer controlled latch and interlock subsystem for locking the PSCCCCDC support inside the microwave cooking chamber during operation of the microwave heater.

There is also provided in accordance with another preferred embodiment of the present invention an automated, computer-controlled, cooking system for use with user selectable ones of a plurality of different PSCCCCDCs useful in preparing corresponding different food products, the system including a microwave cooking chamber including a microwave heater, a PSCCCCDC support for supporting a user selected one of the plurality of different PSCCCCDCs during cooking, a computer-controlled liquid supply subsystem for supplying liquid to the user selected one of the plurality of different PSCCCCDCs, a computer-controlled stirrer subsystem external of the PSCCCCDC support for accelerating the PSCCCCDC and thus producing stirring of the dry contents of the PSCCCCDC together with the liquid and an interlock subsystem preventing operation of the microwave heater other than when the PSCCCCDC support is locked inside the microwave cooking chamber.

Preferably, the microwave cooking chamber has a maximum side-to-side dimension which is less than 200 mm.

In accordance with a preferred embodiment of the present invention the interlock subsystem includes a computer controlled electromagnet for locking the PSCCCCDC support inside the microwave cooking chamber during operation of the microwave heater.

In accordance with a preferred embodiment of the present invention the system includes a microwave cooking chamber including a microwave heater, a PSCCCCDC support for supporting a user selected one of the plurality of different PSCCCCDCs during cooking, a computer-controlled liquid supply subsystem for supplying liquid to the user selected one of the plurality of different PSCCCCDCs, a computer-controlled stirrer subsystem external of the PSCCCCDC support for accelerating the PSCCCCDC and thus producing stirring of the dry contents of the PSCCCCDC together with the liquid and an interlock subsystem preventing operation of the microwave heater other than when the PSCCCCDC support is locked inside the microwave cooking chamber.

Preferably, the interlock subsystem includes a computer controlled electromagnet for locking the PSCCCCDC support inside the microwave cooking chamber during operation of the microwave heater.

There is further provided in accordance with yet another preferred embodiment of the present invention an automated, computer-controlled, cooking system for use with user selectable ones of a plurality of different PSCCCCDCs useful in preparing corresponding different food products, the system including a microwave heater, a PSCCCCDC support for supporting a user selected one of the plurality of different PSCCCCDCs during cooking and a computer-controlled liquid supply subsystem for supplying heated liquid to the user selected one of the plurality of different PSCCCCDCs.

Preferably, the automated, computer-controlled, cooking system also includes a computer controller operative to control operation of at least the computer-controlled liquid supply subsystem in a predetermined sequence corresponding to and specifically adapted for cooking the contents of the user-selected one of the plurality of different PSCCCCDCs. Additionally, the predetermined sequence defines a computer implementable cooking protocol which includes a sequence of cooking sub-protocols each of which defines at least one parameter relating to operation of the liquid heater and at least one parameter relating to operation of the computer-controlled liquid supply subsystem. Additionally or alternatively, the predetermined sequence defines a computer implementable cooking protocol which includes a sequence of cooking sub-protocols each of which defines at least one parameter relating to operation of the computer-controlled liquid supply subsystem and at least one parameter relating to operation of the microwave heater.

Preferably, the computer-controlled liquid supply subsystem for supplying liquid to the user selected one of the plurality of different PSCCCCDCs includes a first water pump for pumping cold water and at least one second water pump for pumping heated water.

In accordance with a preferred embodiment of the present invention the liquid heater is sometimes operable under computer control as a steam generator.

Preferably, the system includes a computer controller operative to control operation of at least the computer-controlled liquid supply subsystem in a predetermined sequence corresponding to and specifically adapted for cooking the contents of the user-selected one of the plurality of different PSCCCCDCs. Additionally, the predetermined sequence defines a computer implementable cooking protocol which includes a sequence of cooking sub-protocols each of which defines at least one parameter relating to operation of the liquid heater and at least one parameter relating to operation of the computer-controlled liquid supply subsystem.

In accordance with a preferred embodiment of the present invention the predetermined sequence defines a computer implementable cooking protocol which includes a sequence of cooking sub-protocols each of which defines at least one parameter relating to operation of the computer-controlled liquid supply subsystem and at least one parameter relating to operation of the microwave heater. Additionally or alternatively, the computer-controlled liquid supply subsystem for supplying liquid to the user selected one of the plurality of different PSCCCCDCs includes a first water pump for pumping cold water and at least one second water pump for pumping heated water.

There is yet further provided in accordance with still another preferred embodiment of the present invention an automated, computer-controlled, cooking system for use with user selectable ones of a plurality of different PSCCCCDCs useful in preparing corresponding different food products, the system including a microwave heater, a PSCCCCDC support for supporting a user selected one of the plurality of different PSCCCCDCs during cooking, a computer-controlled liquid supply subsystem for supplying liquid to the user selected one of the plurality of different PSCCCCDCs and a computer-controlled steam generator for supplying steam to the computer-controlled liquid supply system for flushing thereof between cooking operations.

In accordance with a preferred embodiment of the present invention the automated, computer-controlled, cooking system also includes a computer controller operative to control operation of at least the computer-controlled liquid supply subsystem and the computer-controlled steam generator in a predetermined sequence corresponding to and specifically adapted for cooking the contents of the user-selected one of the plurality of different PSCCCCDCs. Additionally, the predetermined sequence defines a computer implementable cooking protocol includes a sequence of cooking sub-protocols each of which defines at least one parameter relating to operation of the computer-controlled steam generator and at least one parameter relating to operation of the computer-controlled liquid supply subsystem. Alternatively, the predetermined sequence defines a computer implementable cooking protocol which includes a sequence of cooking sub-protocols each of which defines at least one parameter relating to operation of the computer-controlled steam generator, at least one parameter relating to operation of the computer-controlled liquid supply subsystem and at least one parameter relating to operation of the microwave heater.

In accordance with a preferred embodiment of the present invention the computer-controlled liquid supply subsystem for supplying liquid to the user selected one of the plurality of different PSCCCCDCs includes a first water pump for pumping cold water and at least one second water pump for pumping heated water.

In accordance with a preferred embodiment of the present invention the system also includes a computer-controlled steam generator for supplying steam to the computer-controlled liquid supply system for flushing thereof between cooking operations.

Preferably, the automated, computer-controlled, cooking system also includes a computer controller operative to control operation of at least the computer-controlled liquid supply subsystem and the computer-controlled steam generator in a predetermined sequence corresponding to and specifically adapted for cooking the contents of the user-selected one of the plurality of different PSCCCCDCs. Additionally, the predetermined sequence defines a computer implementable cooking protocol includes a sequence of cooking sub-protocols each of which defines at least one parameter relating to operation of the computer-controlled steam generator and at least one parameter relating to operation of the computer-controlled liquid supply subsystem. Additionally or alternatively, the predetermined sequence defines a computer implementable cooking protocol which includes a sequence of cooking sub-protocols each of which defines at least one parameter relating to operation of the computer-controlled steam generator, at least one parameter relating to operation of the computer-controlled liquid supply subsystem and at least one parameter relating to operation of the microwave heater.

In accordance with a preferred embodiment of the present invention the computer-controlled liquid supply subsystem for supplying liquid to the user selected one of the plurality of different PSCCCCDCs includes a first water pump for pumping cold water and at least one second water pump for pumping heated water.

There is still further provided in accordance with a further preferred embodiment of the present invention an automated, computer-controlled, cooking system for use with user selectable ones of a plurality of different PSCCCCDCs useful in preparing corresponding different food products, the system including an undersized microwave cooking chamber having a maximum side-to-side dimension which is less than 200 mm, a PSCCCCDC support for supporting a user selected one of the plurality of different PSCCCCDCs during cooking, a computer-controlled liquid supply subsystem for supplying liquid to the user selected one of the plurality of different PSCCCCDCs and a computer-controlled PSCCCCDC support displacer for displacing and selectably positioning the PSCCCCDC support in the undersized microwave cooking chamber during cooking for providing desired microwave cooking of the contents of the user selected one of the plurality of different PSCCCCDCs.

In accordance with a preferred embodiment of the present invention the system includes an undersized microwave cooking chamber having a maximum side-to-side dimension which is less than 200 mm.

There is even further provided in accordance with another preferred embodiment of the present invention an automated, computer-controlled, cooking system for use with user selectable ones of a plurality of different PSCCCCDCs useful in preparing corresponding different food products, the system including a microwave heater, a PSCCCCDC support for supporting a user-selected one of the plurality of different PSCCCCDCs during cooking, a computer-controlled liquid supply subsystem for supplying liquid to the user selected one of the plurality of different PSCCCCDCs, a computer-controlled stirrer subsystem for producing stirring of the dry contents of the PSCCCCDC together with the liquid and a remotely and wirelessly programmable computer controller operative to control operation of at least the computer-controlled liquid supply subsystem, the computer-controlled stirrer subsystem and the microwave heater in a predetermined sequence corresponding to and specifically adapted for cooking the contents of the user-selected one of the plurality of different PSCCCCDCs.

In accordance with a preferred embodiment of the present invention the system also includes a remotely and wirelessly programmable computer controller operative to control operation of at least the computer-controlled liquid supply subsystem, the computer-controlled stirrer subsystem and the microwave heater in a predetermined sequence corresponding to and specifically adapted for cooking the contents of the user-selected one of the plurality of different PSCCCCDCs.

Preferably, the remotely and wirelessly programmable computer controller is operative to control the operation based partially on user inputs received wirelessly and partially on the predetermined sequence.

There is yet further provided in accordance with yet another preferred embodiment of the present invention an automated, computer-controlled, cooking system for use with user selectable ones of a plurality of different PSCCCCDCs useful in preparing corresponding different food products, the system including a microwave heater, a PSCCCCDC support for supporting a user-selected one of the plurality of different PSCCCCDCs during cooking, a computer-controlled liquid supply subsystem for supplying liquid to the user-selected one of the plurality of different PSCCCCDCs, a computer-controlled stirrer subsystem for producing stirring of the dry contents of the PSCCCCDC together with the liquid and a computer-controlled quality-controller operative to ascertain whether operation of at least the computer-controlled liquid supply subsystem, the computer-controlled stirrer subsystem and the microwave heater actually took place in a predetermined sequence specifically adapted for cooking the contents of the user-selected one of the plurality of different PSCCCCDCs and to provide a corresponding quality control output indication.

In accordance with a preferred embodiment of the present invention the system also includes a computer-controlled quality-controller operative to ascertain whether operation of at least the computer-controlled liquid supply subsystem, the computer-controlled stirrer subsystem and the microwave heater actually took place in a predetermined sequence specifically adapted for cooking the contents of the user-selected one of the plurality of different PSCCCCDCs and to provide a corresponding quality control output indication.

Preferably, the automated, computer-controlled, cooking system also includes a computer controller operative to control operation of at least the computer-controlled liquid supply subsystem, the computer-controlled stirrer subsystem and the microwave heater in a predetermined sequence corresponding to and specifically adapted for cooking the contents of the user-selected one of the plurality of different PSCCCCDCs, the computer controller being responsive to the quality control output indication. Additionally, the computer controller is responsive to a quality control output indication which indicates an operational failure for aborting the cooking. Alternatively, the computer controller is responsive to a quality control output indication which indicates an operational failure for correcting the cooking.

There is also provided in accordance with still another preferred embodiment of the present invention an automated, computer-controlled, cooking system for use with user selectable ones of a plurality of different PSCCCCDCs useful in preparing corresponding different food products, the system including a multiplicity of computer-controlled cooking units, each including at least a wireless communicator communicating operational details of each cooking operation carried out by the computer-controlled cooking unit and at least one central cooking data monitoring unit communicating wirelessly with the multiplicity of computer-controlled cooking units for at least monitoring operation thereof.

In accordance with a preferred embodiment of the present invention the system includes a multiplicity of computer-controlled cooking system units, each cooking system unit including at least a wireless communicator communicating operational details of each cooking operation carried out by the computer-controlled cooking unit and at least one central cooking data monitoring unit communicating wirelessly with the multiplicity of computer-controlled cooking units for at least monitoring operation thereof.

In accordance with a preferred embodiment of the present invention at least one of the multiplicity of computer-controlled cooking units includes a set of elements included at least one of groups A-S below:

A. a microwave heater, a PSCCCCDC support for supporting a user-selected one of the plurality of different PSCCCCDCs during cooking, a computer-controlled liquid supply subsystem for supplying liquid to the user selected one of the plurality of different PSCCCCDCs, a computer-controlled stirrer subsystem for producing stirring of the dry contents of the PSCCCCDC together with the liquid and a computer controller operative to control operation of at least the computer-controlled liquid supply subsystem, the computer-controlled stirrer subsystem and the microwave heater in a predetermined sequence corresponding to and specifically adapted for cooking the contents of the user-selected one of the plurality of different PSCCCCDCs,

B. a microwave heater and a PSCCCCDC support for supporting a user selected one of the plurality of different PSCCCCDCs during cooking and including a passive, microwave heatable portion, which is positioned for conduction heating of the PSCCCCDC,

C. a microwave heater, a PSCCCCDC support for supporting a user selected one of the plurality of different PSCCCCDCs during cooking,a computer-controlled liquid supply subsystem for supplying liquid to the user selected one of the plurality of different PSCCCCDCs and a computer-controlled stirrer subsystem external of the PSCCCCDC support for accelerating the PSCCCCDC and thus producing stirring of the dry contents of the PSCCCCDC together with the liquid,

D. a microwave cooking chamber including a microwave heater, a PSCCCCDC support for supporting a user selected one of the plurality of different PSCCCCDCs during cooking, a computer-controlled liquid supply subsystem for supplying liquid to the user selected one of the plurality of different PSCCCCDCs, and a computer-controlled PSCCCCDC support displacer for displacing the PSCCCCDC support into and out of the microwave cooking chamber and locking the PSCCCCDC support inside the microwave cooking chamber during operation of the microwave heater,

E. a microwave cooking chamber including a microwave heater, a PSCCCCDC support for supporting a user selected one of the plurality of different PSCCCCDCs during cooking, a computer-controlled liquid supply subsystem for supplying liquid to the user selected one of the plurality of different PSCCCCDCs; a computer-controlled stirrer subsystem external of the PSCCCCDC support for accelerating the PSCCCCDC and thus producing stirring of the dry contents of the PSCCCCDC together with the liquid and an interlock preventing operation of the computer-controlled liquid supply subsystem other than when the PSCCCCDC support is locked inside the microwave cooking chamber,

F. a microwave heater, a PSCCCCDC support for supporting a user selected one of the plurality of different PSCCCCDCs during cooking, a computer-controlled liquid supply subsystem for supplying liquid to the user selected one of the plurality of different PSCCCCDCs and a computer-controlled liquid heater for supplying heated liquid to the computer-controlled liquid supply system,

G. a microwave heater, a PSCCCCDC support for supporting a user selected one of the plurality of different PSCCCCDCs during cooking, a computer-controlled liquid supply subsystem for supplying liquid to the user selected one of the plurality of different PSCCCCDCs and a computer-controlled steam generator for supplying steam to the computer-controlled liquid supply system for flushing thereof between cooking operations,

H. an undersized microwave cooking chamber having a maximum side-to-side dimension which is less than 200 mm and a PSCCCCDC support for supporting a user selected one of the plurality of different PSCCCCDCs during cooking, a computer-controlled liquid supply subsystem for supplying liquid to the user selected one of the plurality of different PSCCCCDCs and a computer-controlled PSCCCCDC support displacer for displacing and selectably positioning the PSCCCCDC support in the undersized microwave cooking chamber during cooking for providing desired microwave cooking of the contents of the user selected one of the plurality of different PSCCCCDCs,

I. a microwave heater, a PSCCCCDC support for supporting a user-selected one of the plurality of different PSCCCCDCs during cooking, a computer-controlled liquid supply subsystem for supplying liquid to the user selected one of the plurality of different PSCCCCDCs, a computer-controlled stirrer subsystem for producing stirring of the dry contents of the PSCCCCDC together with the liquid and a remotely and wirelessly programmable computer controller operative to control operation of at least the computer-controlled liquid supply subsystem, the computer-controlled stirrer subsystem and the microwave heater in a predetermined sequence corresponding to and specifically adapted for cooking the contents of the user-selected one of the plurality of different PSCCCCDCs,

J. a microwave heater, a PSCCCCDC support for supporting a user-selected one of the plurality of different PSCCCCDCs during cooking, a computer-controlled liquid supply subsystem for supplying liquid to the user-selected one of the plurality of different PSCCCCDCs, a computer-controlled stirrer subsystem for producing stirring of the dry contents of the PSCCCCDC together with the liquid and a computer-controlled quality-controller operative to ascertain whether operation of at least the computer-controlled liquid supply subsystem, the computer-controlled stirrer subsystem and the microwave heater actually took place in a predetermined sequence specifically adapted for cooking the contents of the user-selected one of the plurality of different PSCCCCDCs and to provide a corresponding quality control output indication,

K. a microwave heater, a PSCCCCDC support for supporting a user-selected one of the plurality of different PSCCCCDCs during cooking, a computer-controlled liquid supply subsystem for supplying liquid to the user selected one of the plurality of different PSCCCCDCs, a computer-controlled stirrer subsystem for producing stirring of the dry contents of the PSCCCCDC together with the liquid and a computer controller operative to control operation of at least the computer-controlled liquid supply subsystem, the computer-controlled stirrer subsystem and the microwave heater in a predetermined sequence corresponding to and specifically adapted for cooking the contents of the user-selected one of the plurality of different PSCCCCDCs, the plurality of different PSCCCCDCs each including a PSCCCCDC body defining a storage and cooking volume and a multi-ingredient, multi-sized and multi-textured dry food precursor located within the PSCCCCDC body, the multi-ingredient, multi-sized and multi-textured dry food precursor including multiple, different freeze-dried food components,

L. a microwave heater, a computer-controlled liquid supply subsystem for supplying heated liquid to the user selected one of the plurality of different PSCCCCDCs, a computer controller operative to control operation of at least the computer-controlled liquid supply subsystem and the microwave heater in a predetermined sequence corresponding to and specifically adapted for cooking the contents of the user-selected one of the plurality of different PSCCCCDCs,

M. a computer-controlled liquid supply subsystem for supplying heated liquid to the user selected one of the plurality of different PSCCCCDCs, a computer controller operative to control operation of at least the computer-controlled liquid supply subsystem in a predetermined sequence corresponding to and specifically adapted for cooking the contents of the user-selected one of the plurality of different PSCCCCDCs, the predetermined sequence including supplying liquid at multiple different times and at different temperatures to the contents of the user-selected one of the plurality of different PSCCCCDCs,

N. a computer-controlled liquid supply subsystem for supplying heated liquid to the user selected one of the plurality of different PSCCCCDCs and a computer controller operative to control operation of at least the computer-controlled liquid supply subsystem in a predetermined sequence corresponding to and specifically adapted for cooking the contents of the user-selected one of the plurality of different PSCCCCDCs, the predetermined sequence including flushing the liquid supply subsystem into the contents of the user-selected one of the plurality of different PSCCCCDCs,

O. a computer-controlled fluid supply subsystem for supplying fluid to the user selected one of the plurality of different PSCCCCDCs and a computer controller operative to control operation of at least the computer-controlled liquid supply subsystem in a predetermined sequence corresponding to and specifically adapted for cooking the contents of the user-selected one of the plurality of different PSCCCCDCs, the predetermined sequence including supplying pressurized air during cooking to lower temperature and pressure within the PSCCCCDC,

P. a microwave heater, a computer-controlled liquid supply subsystem for supplying heated liquid to the user selected one of the plurality of different PSCCCCDCs, a computer controller operative to control operation of at least the computer-controlled liquid supply subsystem and the microwave heater in a predetermined sequence corresponding to and specifically adapted for cooking the contents of the user-selected one of the plurality of different PSCCCCDCs the predetermined sequence including supplying liquids to the PSCCCCDC during the cooking,

Q. a microwave heater, a computer-controlled liquid supply subsystem for supplying heated liquid to the user selected one of the plurality of different PSCCCCDCs, a computer controller operative to control operation of at least the computer-controlled liquid supply subsystem and the microwave heater in a predetermined sequence corresponding to and specifically adapted for cooking the contents of the user-selected one of the plurality of different PSCCCCDCs the predetermined sequence including bringing the contents of the PSCCCCDC to boiling in the PSCCCCDC,

R. a microwave heater, a computer-controlled liquid supply subsystem for supplying heated liquid to the user selected one of the plurality of different PSCCCCDCs, a computer controller operative to control operation of at least the computer-controlled liquid supply subsystem and the microwave heater in a predetermined sequence corresponding to and specifically adapted for cooking the contents of the user-selected one of the plurality of different PSCCCCDCs the predetermined sequence including bringing the contents of the PSCCCCDC to boiling in the PSCCCCDC,

S. a microwave heater, a computer-controlled liquid supply subsystem for supplying heated liquid to the user selected one of the plurality of different PSCCCCDCs, a computer controller operative to control operation of at least the computer-controlled liquid supply subsystem and the microwave heater in a predetermined sequence corresponding to and specifically adapted for cooking the contents of the user-selected one of the plurality of different PSCCCCDCs the predetermined sequence including cooling contents of the PSCCCCDC after at least partially cooking thereof.

Preferably, at least two of the multiplicity of computer-controlled cooking units each includes a set of elements included in a different one of the groups A-S.

In accordance with a preferred embodiment of the present invention the at least one central cooking data monitoring unit is connected to the multiplicity of computer-controlled cooking units by an internet based network. Additionally or alternatively, the at least one central cooking data monitoring unit provides quality control functionality. Alternatively or additionally, the at least one central cooking data monitoring unit provides defect correction functionality.

In accordance with a preferred embodiment of the present invention the at least one central cooking data monitoring unit provides recipe update functionality. Additionally or alternatively, the at least one central cooking data monitoring unit enables recipe sharing among users of the multiplicity of computer-controlled cooking units.

In accordance with a preferred embodiment of the present invention the at least one central cooking data monitoring unit provides supply chain monitoring functionality by monitoring supply and usage of specific PSCCCCDCs. Additionally or alternatively, the at least one central cooking data monitoring unit provides counterfeit detection functionality by monitoring supply and usage of specific PSCCCCDCs which are uniquely identified. In accordance with a preferred embodiment of the present invention the at least one central cooking data monitoring unit provides counterfeit prevention functionality by preventing usage of specific PSCCCCDCs which are uniquely identified as already having been used.

In accordance with a preferred embodiment of the present invention the at least one central cooking data monitoring unit provides malfunction detection functionality by monitoring computerized cooking protocols carried out by the multiplicity of computer-controlled cooking units and matching them to stored computerized cooking protocols assigned to identified PSCCCCDCs whose contents are being cooked.

Preferably, the at least one central cooking data monitoring unit provides quality control functionality by monitoring computerized cooking protocols carried out by the multiplicity of computer-controlled cooking units and matching them to stored computerized cooking protocols assigned to identified PSCCCCDCs whose contents are being cooked and preventing dispensing of cooked products in the event of a mismatch.

In accordance with a preferred embodiment of the present invention the at least one central cooking data monitoring unit provides supply and usage monitoring functionality by monitoring supply and usage of specific types of PSCCCCDCs at given times. Additionally or alternatively, the at least one central cooking data monitoring unit provides supply and usage monitoring functionality by monitoring supply and usage of specific types of PSCCCCDCs in given geographical locations. Alternatively or additionally, the at least one central cooking data monitoring unit provides supply and usage monitoring functionality by monitoring supply and usage of specific types of PSCCCCDCs and correlating usage with seasons and geographical locations.

In accordance with a preferred embodiment of the present invention the at least one central cooking data monitoring unit provides individual user usage monitoring functionality by monitoring usage of PSCCCCDCs by identified users. Additionally or alternatively, the at least one central cooking data monitoring unit provides individual user calorie consumption monitoring functionality by monitoring usage of identified PSCCCCDCs by identified users.

There is also provided in accordance with another preferred embodiment of the present invention a single-use PSCCCCDC for use in an automated, computer-controlled cooking system including a liquid supply subsystem, the PSCCCCDC including a PSCCCCDC body defining an open top, a vapor seal sealed across the open top and a removable top, removably attached to the PSCCCCDC body over the vapor seal, the removable top being formed with a pre-cut portion and an outer seal adhered to the removable top from the outside for providing an outer seal over the pre-cut portion.

In accordance with a preferred embodiment of the present invention the single-use PSCCCCDC is filled with a multi-ingredient, multi-sized and multi-textured dry food precursor located within the PSCCCCDC body, the multi-ingredient, multi-sized and multi-textured dry food precursor including multiple, different freeze-dried food components.

There is further provided in accordance with still another preferred embodiment of the present invention a filled single-use PSCCCCDC for use in an automated, computer-controlled cooking system, the filled PSCCCCDC including a PSCCCCDC body defining a storage and cooking volume and a multi-ingredient, multi-sized and multi-textured dry food precursor located within the PSCCCCDC body, the multi-ingredient, multi-sized and multi-textured dry food precursor including multiple, different freeze-dried food components.

There is yet further provided in accordance with yet another preferred embodiment of the present invention a filled single-use PSCCCCDC for use in an automated, computer-controlled cooking system, the filled PSCCCCDC including a PSCCCCDC body defining a storage and cooking volume and a multi-ingredient, multi-sized and multi-textured dry food precursor located within the PSCCCCDC body, the multi-ingredient, multi-sized and multi-textured dry food precursor including multiple, different food components which require correspondingly different cooking sub-protocols.

Preferably, the filled PSCCCCDC also includes a multi-ingredient, multi-sized and multi-textured dry food precursor located within the PSCCCCDC body, the multi-ingredient, multi-sized and multi-textured dry food precursor including multiple, different food components which require correspondingly different cooking sub-protocols.

There is even further provided in accordance with even a further preferred embodiment of the present invention a filled single-use PSCCCCDC for use in an automated, computer-controlled cooking system, the filled PSCCCCDC including PSCCCCDC body defining a storage and cooking volume, a multi-ingredient, multi-sized and multi-textured dry food precursor located within the PSCCCCDC body and a machine readable identifier associated with the PSCCCCDC body and containing data which is usable by the automated computer-controlled cooking system for selecting a sequence of cooking protocols to be carried out for desired cooking of the contents of the filled PSCCCCDC.

In accordance with a preferred embodiment of the present invention the filled PSCCCCDC also includes a machine readable identifier associated with the PSCCCCDC body and containing data which is usable by the automated computer-controlled cooking system for selecting a sequence of cooking protocols to be carried out for desired cooking of the contents of the filled PSCCCCDC.

Preferably, the machine readable identifier is unique for each filled single-user PSCCCCDC and is thus not repeated in two PSCCCCDCs.

There is still further provided in accordance with still another preferred embodiment of the present invention a filled single-use PSCCCCDC for use in an automated, computer-controlled cooking system, the filled PSCCCCDC including a PSCCCCDC body defining a storage and cooking volume, a multi-ingredient, multi-sized and multi-textured dry food precursor located within the PSCCCCDC body, a first machine readable identifier associated with the PSCCCCDC body and containing data which is usable by the automated computer-controlled cooking system for selecting a sequence of cooking protocols to be carried out for desired cooking of the contents of the filled PSCCCCDC to attain a first selectable result and a second machine readable identifier associated with the PSCCCCDC body and containing data which is usable by the automated computer-controlled cooking system for selecting a sequence of cooking protocols to be carried out for desired cooking of the contents of the filled PSCCCCDC to attain a second selectable result.

In accordance with a preferred embodiment of the present invention the filled PSCCCCDC also includes a first machine readable identifier associated with the PSCCCCDC body and containing data which is usable by the automated computer-controlled cooking system for selecting a sequence of cooking protocols to be carried out for desired cooking of the contents of the filled PSCCCCDC to attain a first selectable result and a second machine readable identifier associated with the PSCCCCDC body and containing data which is usable by the automated computer-controlled cooking system for selecting a sequence of cooking protocols to be carried out for desired cooking of the contents of the filled PSCCCCDC to attain a second selectable result.

There is also provided in accordance with still a further preferred embodiment of the present invention a single-use PSCCCCDC for use in an automated, computer controlled- cooking system including a liquid supply subsystem, the PSCCCCDC including a PSCCCCDC body defining an open top, a vapor seal sealed across the open top and a removable top, removably attached to the PSCCCCDC body over the vapor seal, the removable top being formed with an extendible accordion-like apertured central portion and an outer seal adhered to the removable top from the outside for providing an outer seal over the an extendible accordion-like apertured central portion.

Preferably, the single use PSCCCCDC is filled with a multi-ingredient, multi-sized and multi-textured dry food precursor located within the PSCCCCDC body, the multi-ingredient, multi-sized and multi-textured dry food precursor including multiple, different freeze-dried food components.

There is further provided in accordance with another preferred embodiment of the present invention a filled single-use PSCCCCDC for use in an automated, computer-controlled cooking system, the filled PSCCCCDC including a PSCCCCDC body defining a storage and cooking volume and a multi-ingredient, multi-sized and multi-textured dry food precursor located within the PSCCCCDC body, the multi-ingredient, multi-sized and multi-textured dry food precursor including multiple, different freeze-dried food components and non-freeze-dried food components.

There is even further provided in accordance with yet another preferred embodiment of the present invention a filled single-use PSCCCCDC for use in an automated, computer-controlled cooking system, the filled PSCCCCDC including a PSCCCCDC body defining a storage and cooking volume, a multi-ingredient, multi-sized and multi-textured dry food precursor located within the PSCCCCDC body, the multi-ingredient, multi-sized and multi-textured dry food precursor including multiple, different food components which require correspondingly different cooking sub-protocols and at least one machine readable indicium on an outer surface of the PSCCCCDC for indicating cooking sub-protocols suitable for cooking of the multi-ingredient, multi-sized and multi-textured dry food precursor.

In accordance with a preferred embodiment of the present invention the filled PSCCCCDC also includes a multi-ingredient, multi-sized and multi-textured dry food precursor located within the PSCCCCDC body, the multi-ingredient, multi-sized and multi-textured dry food precursor including multiple, different food components which require correspondingly different cooking sub-protocols.

There is still further provided in accordance with another preferred embodiment of the present invention a filled single-use PSCCCCDC for use in an automated, computer-controlled cooking system, the filled PSCCCCDC including a PSCCCCDC body defining a storage and cooking volume, a multi-ingredient, multi-sized and multi-textured dry food precursor located within the PSCCCCDC body and a machine readable identifier associated with the PSCCCCDC body and containing data which is usable by the automated computer-controlled cooking system for selecting a sequence of cooking protocols to be carried out for desired cooking of the contents of the filled PSCCCCDC.

In accordance with a preferred embodiment of the present invention the filled PSCCCCDC also includes a machine readable identifier associated with the PSCCCCDC body and containing data which is usable by the automated computer-controlled cooking system for selecting a sequence of cooking protocols to be carried out for desired cooking of the contents of the filled PSCCCCDC.

Preferably, the machine readable identifier is unique for each filled single-user PSCCCCDC and is thus not repeated in two PSCCCCDCs.

In accordance with a preferred embodiment of the present invention the filled PSCCCCDC also includes a first machine readable identifier associated with the PSCCCCDC body and containing data which is usable by the automated computer-controlled cooking system for selecting a sequence of cooking protocols to be carried out for desired cooking of the contents of the filled PSCCCCDC to attain a first selectable result and a second machine readable identifier associated with the PSCCCCDC body and containing data which is usable by the automated computer-controlled cooking system for selecting a sequence of cooking protocols to be carried out for desired cooking of the contents of the filled PSCCCCDC to attain a second selectable result.

There is still further provided in accordance with yet another preferred embodiment of the present invention a filled single-use PSCCCCDC for use in an automated, computer-controlled cooking system, the filled PSCCCCDC including a PSCCCCDC body defining a storage and cooking volume, a multi-ingredient, multi-sized and multi-textured dry food precursor located within the PSCCCCDC body, a first machine readable identifier associated with the PSCCCCDC body and containing data which is usable by the automated computer-controlled cooking system for selecting a sequence of cooking protocols to be carried out for desired cooking of the contents of the filled PSCCCCDC to attain a first selectable result and a second machine readable identifier associated with the PSCCCCDC body and containing data which is usable by the automated computer-controlled cooking system for selecting a sequence of cooking protocols to be carried out for desired cooking of the contents of the filled PSCCCCDC to attain a second selectable result.

There is also provided in accordance with still another preferred embodiment of the present invention an automated, computer-controlled, cooking system in combination with user selectable ones of a plurality of different PSCCCCDCs useful in preparing corresponding different food products, the system including a microwave heater, a PSCCCCDC support for supporting a user-selected one of the plurality of different PSCCCCDCs during cooking, a computer-controlled liquid supply subsystem for supplying liquid to the user selected one of the plurality of different PSCCCCDCs, a computer-controlled stirrer subsystem for producing stirring of the dry contents of the PSCCCCDC together with the liquid and a computer controller operative to control operation of at least the computer-controlled liquid supply subsystem, the computer-controlled stirrer subsystem and the microwave heater in a predetermined sequence corresponding to and specifically adapted for cooking the contents of the user-selected one of the plurality of different PSCCCCDCs, the plurality of different PSCCCCDCs each including a PSCCCCDC body defining a storage and cooking volume and a multi-ingredient, multi-sized and multi-textured dry food precursor located within the PSCCCCDC body, the multi-ingredient, multi-sized and multi-textured dry food precursor including multiple, different freeze-dried food components.

Preferably, the predetermined sequence defines a computer implementable cooking protocol which includes a sequence of cooking sub-protocols each of which defines at least one parameter relating to operation of the microwave heater and at least one of a parameter relating to operation of the computer-controlled liquid supply subsystem and a parameter relating to operation of the computer-controlled stirrer subsystem. Alternatively, the predetermined sequence defines a computer implementable cooking protocol which includes a sequence of cooking sub-protocols each of which defines at least one parameter relating to operation of the microwave heater and at least one parameter relating to operation of the computer-controlled liquid supply subsystem. In accordance with an alternative preferred embodiment of the present invention, the predetermined sequence defines a computer implementable cooking protocol which includes a sequence of cooking sub-protocols each of which defines at least one parameter relating to operation of the microwave heater and at least one parameter relating to operation of the computer-controlled stirrer subsystem. Alternatively, the predetermined sequence defines a computer implementable cooking protocol which includes a sequence of cooking sub-protocols each of which defines at least one parameter relating to operation of the microwave heater, at least one parameter relating to operation of the computer-controlled liquid supply subsystem and at least one parameter relating to operation of the computer-controlled stirrer subsystem.

Preferably, the computer-controlled liquid supply subsystem for supplying liquid to the user selected one of the plurality of different PSCCCCDCs includes a first water pump for pumping cold water and at least one second water pump for pumping heated water. Additionally or alternatively, the computer-controlled liquid supply subsystem for supplying liquid to the user selected one of the plurality of different PSCCCCDCs includes a heated water and/or steam generator.

In accordance with a preferred embodiment of the present invention the computer-controlled stirrer subsystem for producing stirring of the dry contents of the PSCCCCDC together with the liquid is operative to effect stirring of contents of the user selected PSCCCCDC only by moving the PSCCCCDC. Additionally or alternatively, the computer-controlled stirrer subsystem for producing stirring of the dry contents of the PSCCCCDC together with the liquid includes a rotary drive motor and a linkage which are together operative to displace the PSCCCCDC support in reciprocal motion. Additionally or alternatively, the computer-controlled stirrer subsystem for producing stirring of the dry contents of the PSCCCCDC together with the liquid includes a PSCCCCDC rotator which is operative to displace the PSCCCCDC in rotational motion relative to the PSCCCCDC support.

There is still further provided in accordance with another preferred embodiment of the present invention an automated, computer-controlled, cooking system for use with user selectable ones of a plurality of different PSCCCCDCs useful in preparing corresponding different food products, the system including a microwave heater, a computer-controlled liquid supply subsystem for supplying heated liquid to the user selected one of the plurality of different PSCCCCDCs and a computer controller operative to control operation of at least the computer-controlled liquid supply subsystem and the microwave heater in a predetermined sequence corresponding to and specifically adapted for cooking the contents of the user-selected one of the plurality of different PSCCCCDCs.

In accordance with a preferred embodiment of the present invention the predetermined sequence defines a computer implementable cooking protocol which includes a sequence of cooking sub-protocols each of which defines at least one parameter relating to operation of the microwave heater or at least one parameter relating to operation of the computer-controlled liquid supply subsystem. Alternatively, the predetermined sequence defines a computer implementable cooking protocol which includes a sequence of cooking sub-protocols each of which defines at least one parameter relating to operation of the microwave heater and at least one parameter relating to operation of the computer-controlled liquid supply subsystem. In a further alternative embodiment of the present invention the predetermined sequence defines a computer implementable cooking protocol which includes a sequence of cooking sub-protocols each of which defines at least one parameter relating to operation of the microwave heater. Alternatively, the predetermined sequence defines a computer implementable cooking protocol which includes a sequence of cooking sub-protocols each of which defines at least one parameter relating to operation of the computer-controlled liquid supply subsystem.

In accordance with a preferred embodiment of the present invention the computer-controlled liquid supply subsystem for supplying liquid to the user selected one of the plurality of different PSCCCCDCs includes a first water pump for pumping cold water and at least one second water pump for pumping heated water. Additionally or alternatively, the computer-controlled liquid supply subsystem for supplying liquid to the user selected one of the plurality of different PSCCCCDCs includes a heated water and/or steam generator.

There is yet further provided in accordance with another preferred embodiment of the present invention an automated, computer-controlled, cooking system for use with user selectable ones of a plurality of different PSCCCCDCs useful in preparing corresponding different food products, the system including a computer-controlled liquid supply subsystem for supplying heated liquid to the user selected one of the plurality of different PSCCCCDCs and a computer controller operative to control operation of at least the computer-controlled liquid supply subsystem in a predetermined sequence corresponding to and specifically adapted for cooking the contents of the user-selected one of the plurality of different PSCCCCDCs, the predetermined sequence including supplying liquid at multiple different times and at different temperatures to the contents of the user-selected one of the plurality of different PSCCCCDCs.

Preferably, the predetermined sequence defines a computer implementable cooking protocol which includes a sequence of cooking sub-protocols each of which defines at least one parameter relating to operation of the microwave heater or at least one parameter relating to operation of the computer-controlled liquid supply subsystem. Alternatively, the predetermined sequence defines a computer implementable cooking protocol which includes a sequence of cooking sub-protocols each of which defines at least one parameter relating to operation of the microwave heater and at least one parameter relating to operation of the computer-controlled liquid supply subsystem. In a further alternative embodiment of the present invention, the predetermined sequence defines a computer implementable cooking protocol which includes a sequence of cooking sub-protocols each of which defines at least one parameter relating to operation of the microwave heater. Alternatively, the predetermined sequence defines a computer implementable cooking protocol which includes a sequence of cooking sub-protocols each of which defines at least one parameter relating to operation of the computer-controlled liquid supply subsystem.

In accordance with a preferred embodiment of the present invention the computer-controlled liquid supply subsystem for supplying liquid to the user selected one of the plurality of different PSCCCCDCs includes a first water pump for pumping cold water and at least one second water pump for pumping heated water. Additionally r alternatively, the computer-controlled liquid supply subsystem for supplying liquid to the user selected one of the plurality of different PSCCCCDCs includes a heated water and/or steam generator.

There is also provided in accordance with yet another preferred embodiment of the present invention an automated, computer-controlled, cooking system for use with user selectable ones of a plurality of different PSCCCCDCs useful in preparing corresponding different food products, the system including a computer-controlled liquid supply subsystem for supplying heated liquid to the user selected one of the plurality of different PSCCCCDCs and a computer controller operative to control operation of at least the computer-controlled liquid supply subsystem in a predetermined sequence corresponding to and specifically adapted for cooking the contents of the user-selected one of the plurality of different PSCCCCDCs, the predetermined sequence including flushing the liquid supply subsystem into the contents of the user-selected one of the plurality of different PSCCCCDCs.

There is further provided in accordance with still another preferred embodiment of the present invention an automated, computer-controlled, cooking system for use with user selectable ones of a plurality of different PSCCCCDCs useful in preparing corresponding different food products, the system including a computer-controlled fluid supply subsystem for supplying fluid to the user selected one of the plurality of different PSCCCCDCs and a computer controller operative to control operation of at least the computer-controlled liquid supply subsystem in a predetermined sequence corresponding to and specifically adapted for cooking the contents of the user-selected one of the plurality of different PSCCCCDCs, the predetermined sequence including supplying pressurized air during cooking to lower temperature and pressure within the PSCCCCDC.

There is even further provided in accordance with yet another preferred embodiment of the present invention an automated, computer-controlled, cooking system for use with user selectable ones of a plurality of different PSCCCCDCs useful in preparing corresponding different food products, the system including a microwave heater, a computer-controlled liquid supply subsystem for supplying heated liquid to the user selected one of the plurality of different PSCCCCDCs and a computer controller operative to control operation of at least the computer-controlled liquid supply subsystem and the microwave heater in a predetermined sequence corresponding to and specifically adapted for cooking the contents of the user-selected one of the plurality of different PSCCCCDCs the predetermined sequence including supplying liquids to the PSCCCCDC during the cooking.

There is yet further provided in accordance with another preferred embodiment of the present invention an automated, computer-controlled, cooking system for use with user selectable ones of a plurality of different PSCCCCDCs useful in preparing corresponding different food products, the system including a microwave heater, a computer-controlled liquid supply subsystem for supplying heated liquid to the user selected one of the plurality of different PSCCCCDCs and a computer controller operative to control operation of at least the computer-controlled liquid supply subsystem and the microwave heater in a predetermined sequence corresponding to and specifically adapted for cooking the contents of the user-selected one of the plurality of different PSCCCCDCs the predetermined sequence including bringing the contents of the PSCCCCDC to boiling in the PSCCCCDC.

There is also provided in accordance with still another preferred embodiment of the present invention an automated, computer-controlled, cooking system for use with user selectable ones of a plurality of different PSCCCCDCs useful in preparing corresponding different food products, the system including a microwave heater, a computer-controlled liquid supply subsystem for supplying heated liquid to the user selected one of the plurality of different PSCCCCDCs and a computer controller operative to control operation of at least the computer-controlled liquid supply subsystem and the microwave heater in a predetermined sequence corresponding to and specifically adapted for cooking the contents of the user-selected one of the plurality of different PSCCCCDCs the predetermined sequence including cooling contents of the PSCCCCDC after at least partially cooking thereof.

There is further provided in accordance with yet another preferred embodiment of the present invention an automated, computer-controlled, cooking method for use with user selectable ones of a plurality of different pre-sealed computerized cooking PSCCCCDCs (PSCCCCDC) useful in preparing corresponding different food products, the method including supplying liquid to a user-selected one of the plurality of different PSCCCCDCs in accordance with a computer-controlled protocol, producing stirring of the dry contents of the PSCCCCDC together with the liquid in accordance with the computer-controlled protocol, heating of the dry contents of the PSCCCCDC together with the liquid in accordance with the computer-controlled protocol and controlling the supplying, the heating and the stirring in a predetermined sequence governed by the computer-controlled protocol and corresponding to and specifically adapted for cooking the contents of the user-selected one of the plurality of different pre-sealed PSCCCCDCs.

Preferably, the predetermined sequence includes a sequence of cooking sub-protocols each of which defines at least one parameter relating to operation of a microwave heater and at least one of a parameter relating to operation of a computer-controlled liquid supply subsystem and at least one parameter relating to operation of a computer-controlled stirrer subsystem. Additionally or alternatively, the supplying includes operating a first water pump for pumping cold water and a second water pump for pumping heated water. Alternatively or additionally, the supplying also provides steam.

In accordance with a preferred embodiment of the present invention the stirring is operative to effect stirring of contents of the user selected PSCCCCDC only by moving the PSCCCCDC. Additionally or alternatively, the stirring includes displacing the PSCCCCDC in reciprocal motion. Additionally, the stirring also includes displacing the PSCCCCDC in rotational motion about an axis therein.

Preferably, the heating includes microwave heating of a microwave heatable element and conduction heating of the PSCCCCDC by the microwave heatable element.

In accordance with a preferred embodiment of the present invention the automated, computer-controlled, cooking method also includes steam flushing between sequential cooking operations.

Preferably, the automated, computer-controlled, cooking method also includes controlling cooking based partially on user inputs received wirelessly and partially on a stored predetermined sequence.

In accordance with a preferred embodiment of the present invention the automated, computer-controlled, cooking method also includes ascertaining whether cooking operations actually took place in a predetermined sequence specifically adapted for cooking the contents of the user-selected one of the plurality of different PSCCCCDCs and providing a corresponding quality control output indication. Additionally, the automated, computer-controlled, cooking method also includes governing cooking in response to the quality control output indication. Alternatively or additionally, the automated, computer-controlled, cooking method also includes aborting cooking in response to the quality control output indication. Alternatively, the automated, computer-controlled, cooking method also includes automatically correcting cooking in response to the quality control output indication.

Preferably, the predetermined sequence includes the following steps:

1. OPERATE HOT WATER PUMP FOR 9 SECONDS AS FOLLOWS:

OPERATE HOT WATER PUMP FOR 3 CYCLES OF 3 SECONDS DURATION EACH, EACH CYCLE BEING SEPARATED BY A REST PERIOD OF 0.5 SECOND.

2. OPERATE COLD WATER PUMP FOR 2 SECONDS.

3. OPERATE HOT WATER PUMP FOR 9 SECONDS AS FOLLOWS:

OPERATE HOT WATER PUMP FOR 3 CYCLES OF 3 SECONDS DURATION EACH, EACH CYCLE BEING SEPARATED BY A REST PERIOD OF 0.5 SECOND.

4. OPERATE MICROWAVE ENERGY GENERATING ASSEMBLY FOR 25 SECONDS AND ALSO OPERATE STIRRING MOTOR AS FOLLOWS:

OPERATE AIR PUMP FOR 5 SECONDS.

OPERATE STIRRING MOTOR FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY.

OPERATE FANS DURING OPERATION OF MICROWAVE ENERGY GENERATING ASSEMBLY AND FOR AN ADDITIONAL APPROXIMATELY 20 MINUTES THEREAFTER.

5. OPERATE COLD WATER PUMP FOR 1 SECOND.

6. OPERATE STIRRING MOTOR CONTINUOUSLY FOR 4 SECONDS.

7. OPERATE MICROWAVE ENERGY GENERATING ASSEMBLY FOR 11 SECONDS AND ALSO OPERATE STIRRING MOTOR AS FOLLOWS:

OPERATE AIR PUMP FOR 5 SECONDS.

OPERATE STIRRING MOTOR FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY.

OPERATE FANS DURING OPERATION OF MICROWAVE ENERGY GENERATING ASSEMBLY AND FOR AN ADDITIONAL APPROXIMATELY 20 MINUTES THEREAFTER.

8. OPERATE COLD WATER PUMP FOR 1 SECOND.

9. OPERATE HOT WATER PUMP FOR 4 SECONDS AS FOLLOWS:

OPERATE HOT WATER PUMP FOR 1 CYCLE OF 3 SECONDS DURATION, FOLLOWED BY A REST PERIOD OF 0.5 SECOND.

10. OPERATE COLD WATER PUMP FOR 2 SECONDS.

11. OPERATE MICROWAVE ENERGY GENERATING ASSEMBLY FOR 4 SECONDS AND ALSO OPERATE STIRRING MOTOR AS FOLLOWS:

OPERATE AIR PUMP FOR 5 SECONDS.

OPERATE STIRRING MOTOR FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY.

OPERATE FANS DURING OPERATION OF MICROWAVE ENERGY GENERATING ASSEMBLY AND FOR AN ADDITIONAL APPROXIMATELY 20 MINUTES THEREAFTER.

12. OPERATE COLD WATER PUMP FOR 2 SECONDS.

13. OPERATE MICROWAVE ENERGY GENERATING ASSEMBLY FOR 5 SECONDS AND ALSO OPERATE STIRRING MOTOR AS FOLLOWS:

OPERATE AIR PUMP FOR 5 SECONDS.

OPERATE STIRRING MOTOR FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY.

OPERATE FANS DURING OPERATION OF MICROWAVE ENERGY GENERATING ASSEMBLY AND FOR AN ADDITIONAL APPROXIMATELY 20 MINUTES THEREAFTER.

14. OPERATE STIRRING MOTOR FOR 500 CYCLES, EACH CYCLE HAVING A DURATION OF 0.02 SECOND FOLLOWED BY A REST PERIOD OF 0.2 SECOND.

15. OPERATE MICROWAVE ENERGY GENERATING ASSEMBLY FOR 2 SECONDS AND ALSO OPERATE STIRRING MOTOR AS FOLLOWS:

OPERATE STIRRING MOTOR FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY.

OPERATE FANS DURING OPERATION OF MICROWAVE ENERGY GENERATING ASSEMBLY AND FOR AN ADDITIONAL APPROXIMATELY 20 MINUTES THEREAFTER.

16. OPERATE STIRRING MOTOR FOR 500 CYCLES, EACH CYCLE HAVING A DURATION OF 0.02 SECOND FOLLOWED BY A REST PERIOD OF 0.2 SECOND.

17. OPERATE MICROWAVE ENERGY GENERATING ASSEMBLY FOR 2 SECONDS AND ALSO OPERATE STIRRING MOTOR AS FOLLOWS:

OPERATE STIRRING MOTOR FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY.

OPERATE FANS DURING OPERATION OF MICROWAVE ENERGY GENERATING ASSEMBLY AND FOR AN ADDITIONAL APPROXIMATELY 20 MINUTES THEREAFTER.

18. OPERATE STIRRING MOTOR FOR 400 CYCLES, EACH CYCLE HAVING A DURATION OF 0.02 SECOND FOLLOWED BY A REST PERIOD OF 0.2 SECOND.

19. OPERATE MICROWAVE ENERGY GENERATING ASSEMBLY FOR 2 SECONDS AND ALSO OPERATE STIRRING MOTOR AS FOLLOWS:

OPERATE STIRRING MOTOR FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY.

OPERATE FANS DURING OPERATION OF MICROWAVE ENERGY GENERATING ASSEMBLY AND FOR AN ADDITIONAL APPROXIMATELY 20 MINUTES THEREAFTER.

20. OPERATE COLD WATER PUMP FOR 1 SECOND.

21. OPERATE STIRRING MOTOR FOR 400 CYCLES, EACH CYCLE HAVING A DURATION OF 0.02 SECOND FOLLOWED BY A REST PERIOD OF 0.2 SECOND.

22. OPERATE STIRRING MOTOR FOR 300 CYCLES, EACH CYCLE HAVING A DURATION OF 0.02 SECOND FOLLOWED BY A REST PERIOD OF 0.2 SECOND.

In accordance with a preferred embodiment of the present invention a PSCCCDC suitable for use in the method includes the following dry ingredients:

| GRAMS | ITEMS |
|---|---|
| 56 | FREEZE DRIED QUICK COOKING MACARONI |
| 17 | FREEZE DRIED MILK POWDER |
| 12 | FREEZE DRIED CHEDDAR CHEESE |
| 9 | FREEZE DRIED PARMESAN CHEESE |
| 9 | FREEZE DRIED MOZZARELLA CHEESE |
| 9 | AIR DRIED PRE-COOKED COATED SEASONED |
| | ONIONS |
| 6 | FREEZE DRIED SOUR CREAM POWDER |
| 3 | TOASTED BREAD CRUMBS |
| 1.3 | SALT |
| 0.4 | GROUND NUTMEG |
| 0.3 | GROUND BLACK PEPPER. |

In accordance with a preferred embodiment of the present invention the predetermined sequence includes the following steps:

1. OPERATE COLD WATER PUMP FOR 10 SECONDS.

OPERATE STIRRING MOTOR DURING THE ENTIRE PERIOD OF OPERATION OF COLD WATER PUMP.

2. OPERATE HOT WATER PUMP FOR 19 SECONDS AS FOLLOWS:

OPERATE HOT WATER PUMP FOR 6 CYCLES OF 3 SECONDS DURATION EACH, EACH CYCLE BEING SEPARATED BY A REST PERIOD OF 0.5 SECOND.

OPERATE MICROWAVE ENERGY GENERATING ASSEMBLY DURING THE ENTIRE DURATION OF OPERATION OF HOT WATER PUMP.

OPERATE FANS DURING OPERATION OF MICROWAVE ENERGY GENERATING ASSEMBLY AND FOR AN ADDITIONAL APPROXIMATELY 20 MINUTES THEREAFTER.

OPERATE STIRRING MOTOR FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY.

3. OPERATE STIRRING MOTOR CONTINUOUSLY FOR 2 SECONDS.

4. OPERATE MICROWAVE ENERGY GENERATING ASSEMBLY FOR 35 SECONDS AND EVERY 7.50 SECONDS DURING OPERATION OF THE MICROWAVE ENERGY GENERATING ASSEMBLY OPERATE AIR PUMP FOR 5 SECONDS.

ALSO OPERATE STIRRING MOTOR AS FOLLOWS:

OPERATE STIRRING MOTOR FOR 5 CYCLES, EACH CYCLE OF 0.02 SECOND FOLLOWED BY A REST PERIOD OF 0.2 SECOND.

OPERATE FANS DURING OPERATION OF MICROWAVE ENERGY GENERATING ASSEMBLY AND FOR AN ADDITIONAL APPROXIMATELY 20 MINUTES THEREAFTER.

5. OPERATE STIRRING MOTOR CONTINUOUSLY FOR 3 SECONDS.

6. OPERATE MICROWAVE ENERGY GENERATING ASSEMBLY FOR 45 SECONDS AND EVERY 7.50 SECONDS DURING OPERATION OF THE MICROWAVE ENERGY GENERATING ASSEMBLY ALSO OPERATE STIRRING MOTOR AS FOLLOWS:

OPERATE STIRRING MOTOR FOR 5 CYCLES, EACH CYCLE OF 0.02 SECOND FOLLOWED BY A REST PERIOD OF 0.2 SECOND.

OPERATE FANS DURING OPERATION OF MICROWAVE ENERGY GENERATING ASSEMBLY AND FOR AN ADDITIONAL APPROXIMATELY 20 MINUTES THEREAFTER.

7. OPERATE STIRRING MOTOR CONTINUOUSLY FOR 2 SECONDS.

8. OPERATE OLIVE OIL PUMP TO SUPPLY 20 GRAMS OF OLIVE OIL.

In accordance with a preferred embodiment of the present invention a PSCCCDC suitable for use in the method includes the following dry ingredients:

| GRAMS | ITEMS |
|---|---|
| 26 | FREEZE DRIED EGG POWDER |
| 10 | FREEZE DRIED DICED TOMATOES |
| 6 | FREEZE DRIED PUREED TOMATO PASTE |
| 4 | FREEZE DRIED DICED WHITE ONIONS |
| 3.5 | FREEZE DRIED DICED RED PEPPERS |
| 1.6 | SALT |
| 0.5 | FREEZE DRIED PARSLEY FLAKES |
| 0.5 | WHITE SUGAR |
| 0.2 | GROUND CHILI PEPPER |
| 0.1 | FREEZE DRIED OREGANO. |

Preferably, the predetermined sequence includes the following steps:

1. OPERATE HOT WATER PUMP FOR 10 SECONDS AS FOLLOWS:

OPERATE HOT WATER PUMP FOR 3 CYCLES OF 3 SECONDS DURATION EACH, EACH CYCLE BEING SEPARATED BY A REST PERIOD OF 0.5 SECOND.

2. STAND BY FOR 3 SECONDS.

3. OPERATE HOT WATER PUMP FOR 10 SECONDS AS FOLLOWS:

OPERATE HOT WATER PUMP FOR 3 CYCLES OF 3 SECONDS DURATION EACH, EACH CYCLE BEING SEPARATED BY A REST PERIOD OF 0.5 SECOND.

OPERATE STIRRING MOTOR DURING THE ENTIRE PERIOD OF OPERATION OF HOT WATER PUMP.

4. OPERATE HOT WATER PUMP FOR 5 SECONDS AS FOLLOWS:

OPERATE HOT WATER PUMP FOR 1 CYCLE OF 3 SECONDS DURATION, FOLLOWED BY A REST PERIOD OF 0.5 SECOND.

5. OPERATE AIR PUMP FOR 5 SECONDS.

6. OPERATE MICROWAVE ENERGY GENERATING ASSEMBLY FOR 20 SECONDS AND ALSO OPERATE STIRRING MOTOR AS FOLLOWS:

OPERATE STIRRING MOTOR FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY.

OPERATE FANS DURING OPERATION OF MICROWAVE ENERGY GENERATING ASSEMBLY AND FOR AN ADDITIONAL APPROXIMATELY 20 MINUTES THEREAFTER.

7. STAND BY FOR 5 SECONDS.

8. OPERATE HOT WATER PUMP FOR 9 SECONDS AS FOLLOWS:

OPERATE HOT WATER PUMP FOR 3 CYCLES OF 3 SECONDS DURATION EACH, EACH CYCLE BEING SEPARATED BY A REST PERIOD OF 0.5 SECOND.

OPERATE STIRRING MOTOR DURING THE ENTIRE PERIOD OF OPERATION OF HOT WATER PUMP.

9. OPERATE HOT WATER PUMP FOR 5 SECONDS AS FOLLOWS:

OPERATE HOT WATER PUMP FOR 1 CYCLE OF 3 SECONDS DURATION, FOLLOWED BY A REST PERIOD OF 0.5 SECONDS.

10. OPERATE AIR PUMP FOR 5 SECONDS.

11. OPERATE THE MICROWAVE ENERGY GENERATING ASSEMBLY FOR 30 SECONDS AND ALSO OPERATE STIRRING MOTOR AS FOLLOWS:

OPERATE STIRRING MOTOR FOR MULTIPLE CYCLES, EACH CYCLE OF 0.02 SECONDS FOLLOWED BY A REST PERIOD OF 0.2 SECONDS FOR THE DURATION OF OPERATION OF MICROWAVE ENERGY GENERATING ASSEMBLY.

OPERATE FANS DURING OPERATION OF MICROWAVE ENERGY GENERATING ASSEMBLY AND FOR AN ADDITIONAL APPROXIMATELY 20 MINUTES THEREAFTER.

12. OPERATE AIR PUMP FOR 5 SECONDS.

13. STAND BY FOR 6 SECONDS.

14. OPERATE MICROWAVE ENERGY GENERATING ASSEMBLY FOR 20 SECONDS AND ALSO OPERATE STIRRING MOTOR AS FOLLOWS:

OPERATE STIRRING MOTOR FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY.

OPERATE FANS DURING OPERATION OF MICROWAVE ENERGY GENERATING ASSEMBLY AND FOR AN ADDITIONAL APPROXIMATELY 20 MINUTES THEREAFTER.

15. STAND BY FOR 6 SECONDS.

16. OPERATE MICROWAVE ENERGY GENERATING ASSEMBLY FOR 10 SECONDS AND ALSO OPERATE STIRRING MOTOR AS FOLLOWS:

OPERATE STIRRING MOTOR FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY.

OPERATE FANS DURING OPERATION OF MICROWAVE ENERGY GENERATING ASSEMBLY AND FOR AN ADDITIONAL APPROXIMATELY 20 MINUTES THEREAFTER.

17. OPERATE AIR PUMP FOR 3 SECONDS.

18. OPERATE MICROWAVE ENERGY GENERATING ASSEMBLY FOR 10 SECONDS AND ALSO OPERATE STIRRING MOTOR AS FOLLOWS:

OPERATE STIRRING MOTOR FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY.

OPERATE FANS DURING OPERATION OF MICROWAVE ENERGY GENERATING ASSEMBLY AND FOR AN ADDITIONAL APPROXIMATELY 20 MINUTES THEREAFTER.

19. STAND BY FOR 2 SECONDS.

20. OPERATE MICROWAVE ENERGY GENERATING ASSEMBLY FOR 10 SECONDS AND ALSO OPERATE STIRRING MOTOR AS FOLLOWS:

OPERATE STIRRING MOTOR FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY.

OPERATE FANS DURING OPERATION OF MICROWAVE ENERGY GENERATING ASSEMBLY AND FOR AN ADDITIONAL APPROXIMATELY 20 MINUTES THEREAFTER.

21. STAND BY FOR 2 SECONDS.

22. OPERATE MICROWAVE ENERGY GENERATING ASSEMBLY FOR 10 SECONDS AND ALSO OPERATE STIRRING MOTOR AS FOLLOWS:

OPERATE STIRRING MOTOR FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY.

OPERATE FAN DURING OPERATION OF MICROWAVE ENERGY GENERATING ASSEMBLY AND FOR AN ADDITIONAL APPROXIMATELY 20 MINUTES THEREAFTER.

In accordance with a preferred embodiment of the present invention a PSCCCDC suitable for use in the method includes the following dry ingredients:

| GRAMS | ITEMS |
|---|---|
| 36 | FREEZE DRIED PRE-COOKED BASMATI RICE |
| 24 | AIR DRIED PRE-COOKED COATED SEASONED |
| | ONIONS |
| 13 | SPLIT ORANGE LENTILS |
| 8 | FREEZE DRIED BLACK LENTILS. |
| 7 | FREEZE DRIED BROWN LENTILS |
| 2 | SALT |
| 0.8 | FREEZE DRIED MINCED GARLIC |
| 0.4 | GROUND CINNAMON |
| 0.2 | GROUND CUMIN |
| 0.2 | GROUND PEPPER |
| 0.1 | GROUND CURCUMIN. |

In accordance with a preferred embodiment of the present invention the predetermined sequence includes the following steps:

1. OPERATE COLD WATER PUMP FOR 3 SECONDS.

2. OPERATE STIRRING MOTOR CONTINUOUSLY FOR 3 SECONDS.

3. OPERATE COLD WATER PUMP FOR 3 SECONDS.

4. OPERATE STIRRING MOTOR CONTINUOUSLY FOR 3 SECONDS.

5. OPERATE COLD WATER PUMP FOR 3 SECONDS.

6. OPERATE STIRRING MOTOR CONTINUOUSLY FOR 3 SECONDS.

7. OPERATE COLD WATER PUMP FOR 3 SECONDS.

8. OPERATE STIRRING MOTOR CONTINUOUSLY FOR 3 SECONDS.

9. OPERATE HOT WATER PUMP FOR 2 SECONDS.

10. OPERATE STIRRING MOTOR CONTINUOUSLY FOR 3 SECONDS.

11. OPERATE HOT WATER PUMP FOR 6 SECONDS AS FOLLOWS:

OPERATE HOT WATER PUMP FOR 2 CYCLES OF 3 SECONDS DURATION EACH, EACH CYCLE BEING SEPARATED BY A REST PERIOD OF 0.5 SECOND.

OPERATE STIRRING MOTOR DURING THE ENTIRE PERIOD OF OPERATION OF THE HOT WATER PUMP.

12. STAND BY FOR 5 SECONDS.

13. OPERATE HOT WATER PUMP FOR 6 SECONDS AS FOLLOWS:

OPERATE HOT WATER PUMP FOR 2 CYCLES OF 3 SECONDS DURATION EACH, EACH CYCLE BEING SEPARATED BY A REST PERIOD OF 0.5 SECOND.

OPERATE MICROWAVE ENERGY GENERATING ASSEMBLY DURING THE ENTIRE DURATION OF OPERATION OF HOT WATER PUMP.

OPERATE STIRRING MOTOR FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY.

OPERATE FANS DURING OPERATION OF MICROWAVE ENERGY GENERATING ASSEMBLY AND FOR AN ADDITIONAL APPROXIMATELY 20 MINUTES THEREAFTER.

14. OPERATE AIR PUMP FOR 5 SECONDS.

15. OPERATE MICROWAVE ENERGY GENERATING ASSEMBLY FOR 12 SECONDS AND ALSO OPERATE STIRRING MOTOR AS FOLLOWS:

OPERATE AIR PUMP FOR 5 SECONDS.

OPERATE STIRRING MOTOR FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY.

OPERATE FANS DURING OPERATION OF MICROWAVE ENERGY GENERATING ASSEMBLY AND FOR AN ADDITIONAL APPROXIMATELY 20 MINUTES THEREAFTER.

16. OPERATE COLD WATER PUMP FOR 1 SECOND.

17. OPERATE AIR PUMP FOR 5 SECONDS.

18. OPERATE MICROWAVE ENERGY GENERATING ASSEMBLY FOR 12 SECONDS AND ALSO OPERATE STIRRING MOTOR AS FOLLOWS:

OPERATE STIRRING MOTOR FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY.

OPERATE FANS DURING OPERATION OF MICROWAVE ENERGY GENERATING ASSEMBLY AND FOR AN ADDITIONAL APPROXIMATELY 20 MINUTES THEREAFTER.

19. OPERATE COLD WATER PUMP FOR 1 SECOND.

20. OPERATE AIR PUMP FOR 5 SECONDS.

21. OPERATE MICROWAVE ENERGY GENERATING ASSEMBLY FOR 12 SECONDS AND ALSO OPERATE STIRRING MOTOR AS FOLLOWS:

OPERATE STIRRING MOTOR FOR MULTIPLE CYCLES, EACH CYCLE OF 0.02 SECOND FOLLOWED BY A REST PERIOD OF 0.2 SECONDS FOR THE DURATION OF OPERATION OF MICROWAVE ENERGY GENERATING ASSEMBLY.

OPERATE FANS DURING OPERATION OF MICROWAVE ENERGY GENERATING ASSEMBLY AND FOR AN ADDITIONAL APPROXIMATELY 20 MINUTES THEREAFTER.

In accordance with a preferred embodiment of the present invention a PSCCCDC suitable for use in the method includes the following dry ingredients:

| GRAMS | ITEMS |
|---|---|
| 40 | INSTANT OATMEAL |
| 12 | DEMERARA SUGAR |
| 9 | FREEZE DRIED BANANA SLICES, 4-5 mm THICK |
| 8 | DRIED CRANBERRIES |
| 8 | FREEZE DRIED MILK POWDER |
| 0.3 | GROUND CINNAMON |
| 0.1 | GRATED VANILLA BEAN. |

In accordance with a preferred embodiment of the present invention the predetermined sequence includes the following steps:

1. OPERATE HOT WATER PUMP FOR 15 SECONDS AS FOLLOWS:

OPERATE HOT WATER PUMP FOR 5 CYCLES OF 3 SECONDS DURATION EACH, EACH CYCLE BEING SEPARATED BY A REST PERIOD OF 0.5 SECOND.

OPERATE STIRRING MOTOR DURING THE ENTIRE PERIOD OF OPERATION OF HOT WATER PUMP.

2. OPERATE MICROWAVE ENERGY GENERATING ASSEMBLY FOR 15 SECONDS AND EVERY 7.50 SECONDS DURING OPERATION OF MICROWAVE ENERGY GENERATING ASSEMBLY ALSO OPERATE STIRRING MOTOR AS FOLLOWS:

OPERATE AIR PUMP FOR 5 SECONDS.

OPERATE STIRRING MOTOR FOR 5 CYCLES, EACH CYCLE OF 0.02 SECOND FOLLOWED BY A REST PERIOD OF 0.2 SECOND.

OPERATE FANS DURING OPERATION OF MICROWAVE ENERGY GENERATING ASSEMBLY AND FOR AN ADDITIONAL APPROXIMATELY 20 MINUTES THEREAFTER.

3. OPERATE HOT WATER PUMP FOR 10 SECONDS AS FOLLOWS:

OPERATE HOT WATER PUMP FOR 3 CYCLES OF 3 SECONDS DURATION EACH, EACH CYCLE BEING SEPARATED BY A REST PERIOD OF 0.5 SECOND.

OPERATE MICROWAVE ENERGY GENERATING ASSEMBLY DURING THE ENTIRE DURATION OF OPERATION OF HOT WATER PUMP.

OPERATE STIRRING MOTOR FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY.

4. STAND BY FOR 5 SECONDS.

5. OPERATE HOT WATER PUMP FOR 15 SECONDS AS FOLLOWS:

OPERATE HOT WATER PUMP FOR 5 CYCLES OF 3 SECONDS DURATION EACH, EACH CYCLE BEING SEPARATED BY A REST PERIOD OF 0.5 SECONDS

OPERATE MICROWAVE ENERGY GENERATING ASSEMBLY DURING THE ENTIRE DURATION OF OPERATION OF HOT WATER PUMP.

OPERATE STIRRING MOTOR FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY.

6. OPERATE MICROWAVE ENERGY GENERATING ASSEMBLY FOR 20 SECONDS AND EVERY 7.50 SECONDS DURING OPERATION OF MICROWAVE ENERGY GENERATING ASSEMBLY ALSO OPERATE STIRRING MOTOR AS FOLLOWS:

OPERATE AIR PUMP FOR 5 SECONDS.

OPERATE STIRRING MOTOR FOR 5 CYCLES, EACH CYCLE OF 0.02 SECOND FOLLOWED BY A REST PERIOD OF 0.2 SECOND.

OPERATE FANS DURING OPERATION OF MICROWAVE ENERGY GENERATING ASSEMBLY AND FOR AN ADDITIONAL APPROXIMATELY 20 MINUTES THEREAFTER.

7. OPERATE AIR PUMP FOR 5 SECONDS.

8. OPERATE MICROWAVE ENERGY GENERATING ASSEMBLY FOR 15 SECONDS AND EVERY 7.50 SECONDS DURING OPERATION OF MICROWAVE ENERGY GENERATING ASSEMBLY ALSO OPERATE STIRRING MOTOR AS FOLLOWS:

OPERATE STIRRING MOTOR FOR 5 CYCLES, EACH CYCLE OF 0.02 SECOND FOLLOWED BY A REST PERIOD OF 0.2 SECOND.

OPERATE FANS DURING OPERATION OF MICROWAVE ENERGY GENERATING ASSEMBLY AND FOR AN ADDITIONAL APPROXIMATELY 20 MINUTES THEREAFTER.

9. OPERATE OLIVE OIL PUMP TO SUPPLY 20 GRAMS OF OLIVE OIL.

In accordance with a preferred embodiment of the present invention a PSCCCDC suitable for use in the method includes the following dry ingredients:

| GRAMS | ITEMS |
|---|---|
| 23 | SEASONED BREAD CROUTONS |
| 12 | FREEZED DRIED PUREED TOMATOES |
| 4.5 | FREEZE DRIED TOMATO PASTE POWDER |
| 3.5 | FREEZE DRIED DICED TOMATOES |
| 2.5 | SALT |
| 2.0 | FREEZE DRIED DICED WHITE ONIONS |
| 1.5 | WHITE SUGAR |
| 0.9 | FREEZE DRIED MINCED GARLIC |
| 0.3 | FREEZE DRIED BASIL FLAKES |
| 0.2 | COARSELY GROUND BLACK PEPPER. |

In accordance with a preferred embodiment of the present invention the predetermined sequence includes the following steps:

1. OPERATE COLD WATER PUMP FOR 6 SECONDS.

2. OPERATE STIRRING MOTOR CONTINUOUSLY FOR 7 SECONDS.

3. OPERATE MICROWAVE ENERGY GENERATING ASSEMBLY FOR 5 SECONDS.

OPERATE AIR PUMP FOR 5 SECONDS.

OPERATE FANS DURING OPERATION OF MICROWAVE ENERGY GENERATING ASSEMBLY AND FOR AN ADDITIONAL APPROXIMATELY 20 MINUTES THEREAFTER.

4. OPERATE STIRRING MOTOR CONTINUOUSLY FOR 5 SECONDS.

5. OPERATE MICROWAVE ENERGY GENERATING ASSEMBLY FOR 40 SECONDS AND EVERY 10 SECONDS DURING OPERATION OF MICROWAVE ENERGY GENERATING ASSEMBLY ALSO OPERATE STIRRING MOTOR AS FOLLOWS:

OPERATE STIRRING MOTOR FOR 5 CYCLES, EACH CYCLE OF 0.02 SECOND FOLLOWED BY A REST PERIOD OF 0.2 SECOND.

OPERATE FANS DURING OPERATION OF MICROWAVE ENERGY GENERATING ASSEMBLY AND FOR AN ADDITIONAL APPROXIMATELY 20 MINUTES THEREAFTER.

In accordance with a preferred embodiment of the present invention a PSCCCDC suitable for use in the method includes the following dry ingredients:

| GRAMS | ITEMS |
|---|---|
| 28 | WHITE SUGAR |
| 11 | STANDARD WHEAT FLOUR |
| 9 | FREEZE DRIED EGG POWDER |
| 8 | BITTERSWEET CHOCOLATE CHIPS |
| 6.5 | BAKING COCOA POWDER |
| 1.5 | BAKING POWDER |
| 0.1 | GRATED VANILLA BEAN. |

In accordance with a preferred embodiment of the present invention the predetermined sequence includes the following steps:

1. OPERATE HOT WATER PUMP FOR 5 SECONDS AS FOLLOWS:

OPERATE HOT WATER PUMP FOR 1 CYCLE OF 3 SECONDS DURATION, WITH THE CYCLE FOLLOWED BY A REST PERIOD OF 0.5 SECOND.

OPERATE STIRRING MOTOR DURING THE ENTIRE PERIOD OF OPERATION OF HOT WATER PUMP.

2. OPERATE HOT WATER PUMP FOR 18 SECONDS AS FOLLOWS:

OPERATE HOT WATER PUMP FOR 6 CYCLES OF 3 SECONDS DURATION EACH, EACH CYCLE BEING SEPARATED BY A REST PERIOD OF 0.5 SECONDS.

OPERATE MICROWAVE ENERGY GENERATING ASSEMBLY DURING THE ENTIRE DURATION OF OPERATION OF HOT WATER PUMP.

OPERATE STIRRING MOTOR FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY

3. OPERATE STIRRING MOTOR CONTINUOUSLY FOR 2 SECONDS.

4. OPERATE MICROWAVE ENERGY GENERATING ASSEMBLY FOR 60 SECONDS AND EVERY 10 SECONDS DURING OPERATION OF THE MICROWAVE ENERGY GENERATING ASSEMBLY ALSO OPERATE STIRRING MOTOR AS FOLLOWS:

OPERATE AIR PUMP FOR 5 SECONDS.

OPERATE STIRRING MOTOR FOR 5 CYCLES, EACH CYCLE OF 0.02 SECOND FOLLOWED BY A REST PERIOD OF 0.2 SECOND.

OPERATE FANS DURING OPERATION OF MICROWAVE ENERGY GENERATING ASSEMBLY AND FOR AN ADDITIONAL APPROXIMATELY 20 MINUTES THEREAFTER.

5. OPERATE STIRRING MOTOR CONTINUOUSLY FOR 3 SECONDS.

In accordance with a preferred embodiment of the present invention a PSCCCDC suitable for use in the method includes the following dry ingredients:

| GRAMS | ITEMS |
|---|---|
| 29 | FREEZE DRIED NOODLES |
| 15 | FREEZE DRIED PEANUT BUTTER POWDER |
| 12 | FREEZE DRIED COCONUT MILK POWDER |
| 11 | DICED ROASTED PEANUTS |
| 4 | FREEZE DRIED CORN KERNELS |
| 4 | FREEZE DRIED SOY POWDER |
| 3 | FREEZE DRIED SLICED WHITE BUTTON MUSHROOMS |
| 3 | FREEZE DRIED GARDEN PEAS |
| 3 | FREEZE DRIED DICED CARROTS |
| 1.5 | FREEZE DRIED MINCED GREEN ONIONS |
| 0.8 | FREEZE DRIED GRATED GINGER |
| 0.7 | FREEZE DRIED MINCED GARLIC |
| 0.2 | FREEZE DRIED CHOPPED CORIANDER LEAF FLAKES |
| 0.2 | FREEZE DRIED GRATED LEMON PEEL |
| 0.2 | FREEZE DRIED CHOPPED BASIL. |

In accordance with a preferred embodiment of the present invention the predetermined sequence includes the following steps:

1. OPERATE HOT WATER PUMP FOR 6 SECONDS AS FOLLOWS:

OPERATE HOT WATER PUMP FOR 2 CYCLES OF 3 SECONDS DURATION EACH, EACH CYCLE BEING SEPARATED BY A REST PERIOD OF 0.5 SECOND.

OPERATE STIRRING MOTOR DURING THE ENTIRE PERIOD OF OPERATION OF HOT WATER PUMP.

2. OPERATE HOT WATER PUMP FOR 18 SECONDS AS FOLLOWS:

OPERATE HOT WATER PUMP FOR 6 CYCLES OF 3 SECONDS DURATION EACH, EACH CYCLE BEING SEPARATED BY A REST PERIOD OF 0.5 SECOND.

OPERATE MICROWAVE ENERGY GENERATING ASSEMBLY DURING THE ENTIRE DURATION OF OPERATION OF HOT WATER PUMP.

OPERATE STIRRING MOTOR FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY.

OPERATE FANS DURING OPERATION OF MICROWAVE ENERGY GENERATING ASSEMBLY AND FOR AN ADDITIONAL APPROXIMATELY 20 MINUTES THEREAFTER.

3. OPERATE STIRRING MOTOR CONTINUOUSLY FOR 2 SECONDS.

4. OPERATE MICROWAVE ENERGY GENERATING ASSEMBLY FOR 60 SECONDS AND EVERY 10 SECONDS DURING OPERATION OF THE MICROWAVE ENERGY GENERATING ASSEMBLY ALSO OPERATE STIRRING MOTOR AS FOLLOWS:

OPERATE AIR PUMP FOR 5 SECONDS.

OPERATE STIRRING MOTOR FOR 5 CYCLES, EACH CYCLE OF 0.02 SECOND FOLLOWED BY A REST PERIOD OF 0.2 SECOND.

OPERATE FANS DURING OPERATION OF MICROWAVE ENERGY GENERATING ASSEMBLY AND FOR AN ADDITIONAL APPROXIMATELY 20 MINUTES THEREAFTER.

5. OPERATE STIRRING MOTOR CONTINUOUSLY FOR 2 SECONDS.

6. OPERATE OLIVE OIL PUMP TO SUPPLY 18 GRAMS OF OLIVE OIL.

In accordance with a preferred embodiment of the present invention a PSCCCDC suitable for use in the method includes the following dry ingredients:

| GRAMS | ITEMS |
|---|---|
| 27 | RED QUINOA |
| 10 | ROASTED UNPEELED SMALL WHOLE ALMONDS |
| 7 | FREEZE DRIED WASABI COATED PEAS |
| 7 | FREEZE DRIED FIRM TOFU CUBES |
| 4 | FREEZE DRIED SOY POWDER |
| 3 | FREEZE DRIED ZUCCHINI 2 MM HALF SLICE |
| | MEDALLIONS |
| 3 | FREEZE DRIED ASPARAGUS 2 MM MEDALLIONS |
| 2 | FREEZE DRIED CHOPPED BLANCHED SPINACH |
| 1.5 | FREEZE DRIED DICED GREEN ONIONS |
| 1 | FREEZE DRIED DICED CELERY STALK |
| 0.4 | FREEZE DRIED MINCED PARSLEY |
| 0.4 | FREEZE DRIED MINCED GARLIC |
| 0.3 | GROUND BLACK PEPPER. |

In accordance with a preferred embodiment of the present invention the predetermined sequence includes the following steps:

1. OPERATE HOT WATER PUMP FOR 1 CYCLE OF 2 SECONDS DURATION FOLLOWED BY A REST PERIOD OF 0.5 SECOND.

2. STAND BY FOR 5 SECONDS.

3. OPERATE HOT WATER PUMP FOR 9 SECONDS AS FOLLOWS:

OPERATE HOT WATER PUMP FOR 3 CYCLES OF 3 SECONDS DURATION EACH, EACH CYCLE BEING SEPARATED BY A REST PERIOD OF 0.5 SECOND.

OPERATE STIRRING MOTOR DURING THE ENTIRE PERIOD OF OPERATION OF HOT WATER PUMP.

4. OPERATE HOT WATER PUMP FOR 12 SECONDS AS FOLLOWS:

OPERATE HOT WATER PUMP FOR 4 CYCLES OF 3 SECONDS DURATION EACH, EACH CYCLE BEING SEPARATED BY A REST PERIOD OF 0.5 SECOND.

OPERATE MICROWAVE ENERGY GENERATING ASSEMBLY DURING THE ENTIRE DURATION OF OPERATION OF HOT WATER PUMP.

OPERATE STIRRING MOTOR FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY.

OPERATE FANS DURING OPERATION OF MICROWAVE ENERGY GENERATING ASSEMBLY AND FOR AN ADDITIONAL APPROXIMATELY 20 MINUTES THEREAFTER.

5. OPERATE MICROWAVE ENERGY GENERATING ASSEMBLY FOR 15 SECONDS AND EVERY 7.50 SECONDS DURING OPERATION OF MICROWAVE ENERGY GENERATING ASSEMBLY ALSO OPERATE STIRRING MOTOR AS FOLLOWS:

OPERATE AIR PUMP FOR 5 SECONDS.

OPERATE STIRRING MOTOR FOR 5 CYCLES, EACH CYCLE OF 0.02 SECOND FOLLOWED BY A REST PERIOD OF 0.2 SECOND.

OPERATE FANS DURING OPERATION OF MICROWAVE ENERGY GENERATING ASSEMBLY AND FOR AN ADDITIONAL APPROXIMATELY 20 MINUTES THEREAFTER.

6. OPERATE HOT WATER PUMP FOR 9 SECONDS AS FOLLOWS:

OPERATE HOT WATER PUMP FOR 3 CYCLES OF 3 SECONDS DURATION EACH, EACH CYCLE BEING SEPARATED BY A REST PERIOD OF 0.5 SECOND.

OPERATE MICROWAVE ENERGY GENERATING ASSEMBLY DURING THE ENTIRE DURATION OF OPERATION OF HOT WATER PUMP.

OPERATE STIRRING MOTOR FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY.

OPERATE FANS DURING OPERATION OF MICROWAVE ENERGY GENERATING ASSEMBLY AND FOR AN ADDITIONAL APPROXIMATELY 20 MINUTES THEREAFTER.

7. OPERATE MICROWAVE ENERGY GENERATING ASSEMBLY FOR 15 SECONDS AND EVERY 7.50 SECONDS DURING OPERATION OF MICROWAVE ENERGY GENERATING ASSEMBLY ALSO OPERATE STIRRING MOTOR AS FOLLOWS:

OPERATE STIRRING MOTOR FOR 5 CYCLES, EACH CYCLE OF 0.02 SECOND FOLLOWED BY A REST PERIOD OF 0.2 SECOND.

OPERATE FANS DURING OPERATION OF MICROWAVE ENERGY GENERATING ASSEMBLY AND FOR AN ADDITIONAL APPROXIMATELY 20 MINUTES THEREAFTER.

8. OPERATE AIR PUMP FOR 2 SECONDS.

9. OPERATE MICROWAVE ENERGY GENERATING ASSEMBLY FOR 15 SECONDS AND EVERY 7.50 SECONDS DURING OPERATION OF THE MICROWAVE ENERGY GENERATING ASSEMBLY ALSO OPERATE STIRRING MOTOR AS FOLLOWS:

OPERATE STIRRING MOTOR FOR 5 CYCLES, EACH CYCLE OF 0.02 SECOND FOLLOWED BY A REST PERIOD OF 0.2 SECOND.

OPERATE FANS DURING OPERATION OF MICROWAVE ENERGY GENERATING ASSEMBLY AND FOR AN ADDITIONAL APPROXIMATELY 20 MINUTES THEREAFTER.

10. STAND BY FOR 4 SECONDS.

11. OPERATE MICROWAVE ENERGY GENERATING ASSEMBLY FOR 15 SECONDS AND EVERY 7.50 SECONDS DURING OPERATION OF THE MICROWAVE ENERGY GENERATING ASSEMBLY ALSO OPERATE STIRRING MOTOR AS FOLLOWS:

OPERATE STIRRING MOTOR FOR 5 CYCLES, EACH CYCLE OF 0.02 SECOND FOLLOWED BY A REST PERIOD OF 0.2 SECOND.

OPERATE FANS DURING OPERATION OF MICROWAVE ENERGY GENERATING ASSEMBLY AND FOR AN ADDITIONAL APPROXIMATELY 20 MINUTES THEREAFTER.

12. OPERATE AIR PUMP FOR 2 SECONDS.

13. OPERATE MICROWAVE ENERGY GENERATING ASSEMBLY FOR 15 SECONDS AND EVERY 7.50 SECONDS DURING OPERATION OF THE MICROWAVE ENERGY GENERATING ASSEMBLY ALSO OPERATE STIRRING MOTOR AS FOLLOWS:

OPERATE STIRRING MOTOR FOR 5 CYCLES, EACH CYCLE OF 0.02 SECOND FOLLOWED BY A REST PERIOD OF 0.2 SECOND.

OPERATE FANS DURING OPERATION OF MICROWAVE ENERGY GENERATING ASSEMBLY AND FOR AN ADDITIONAL APPROXIMATELY 20 MINUTES THEREAFTER.

14. STAND BY FOR 4 SECONDS.

15. OPERATE MICROWAVE ENERGY GENERATING ASSEMBLY FOR 15 SECONDS AND EVERY 7.50 SECONDS DURING OPERATION OF MICROWAVE ENERGY GENERATING ASSEMBLY ALSO OPERATE STIRRING MOTOR AS FOLLOWS:

OPERATE STIRRING MOTOR FOR 5 CYCLES, EACH CYCLE OF 0.02 SECOND FOLLOWED BY A REST PERIOD OF 0.2 SECOND.

OPERATE FANS DURING OPERATION OF MICROWAVE ENERGY GENERATING ASSEMBLY AND FOR AN ADDITIONAL APPROXIMATELY 20 MINUTES THEREAFTER.

16. STAND BY FOR 8 SECONDS.

17. OPERATE MICROWAVE ENERGY GENERATING ASSEMBLY FOR 15 SECONDS AND EVERY 7.50 SECONDS DURING OPERATION OF MICROWAVE ENERGY GENERATING ASSEMBLY ALSO OPERATE STIRRING MOTOR AS FOLLOWS:

OPERATE STIRRING MOTOR FOR 5 CYCLES, EACH CYCLE OF 0.02 SECOND FOLLOWED BY A REST PERIOD OF 0.2 SECOND.

OPERATE FANS DURING OPERATION OF MICROWAVE ENERGY GENERATING ASSEMBLY AND FOR AN ADDITIONAL APPROXIMATELY 20 MINUTES THEREAFTER.

18. OPERATE OLIVE OIL PUMP TO SUPPLY 18 GRAMS OF OLIVE OIL.

In accordance with a preferred embodiment of the present invention a PSCCCDC suitable for use in the method includes the following dry ingredients:

| GRAMS | ITEMS |
|---|---|
| 45 | QUICK COOKING ELBOW PASTA |
| 10 | FREEZE DRIED PUREED TOMATOES |
| 5 | FREEZE DRIED DICED TOMATOES |
| 4 | TOMATO PASTE POWDER |
| 2.5 | SALT |
| 1.7 | WHITE SUGAR |
| 0.8 | FREEZE DRIED GARLIC POWDER |
| 0.3 | FREEZE DRIED BASIL |
| 0.2 | GROUND CHILI PEPPER |
| 0.2 | FREEZE DRIED FINELY GROUND BEET POWDER |
| 0.2 | FREEZE DRIED OREGANO |

In accordance with a preferred embodiment of the present invention the predetermined sequence includes the following steps:

1. OPERATE HOT WATER PUMP FOR 30 SECONDS AS FOLLOWS:

OPERATE HOT WATER PUMP FOR 10 CYCLES OF 3 SECONDS DURATION EACH, EACH CYCLE BEING SEPARATED BY A REST PERIOD OF 0.5 SECOND.

2. OPERATE HOT WATER PUMP FOR 7 SECONDS AS FOLLOWS:

OPERATE HOT WATER PUMP FOR 2 CYCLES OF 3 SECONDS DURATION EACH, EACH CYCLE BEING SEPARATED BY A REST PERIOD OF 0.5 SECOND.

OPERATE MICROWAVE ENERGY GENERATING ASSEMBLY DURING THE ENTIRE DURATION OF OPERATION OF HOT WATER PUMP.

OPERATE STIRRING MOTOR FOR MULTIPLE CYCLES, EACH CYCLE OF 0.02 SECOND FOLLOWED BY A REST PERIOD OF 0.2 SECONDS FOR THE 7 SECONDS DURATION OF OPERATION OF MICROWAVE ENERGY GENERATING ASSEMBLY.

OPERATE FANS DURING OPERATION OF MICROWAVE ENERGY GENERATING ASSEMBLY AND FOR AN ADDITIONAL APPROXIMATELY 20 MINUTES THEREAFTER.

3. OPERATE HOT WATER PUMP FOR 4 SECONDS AS FOLLOWS:

OPERATE HOT WATER PUMP FOR 1 CYCLE OF 3 SECONDS DURATION, WITH A REST PERIOD OF 0.5 SECONDS, FOLLOWED BY 1 CYCLE OF 1 SECOND DURATION.

OPERATE MICROWAVE ENERGY GENERATING ASSEMBLY DURING THE ENTIRE 4 SECONDS DURATION OF OPERATION OF HOT WATER PUMP.

OPERATE STIRRING MOTOR FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY.

OPERATE FANS DURING OPERATION OF MICROWAVE ENERGY GENERATING ASSEMBLY AND FOR AN ADDITIONAL APPROXIMATELY 20 MINUTES THEREAFTER.

4. OPERATE MICROWAVE ENERGY GENERATING ASSEMBLY FOR 15 SECONDS AND ALSO OPERATE STIRRING MOTOR AS FOLLOWS:

OPERATE AIR PUMP FOR 5 SECONDS.

OPERATE STIRRING MOTOR FOR MULTIPLE CYCLES, EACH CYCLE OF 0.02 SECOND FOLLOWED BY A REST PERIOD OF 0.2 SECONDS FOR THE DURATION OF OPERATION OF MICROWAVE ENERGY GENERATING ASSEMBLY.

OPERATE FANS DURING OPERATION OF MICROWAVE ENERGY GENERATING ASSEMBLY AND FOR AN ADDITIONAL APPROXIMATELY 20 MINUTES THEREAFTER.

5. OPERATE MICROWAVE ENERGY GENERATING ASSEMBLY FOR 15 SECONDS AND ALSO OPERATE STIRRING MOTOR AS FOLLOWS:

OPERATE STIRRING MOTOR FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY.

OPERATE FANS DURING OPERATION OF MICROWAVE ENERGY GENERATING ASSEMBLY AND FOR AN ADDITIONAL APPROXIMATELY 20 MINUTES THEREAFTER.

6. OPERATE MICROWAVE ENERGY GENERATING ASSEMBLY FOR 15 SECONDS AND ALSO OPERATE STIRRING MOTOR AS FOLLOWS:

OPERATE STIRRING MOTOR FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY.

OPERATE FANS DURING OPERATION OF MICROWAVE ENERGY GENERATING ASSEMBLY AND FOR AN ADDITIONAL APPROXIMATELY 20 MINUTES THEREAFTER.

7. OPERATE MICROWAVE ENERGY GENERATING ASSEMBLY FOR 15 SECONDS AND ALSO OPERATE STIRRING MOTOR AS FOLLOWS:

OPERATE STIRRING MOTOR FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY.

OPERATE FANS DURING OPERATION OF MICROWAVE ENERGY GENERATING ASSEMBLY AND FOR AN ADDITIONAL APPROXIMATELY 20 MINUTES THEREAFTER.

8. OPERATE MICROWAVE ENERGY GENERATING ASSEMBLY FOR 15 SECONDS AND ALSO OPERATE STIRRING MOTOR AS FOLLOWS:

OPERATE STIRRING MOTOR FOR MULTIPLE CYCLES, EACH CYCLE OF 0.02 SECOND FOLLOWED BY A REST PERIOD OF 0.2 SECOND FOR THE DURATION OF OPERATION OF THE MICROWAVE ENERGY GENERATING ASSEMBLY.

OPERATE FANS DURING OPERATION OF MICROWAVE ENERGY GENERATING ASSEMBLY AND FOR AN ADDITIONAL APPROXIMATELY 20 MINUTES THEREAFTER.

9. OPERATE MICROWAVE ENERGY GENERATING ASSEMBLY FOR 5 SECONDS AND ALSO OPERATE STIRRING MOTOR AS FOLLOWS:

OPERATE STIRRING MOTOR FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY.

OPERATE FANS DURING OPERATION OF MICROWAVE ENERGY GENERATING ASSEMBLY AND FOR AN ADDITIONAL APPROXIMATELY 20 MINUTES THEREAFTER.

10. OPERATE MICROWAVE ENERGY GENERATING ASSEMBLY FOR 5 SECONDS AND ALSO OPERATE STIRRING MOTOR AS FOLLOWS:

OPERATE STIRRING MOTOR FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY.

OPERATE FANS DURING OPERATION OF MICROWAVE ENERGY GENERATING ASSEMBLY AND FOR AN ADDITIONAL APPROXIMATELY 20 MINUTES THEREAFTER.

11. OPERATE MICROWAVE ENERGY GENERATING ASSEMBLY FOR 5 SECONDS AND ALSO OPERATE STIRRING MOTOR AS FOLLOWS:

OPERATE STIRRING MOTOR FOR MULTIPLE CYCLES, EACH CYCLE OF 0.02 SECOND FOLLOWED BY A REST PERIOD OF 0.2 SECOND FOR THE DURATION OF OPERATION OF THE MICROWAVE ENERGY GENERATING ASSEMBLY.

OPERATE FANS DURING OPERATION OF MICROWAVE ENERGY GENERATING ASSEMBLY AND FOR AN ADDITIONAL APPROXIMATELY 20 MINUTES THEREAFTER.

12. OPERATE MICROWAVE ENERGY GENERATING ASSEMBLY FOR 5 SECONDS AND ALSO OPERATE STIRRING MOTOR AS FOLLOWS:

OPERATE STIRRING MOTOR FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY.

OPERATE FANS DURING OPERATION OF MICROWAVE ENERGY GENERATING ASSEMBLY AND FOR AN ADDITIONAL APPROXIMATELY 20 MINUTES THEREAFTER.

13. OPERATE MICROWAVE ENERGY GENERATING ASSEMBLY FOR 5 SECONDS AND ALSO OPERATE STIRRING MOTOR AS FOLLOWS:

OPERATE STIRRING MOTOR FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY.

OPERATE FANS DURING OPERATION OF MICROWAVE ENERGY GENERATING ASSEMBLY AND FOR AN ADDITIONAL APPROXIMATELY 20 MINUTES THEREAFTER.

14. OPERATE OLIVE OIL PUMP TO SUPPLY 18 GRAMS OF OLIVE OIL.

15. STAND BY FOR 30 SECONDS.

In accordance with a preferred embodiment of the present invention a PSCCCDC suitable for use in the method includes the following dry ingredients:

| GRAMS | ITEMS |
|---|---|
| 57 | INSTANT MEDIUM SIZE COUSCOUS |
| 12 | DRIED CRANBERRIES |
| 12 | FREEZE DRIED ROASTED SMALL UNPEELED |
| | ALMONDS |
| 10 | FREEZE DRIED PRE-COOKED HADAS CHICKPEAS |
| 5 | FREEZE DRIED DICED CARROTS |
| 2 | SALT |
| 0.4 | GROUND CINNAMON |
| 0.3 | FREEZE DRIED CORIANDER LEAF FLAKES |
| 0.2 | GROUND CURCUMIN |
| 0.2 | GROUND HOT PAPRIKA. |

There is also provided in accordance with a preferred embodiment of the present invention an automated, computer-controlled, cooking management method for use with user selectable ones of a plurality of different PSCCCCDCs useful in preparing corresponding different food products and a multiplicity of computer-controlled cooking units, each including at least a wireless communicator, the method including communicating operational details of cooking operations carried out by each of the computer-controlled cooking units to at least one remote central cooking data monitoring unit.

In accordance with a preferred embodiment of the present invention an automated, computer-controlled, cooking management method, for use with user selectable ones of a plurality of different PSCCCCDCs useful in preparing corresponding different food products and a multiplicity of computer-controlled cooking units, each including at least a wireless communicator, includes communicating operational details of cooking operations carried out by each of the computer-controlled cooking units to at least one remote central cooking data monitoring unit.

In accordance with a preferred embodiment of the present invention an automated, computer-controlled, cooking management method, for use with user selectable ones of a plurality of different PSCCCCDCs useful in preparing corresponding different food products and a multiplicity of computer-controlled cooking units, each including at least a wireless communicator, includes communicating operational details of cooking operations carried out by each of the computer-controlled cooking units to at least one remote central cooking data monitoring unit.

Preferably, the method also includes wirelessly communicating computer cooking protocols to at least some of the multiplicity of computer-controlled cooking units.

There is also provided in accordance with still another preferred embodiment of the present invention an automated, computer-controlled, cooking management method for use with user selectable ones of a plurality of different PSCCCCDCs useful in preparing corresponding different food products and a multiplicity of computer-controlled cooking units, each including at least a wireless communicator, the method including wirelessly communicating computer cooking protocols to at least some of the multiplicity of computer-controlled cooking units.

In accordance with a preferred embodiment of the present invention an automated, computer-controlled, cooking management method, for use with user selectable ones of a plurality of different PSCCCCDCs useful in preparing corresponding different food products and a multiplicity of computer-controlled cooking units, each including at least a wireless communicator, includes wirelessly communicating computer cooking protocols to at least some of the multiplicity of computer-controlled cooking units.

In accordance with a preferred embodiment of the present invention an automated, computer-controlled, cooking management method, for use with user selectable ones of a plurality of different PSCCCCDCs useful in preparing corresponding different food products and a multiplicity of computer-controlled cooking units, each including at least a wireless communicator, includes wirelessly communicating computer cooking protocols to at least some of the multiplicity of computer-controlled cooking units.

Preferably, the wireless communicating employs an internet-based network.

In accordance with a preferred embodiment of the present invention the method includes quality control functionality. Additionally or alternatively, the method includes cooking operation defect correction functionality. Additionally or alternatively, the method includes recipe update functionality. Alternatively or additionally, the method enables recipe sharing among users of the multiplicity of computer-controlled cooking units.

In accordance with a preferred embodiment of the present invention the method includes monitoring supply and usage of specific PSCCCCDCs. Additionally or alternatively, the method includes counterfeit detection functionality by monitoring supply and usage of specific PSCCCCDCs which are uniquely identified. Additionally, the method includes counterfeit prevention functionality by preventing usage of specific PSCCCCDCs which are uniquely identified as already having been used.

Preferably, the method includes malfunction detection functionality by monitoring computerized cooking protocols carried out by the multiplicity of computer-controlled cooking units and matching them to stored computerized cooking protocols assigned to identified PSCCCCDCs whose contents are being cooked.

In accordance with a preferred embodiment of the present invention the method includes quality control functionality by monitoring computerized cooking protocols carried out by the multiplicity of computer-controlled cooking units and matching them to stored computerized cooking protocols assigned to identified PSCCCCDCs whose contents are being cooked and preventing dispensing of cooked products in the event of a mismatch.

In accordance with a preferred embodiment of the present invention the method includes supply and usage monitoring functionality by monitoring supply and usage of specific types of PSCCCCDCs at given times. Additionally or alternatively, the method includes supply and usage monitoring functionality by monitoring supply and usage of specific types of PSCCCCDCs in given geographical locations.

In accordance with a preferred embodiment of the present invention the method includes supply and usage monitoring functionality by monitoring supply and usage of specific types of PSCCCCDCs and correlating usage with seasons and geographical locations. Preferably, the method includes individual user usage monitoring functionality by monitoring usage of PSCCCCDCs by identified users. Additionally or alternatively, the method includes individual user calorie consumption monitoring functionality by monitoring usage of identified PSCCCCDCs by identified users.

In accordance with a preferred embodiment of the present invention the method includes flushing residues of previous supplied liquids into the contents of the user-selected one of the plurality of different PSCCCCDCs.

In accordance with a preferred embodiment of the present invention the method includes supplying pressurized air during cooking to lower temperature and pressure within the PSCCCCDC. Additionally or alternatively, the method includes supplying liquids to the container during the cooking.

Preferably, the method includes bringing the contents of the container to boiling in the PSCCCCDC. Additionally or alternatively, the method includes cooling contents of the PSCCCCDC after at least partial cooking thereof.

### BRIEF DESCRIPTION OF THE DRAWINGS

The present invention will be understood and appreciated more fully from the following detailed description, taken in conjunction with the drawings in which:

FIGS. 1A and 1B are simplified, respectively front-facing and rear-facing pictorial illustrations of a computer-controlled cooking system constructed and operative in accordance with a preferred embodiment of the present invention;

FIGS. 2A and 2B are simplified pictorial illustrations of the computer-controlled cooking system of FIGS. 1A & 1B, which are partially disassembled on mutually opposite sides thereof;

FIG. 3 is a simplified partial exploded view illustration of the computer-controlled cooking system of FIGS. 1A-2B;

FIGS. 4A & 4B are simplified top-facing and bottom facing pictorial illustrations of a first chassis element, forming part of the computer-controlled cooking system of FIGS. 1A-3;

FIGS. 5A & 5B are simplified top-facing and bottom facing pictorial illustrations of a second chassis element, forming part of the computer-controlled cooking system of FIGS. 1A-3;

FIGS. 6A & 6B are simplified top-facing and bottom facing pictorial illustrations of a third chassis element, forming part of the computer-controlled cooking system of FIGS. 1A-3;

FIGS. 7A, 7B and 7C are simplified respective pictorial exploded view, front view and back view illustrations of a microwave cooling chamber, forming part of the computer-controlled cooking system of FIGS. 1A-3 and mounted on the first and second chassis elements;

FIGS. 8A and 8B are simplified top and bottom view illustrations of a chassis element forming part of a microwave cooking enclosure, which is part of the microwave heating subsystem of FIGS. 7A-7C;

FIGS. 9A and 9B are simplified top and bottom view illustrations of another chassis element forming part of the microwave cooking enclosure of FIGS. 7A & 7B;

FIGS. 10A and 10B are simplified top and bottom view illustrations of yet another chassis element forming part of the microwave cooking enclosure of FIGS. 7A & 7B;

FIGS. 11A and 11B are simplified top and bottom view illustrations of still another chassis element forming part of the microwave cooking enclosure of FIGS. 7A & 7B;

FIGS. 12A and 12B are simplified top and bottom view illustrations of a further chassis element forming part of the microwave cooking enclosure of FIGS. 7A & 7B;

FIG. 13A is a simplified exploded view of a first embodiment of a pre-sealed computerized cooking container containing dried contents (PSCCCCDC) useful in the computer-controlled cooking system of FIGS. 1A-18;

FIG. 13B is a simplified exploded view of a second embodiment of a pre-sealed computerized cooking container containing dried contents (PSCCCCDC) useful in the computer-controlled cooking system of FIGS. 1A-18;

FIGS. 14A, 14B, 14C, 14D and 14E are simplified respective first and second pictorial, top view, side view and exploded view illustrations of a pre-sealed computerized cooking container containing dried contents (PSCCCCDC) insertion, locking, stirring and serving subsystem, forming part of the computer-controlled cooking system of FIGS. 1A-3;

FIGS. 15A, 15B, 15C, 15D, 15E, 15F, 15G and 15H are simplified illustrations of various stages of pre-cooking operation of the PSCCCCDC insertion, locking, stirring and serving subsystem of FIGS. 14A-14E employing the first embodiment of a PSCCCCDC as shown in FIG. 13A;

FIGS. 15I, 15J, 15K, 15L, and 15M are simplified illustrations of various stages of pre-cooking operation of the PSCCCCDC insertion, locking, stirring and serving subsystem of FIGS. 14A-14E employing the second embodiment of a PSCCCCDC as shown in FIG. 13B, FIGS. 15I, 15J, 15K, 15L, and 15M showing stages corresponding to the stages illustrated in FIGS. 15C, 15D, 15E, 15F and 15G;

FIGS. 16A, 16B, 16C, 16D and 16E are simplified illustrations of various stages of cooking operation of the PSCCCCDC insertion, locking, stirring and serving subsystem of FIGS. 14A-14E employing the first embodiment of a PSCCCCDC as shown in FIG. 13A;

FIG. 16F is a simplified illustration of a stage of cooking operation of the PSCCCCDC insertion, locking, stirring and serving subsystem of FIGS. 14A-14E employing the second embodiment of a PSCCCCDC as shown in FIG. 13B, FIG. 16F illustrating a stage corresponding to the stage illustrated in FIG. 16E;

FIGS. 17A, 17B, 17C and 17D are simplified illustrations of various stages of post-cooking operation of the PSCCCCDC insertion, locking, stirring and serving subsystem of FIGS. 14A-14E, employing the first embodiment of a PSCCCCDC as shown in FIG. 13A;

FIGS. 17E, 17F and 17G are simplified illustrations of various stages of post-cooking operation of the PSCCCCDC insertion, locking, stirring and serving subsystem of FIGS. 14A-14E, employing the second embodiment of a PSCCCCDC as shown in FIG. 13B, FIGS. 17E, 17F and 17G showing stages corresponding to the stages illustrated in FIGS. 17B, 17C and 17D;

FIG. 18 is a simplified illustration of a fluid supply subsystem including a liquid supply subsystem and forming part of the computer-controlled cooking system of FIGS. 1A-3;

FIG. 19 is a simplified electrical functional block diagram of the electrically operated components of the computer-controlled cooking system of FIGS. 1A-3;

FIG. 20 is a simplified network diagram of a cloud-based network interconnecting a multiplicity of computer-controlled cooking systems of the type illustrated in FIGS. 1A-3; and

FIGS. 21A, 21B, 21C, 21D, 21E, 21F, 21G, 21H, 21I, 21J, 21K, 21L, 21M, 21N, 21O and 21P are simplified schematic illustrations of operational states corresponding to various sub-protocols governing the operation of part of the computer-controlled cooking system at a plurality of cooking operation stages which occur in accordance with a preferred embodiment of the present invention.

### DETAILED DESCRIPTION OF A PREFERRED EMBODIMENT

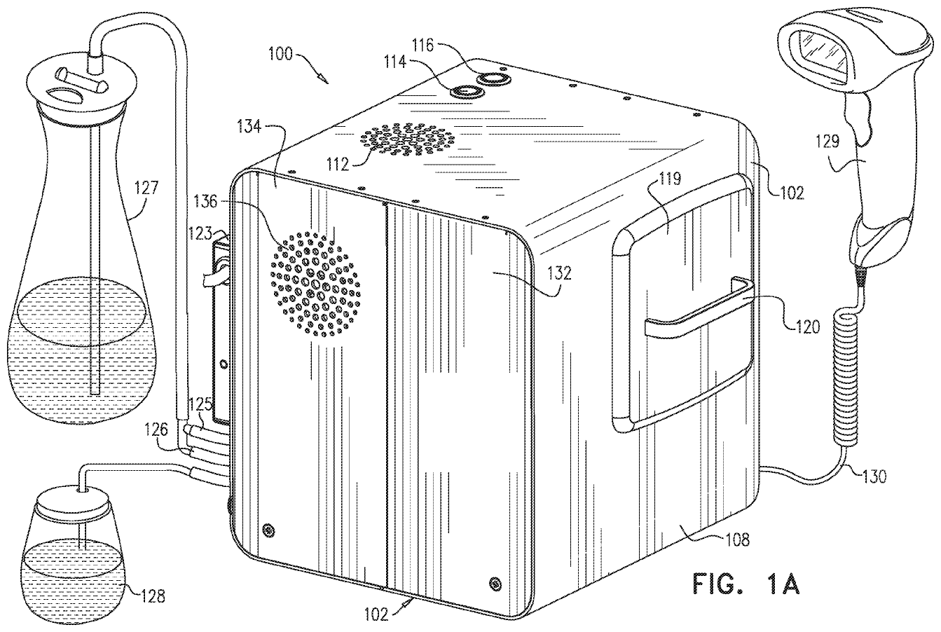

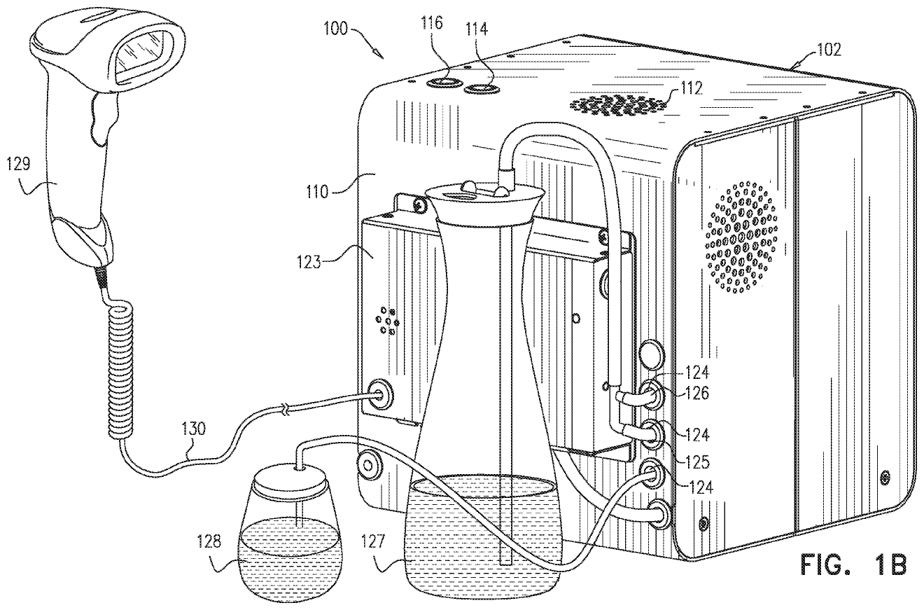

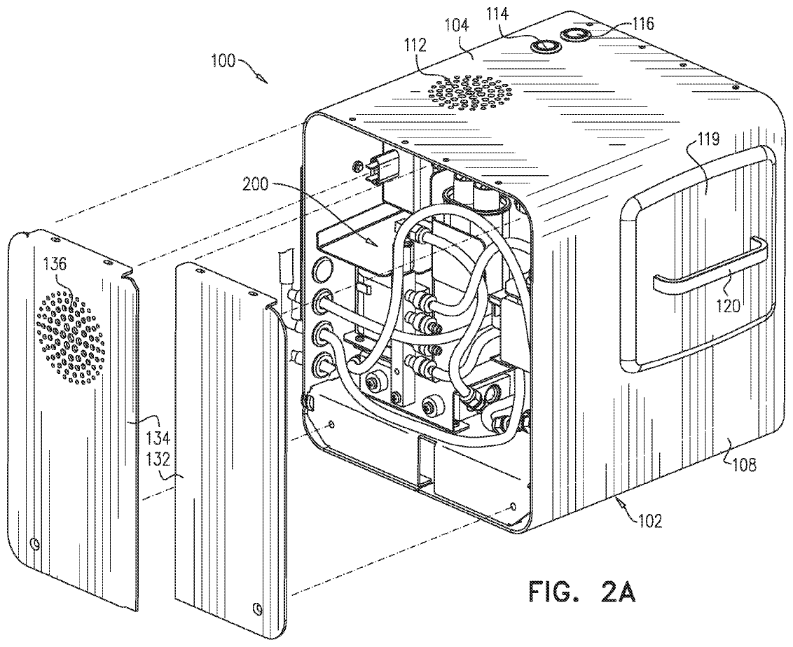

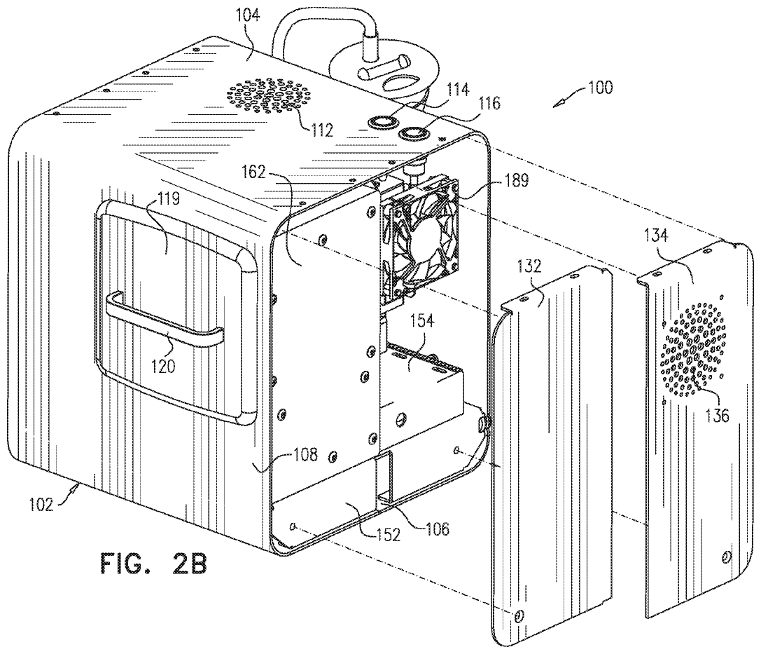

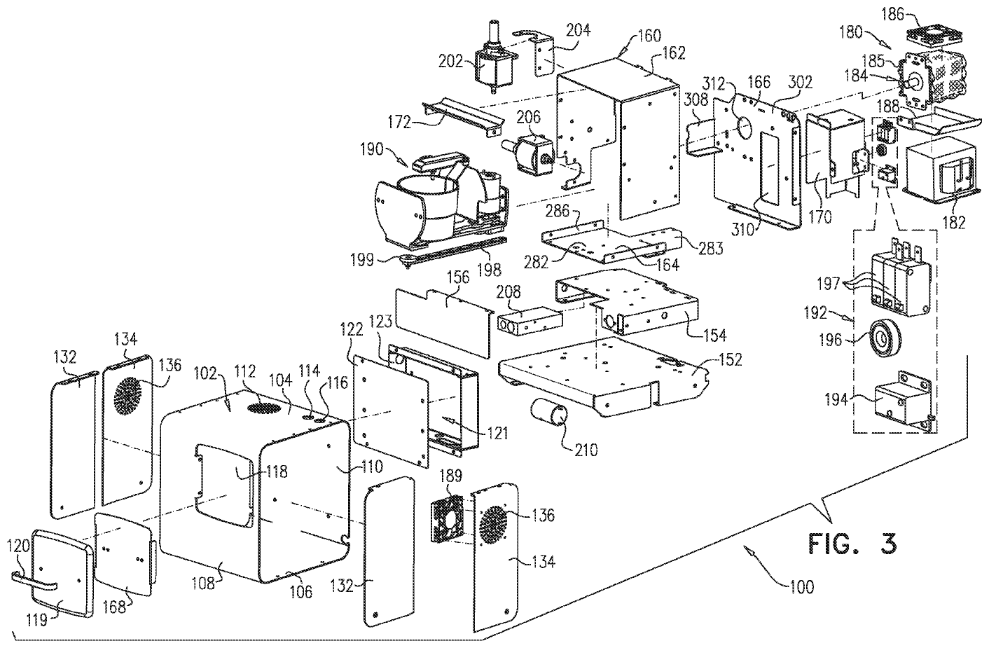

Reference is now made to FIGS. 1A and 1B, which are simplified respectively front-facing and rear-facing pictorial illustrations of a computer-controlled cooking system 100, constructed and operative in accordance with a preferred embodiment of the present invention, FIGS. 2A and 2B, which are simplified pictorial illustrations of the computer-controlled cooking system of FIGS. 1A & 1B, partially disassembled on mutually opposite sides thereof, and to FIG. 3, which is a simplified partial exploded view illustration of the computer-controlled cooking system of FIGS. 1A-2B.

As seen in FIGS. 1A-3, the computer-controlled cooking system 100 comprises a main housing 102, including a top portion 104, a bottom portion 106, a front portion 108 and a rear portion 110. The top portion 104 preferably includes an array 112 of communication apertures and first and second operation buttons 114 and 116. Button 114 is preferably user operable to initiate cooking and button 116 is preferably user operable to initiate wireless communication with a remote communicator such as a server (not shown).

The front portion 108 of the main housing 102 preferably is formed with an aperture 118, which is normally closed by a food cooking PSCCCCDC access door 119 having a handle 120. Disposed rearwardly of rear portion 110 is a microwave radiation protected enclosure 121 including a metal plate 122. Enclosure 121 is normally covered with a rear enclosure element 123, having an array of apertures, and encloses a main circuit board (not shown) and a cellular communication board (not shown). Rear portion 110 is preferably also formed with at least two, and preferably at least four, apertures 124 which accommodate respective liquid supply tubes 125 and 126, preferably connected to at least one liquid storage container 127, such as a water storage container. Additional liquid storage containers 128 may also be provided and may include storage containers for liquid ingredients, such as olive oil, wine, spirits, soy sauce or any other liquid ingredient required in a computerized cooking recipe, or a liquid ingredient that a user may wish to have added during cooking. Such additional storage containers may be coupled to the system via suitable liquid supply tubes (not shown). A bar code reader 129 is preferably also provided and may be connected to main circuit board (not shown) wirelessly or by a data cable 130.

There are also preferably provided a pair of forward side panels 132 and a pair of rearward side panels 134, each of rearward side panels 134 having formed thereon an array 136 of communication apertures. Panels 132 and 134 are preferably removably mounted onto main housing 102, as by screws (not shown).

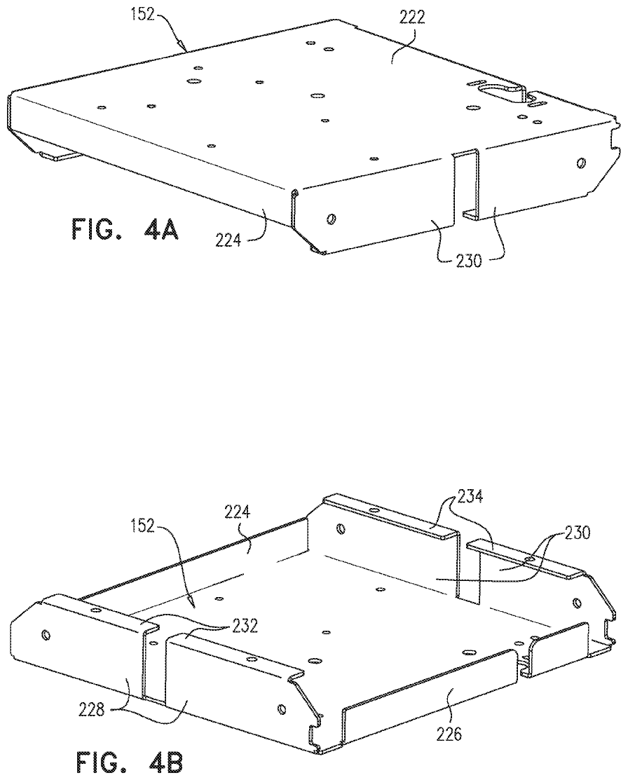

Located within main housing 102 are first, second and third chassis elements 152, 154 and 156, which are described hereinbelow in greater detail with respect to FIGS. 4A & 4B, 5A & 5B and 6A & 6B, respectively. Chassis element 152 is a main chassis element. Chassis element 154 is mounted on chassis element 152. Chassis element 156 lies parallel to front portion 108 of main housing 102 below aperture 118 and is mounted onto chassis element 152.

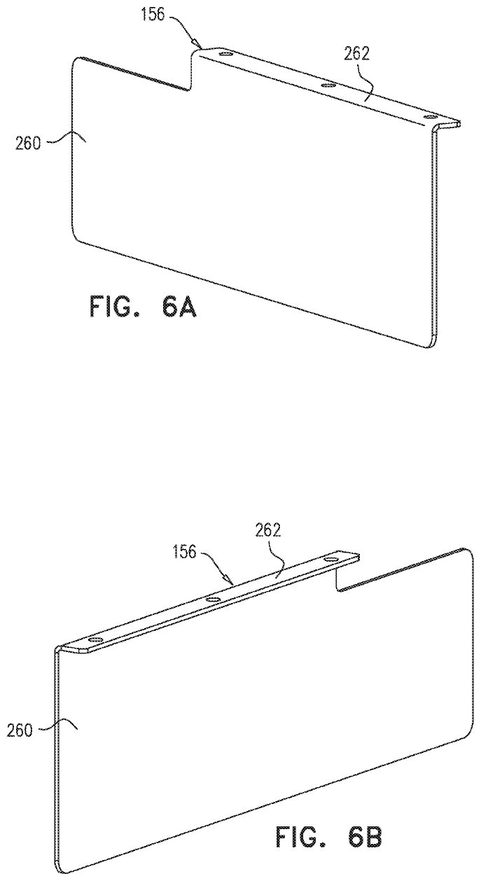

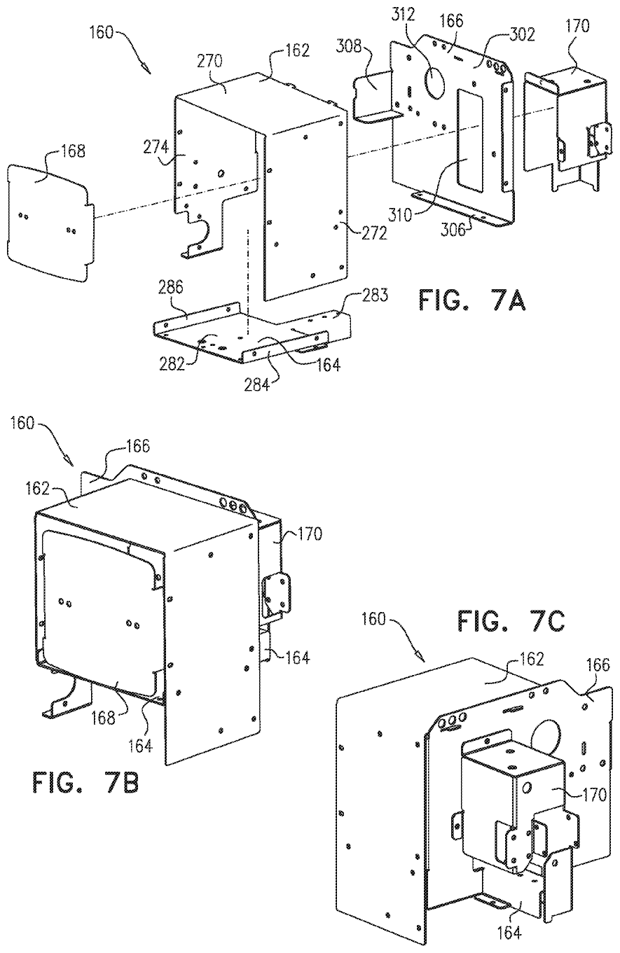

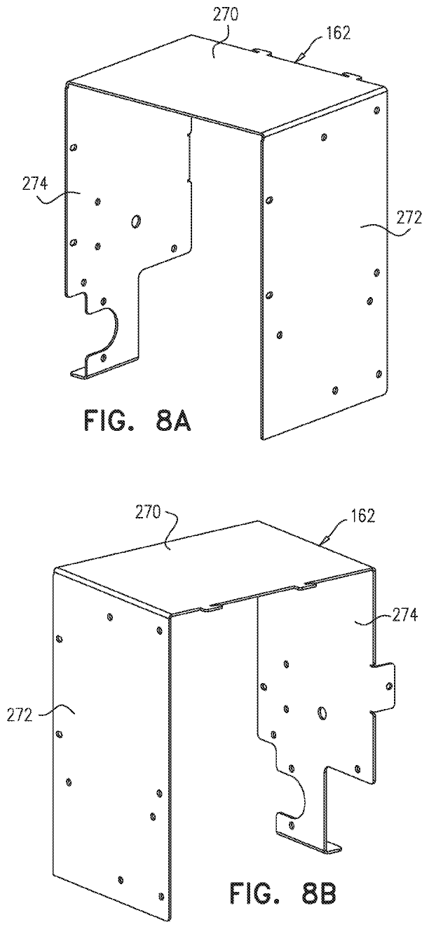

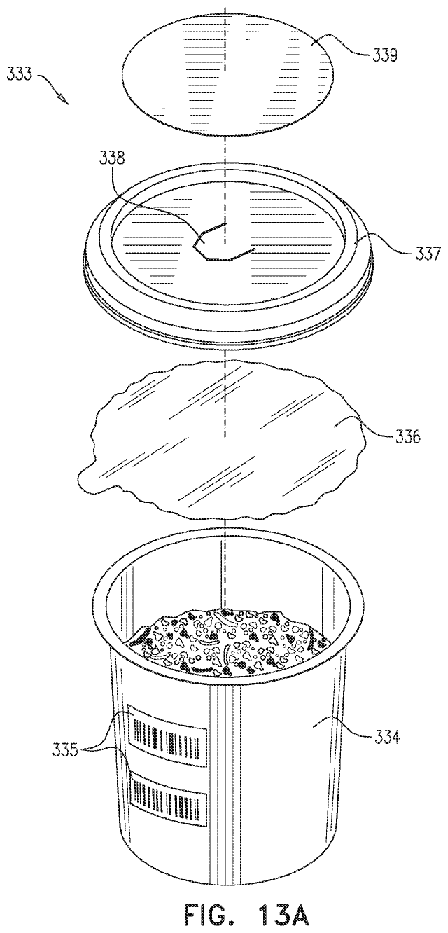

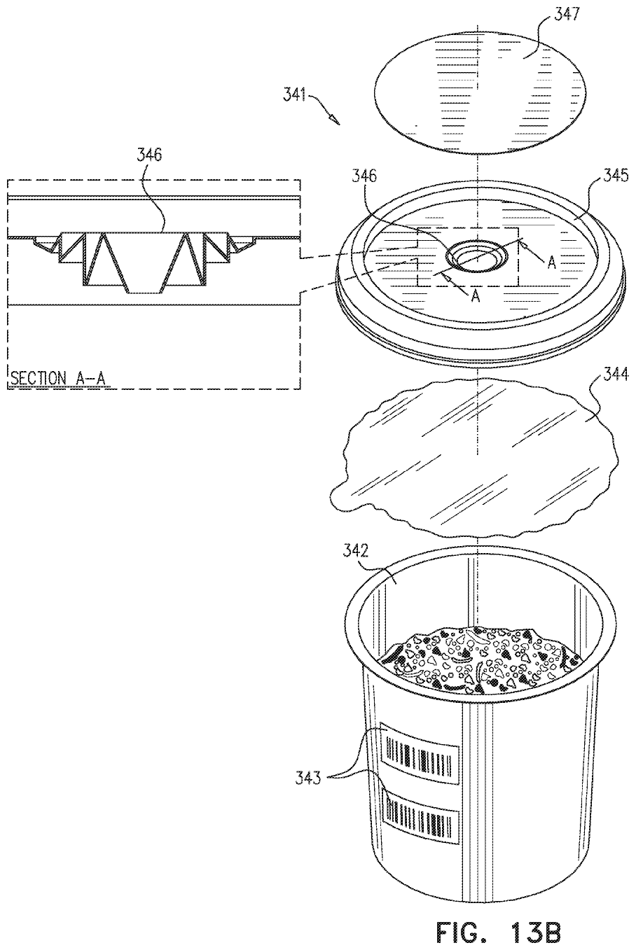

In accordance with a preferred embodiment of the present invention, a microwave cooking chamber 160 is defined within main housing 102. Microwave cooking chamber 160 is described hereinbelow in detail with reference to FIGS. 7A and 7B and is defined by chassis elements 162, 164, 166, 168 and 170, which are described hereinbelow in greater detail with respect to FIGS. 8A & 8B, 9A & 9B, 10A & 10B, FIGS. 11A & 11B and 12A & 12B, respectively. An orientation retaining element 172 is mounted onto chassis element 162.

It is a particular feature of the microwave cooking chamber that its dimensions are unusually small, preferably having a width of 161.5 mm, a height of 145 mm and a depth of 123.5 mm.

Additionally located within main housing 102 is a microwave energy generating assembly 180 including a power supply 182, a magnetron 184, such as a PANASONIC INVERTER MICROWAVE OVEN MAGNATRON 2M261-M39 641W, surrounded by a radiation protective mesh 185 and a fan 186 for directing a cooling air flow from outside main housing 102, via array 112 of communication apertures formed in top portion 104 of main housing 102, downwardly through the magnetron 184 and downstream thereof along a ventilation path defining element 188 and out via an array 136 of communication apertures formed in a back side panel 134 at the left of the main housing 102 in the sense of FIG. 3. An additional fan 189 is preferably mounted onto an outer wall of chassis element 170 and draws heated air from the interior of main housing 102 to the outside via an array 136 of communication apertures formed in a back side panel 134 at the right of the main housing 102 in the sense of FIG. 3.

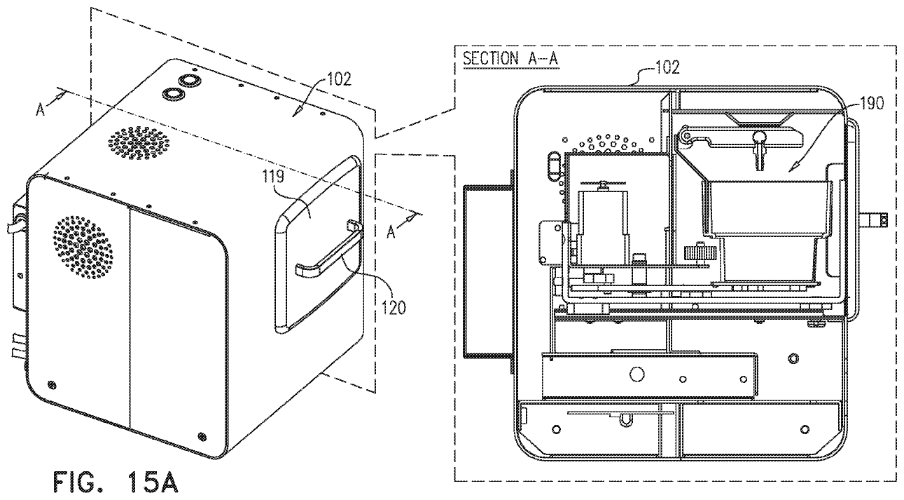

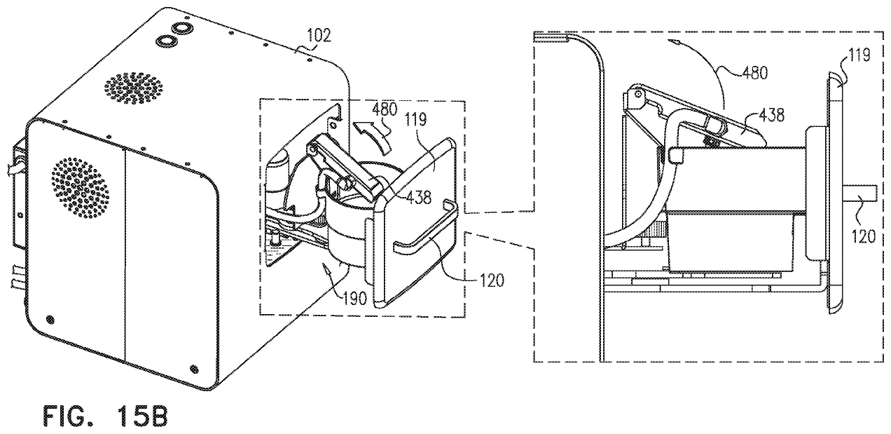

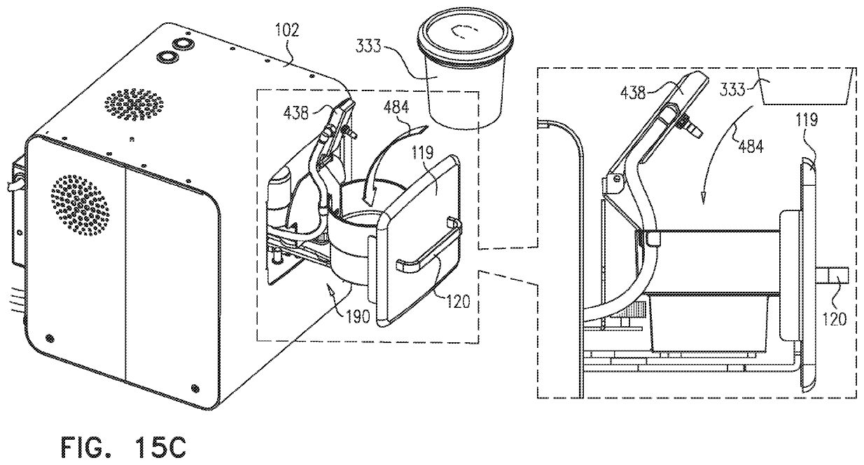

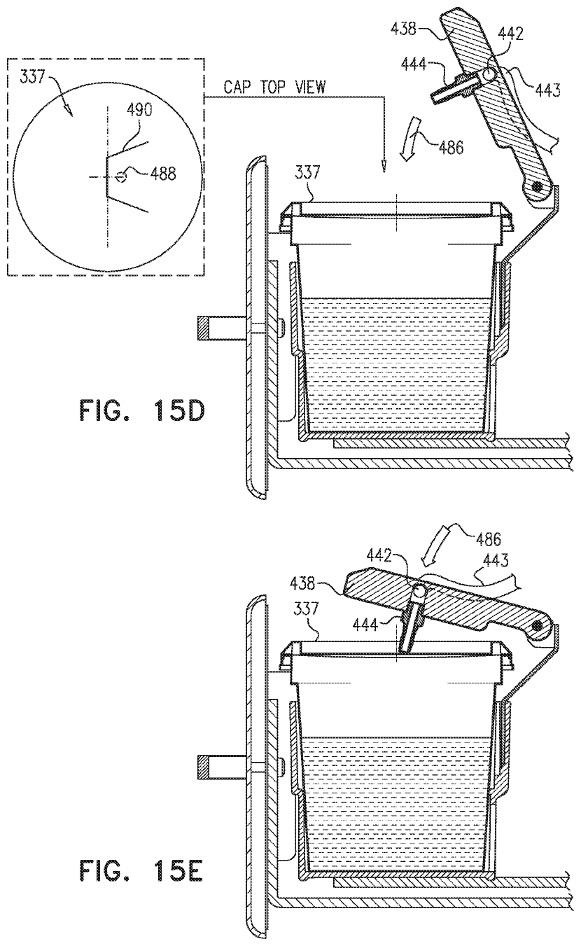

Further disposed within main housing 102, for operative engagement with microwave cooking chamber 160, is a pre-sealed computerized cooking container containing dry contents (PSCCCCDC) insertion, locking, stirring and serving subsystem 190, which is described hereinbelow in detail with respect to FIGS. 14A-14E. A safety interlock and locking assembly 192 is mounted onto chassis element 170. Safety interlock and locking assembly 192 preferably includes a mechanical latch assembly 194, such as a model XPO-217 commercially available from XPO Technology, for locking PSCCCCDC insertion, locking, stirring and serving subsystem 190 in a fully retracted operative orientation during cooking operation. Safety interlock and locking assembly 192 preferably also includes a magnet 196 which draws PSCCCCDC insertion, locking, stirring and serving subsystem 190 into lockable engagement with mechanical latch assembly 194, when in propinquity therewith, and three mutually redundant interlock switches 197, such as Part number W-15-302C GP commercially available from Galanz Guangdong of China, for preventing operation of the microwave energy generating assembly 180, other than when PSCCCCDC insertion, locking, stirring and serving subsystem 190 in a fully retracted operative orientation.

PSCCCCDC insertion, locking, stirring and serving subsystem 190 is arranged for linear displacement into and partially out of the microwave cooking chamber 160 along a rail 198, which is fixedly mounted onto chassis element 164 and has a low friction spacer 199 mounted thereon.

Also disposed within main housing 102 is a computer-controlled fluid supply subsystem 200 which is described hereinbelow in detail hereinbelow with reference to FIG. 18. For the sake of clarity, most of the computer-controlled liquid supply system 200 is not shown in FIG. 3, with the exception of a cold water pump 202, which is mounted via a bracket 204 mounted onto chassis element 162, a hot water pump 206, which is preferably mounted interiorly of a lower portion of chassis element 162 underlying chassis element 164, and an electric water heater 208, which is preferably mounted under chassis element 154. Water heater 208 is preferably constructed and operative as described in U.S. Published Patent Application U.S. patent application Ser. No. 14/942,149 entitled APPARATUS FOR RAPID HEATING OF LIQUIDS, filed Nov. 16, 2015, the disclosure of which is hereby incorporated by reference. An air pump 210 is also disposed within main housing 102, preferably under chassis element 152.

Reference is now made to FIGS. 4A & 4B, which are simplified downward-facing and upward-facing pictorial illustrations of first chassis element 152, forming part of the computer-controlled cooking system of FIGS. 1A-3. As seen in FIGS. 4A & 4B, first chassis element 152 is preferably a stamped and bent element formed of metal and having a generally planar main portion 222, forward, rearward and bifurcated side wall portions 224, 226, 228 and 230 and bifurcated edge portions 232 and 234 extending inwardly with respect to bifurcated side wall portions 228 and 230, respectively.

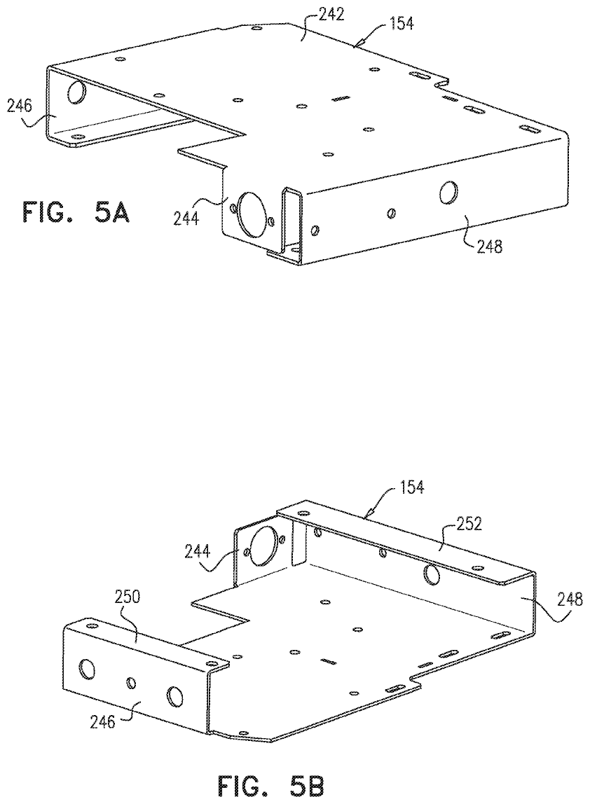

Reference is now made to FIGS. 5A & 5B, which are simplified downward-facing and upward-facing pictorial illustrations of second chassis element 154, forming part of the computer-controlled cooking system of FIGS. 1A-3. As seen in FIGS. 5A & 5B, second chassis element 154 is preferably a stamped and bent element formed of metal and having a generally planar main portion 242, forward, and side wall portions 244, 246 and 248 and edge portions 250 and 252 extending inwardly with respect to side wall portions 246 and 248, respectively.

Reference is now made to FIGS. 6A & 6B, which are simplified front-facing and rear-facing pictorial illustrations of third chassis element 156, forming part of the computer-controlled cooking system of FIGS. 1A-3. As seen in FIGS. 6A & 6B, third chassis element 156 is preferably a stamped and bent element formed of metal and having a generally planar main portion 260 and a rearwardly bent upper edge portion 262.

Reference is now made to FIGS. 7A and 7B, which are simplified respective pictorial and exploded view illustrations of microwave cooling chamber 160, forming part of the computer-controlled cooking system of FIGS. 1A-3 and mounted on the first and second chassis elements.

As seen in FIGS. 7A & 7B, microwave cooking chamber 160 is defined by a generally U-shaped chassis element 162, illustrated in FIGS. 8A and 8B, and which includes a top portion 270, a first depending side portion 272 and a second depending side portion 274.

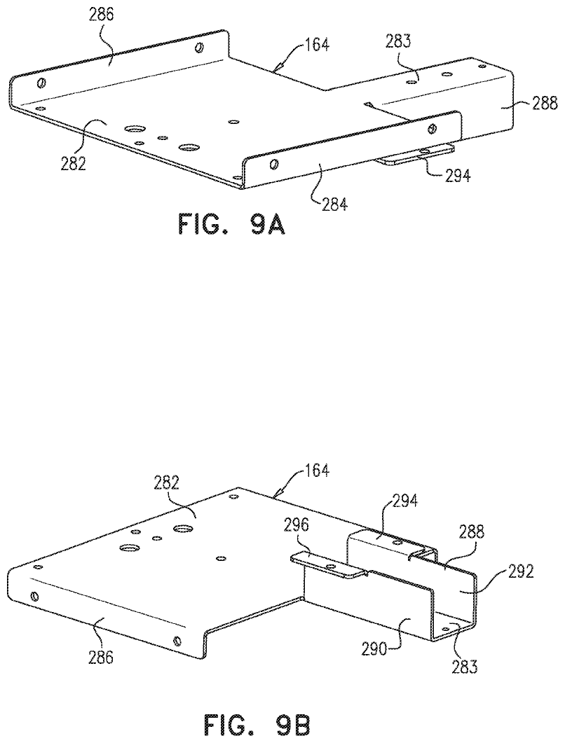

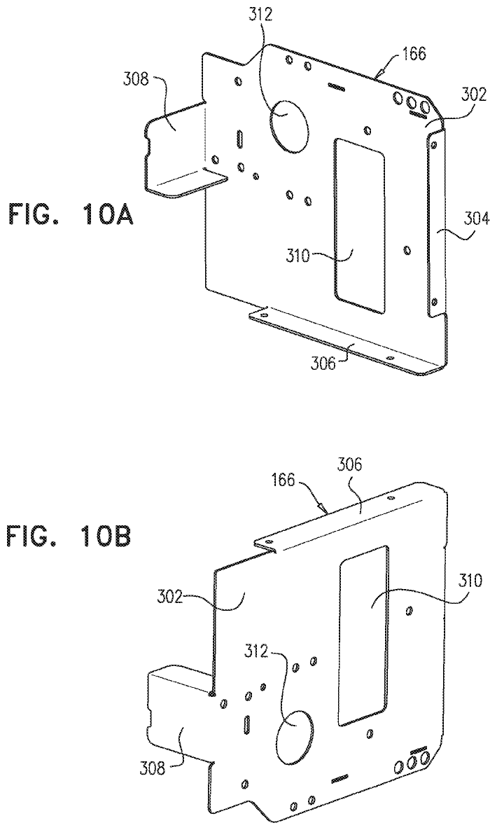

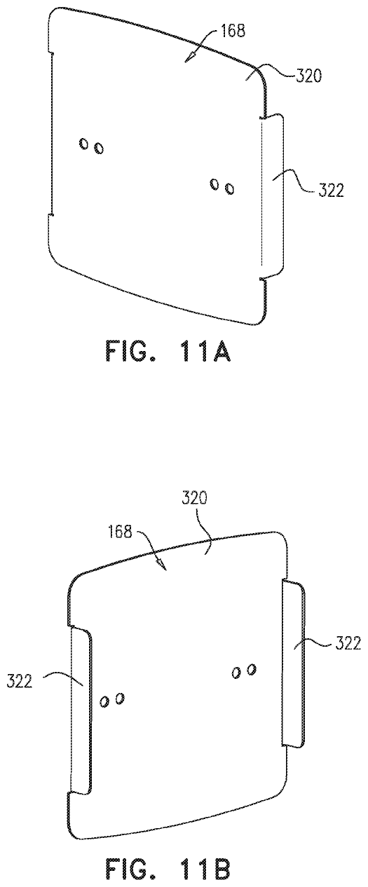

A floor of microwave cooking chamber 160 is defined by chassis element 164, which is illustrated in FIGS. 9A and 9B and is connected to the first depending side portion 272 and second depending side portion 274. As seen in FIGS. 9A & 9B, chassis element 164 is preferably a stamped and bent element formed of metal and having a generally planar main portion 282, including a finger portion 283 coplanar therewith, upward facing edge portions 284 and 286, downward facing side wall portions 288 and 290, defining a channel 292 and having edge portions 294 and 296, respectively, extending outwardly therefrom.

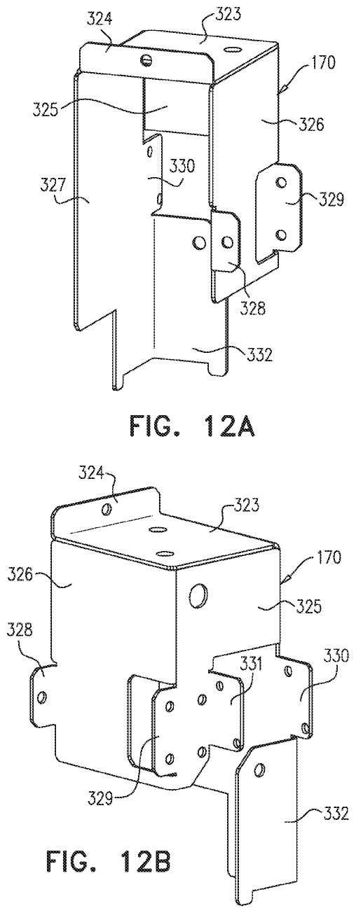

A back wall of microwave cooking chamber 160 is defined by chassis element 166, which is illustrated in FIGS. 10A & 10B. As seen in FIGS. 10A & 10B, chassis element 166 is preferably a stamped and bent element formed of metal and having a generally planar main portion 302, side and bottom edge portions 304 and 306 extending forwardly with respect to main portion 302 and an L-shaped forwardly extending portion 308. Chassis element 166 preferably is formed with a rectangular aperture 310 and a circular aperture 312.

A forward wall of microwave cooking chamber 160 is defined by chassis element 168, illustrated in FIGS. 11A and 11B, which is preferably fixedly mounted onto door 119. As seen in FIGS. 11A & 11B, chassis element 168 is preferably a stamped and bent element formed of metal and having a generally planar main portion 320 and inwardly-facing, side edge portions 322.

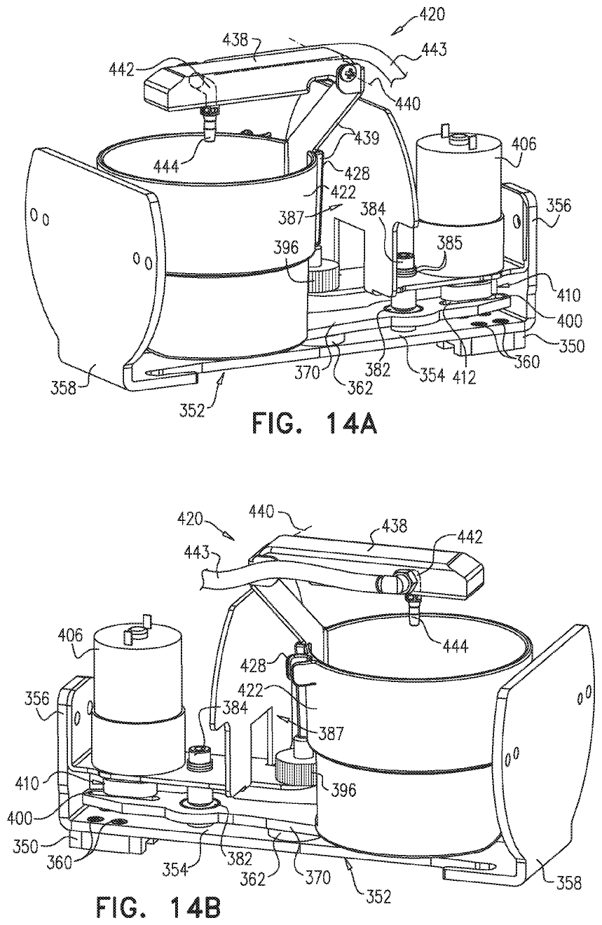

Rectangular aperture 310 of chassis element 166 communicates with the interior of chassis element 170, illustrated in FIGS. 12A and 12B, which defines a housing for receiving a rearward part of the PSCCCCDC insertion, locking, stirring and serving subsystem 190, when it is in a retracted operative orientation during cooking.

As seen in FIGS. 12A & 12B, chassis element 170 is preferably a stamped and bent element formed of metal and having a top wall 323, from which extends an upwardly-directed bracket portion 324, a back wall 325 and side walls 326 and 327. Chassis element 170 also defines first and second side bracket portions 328 and 329, first and second back bracket portions 330 and 331 and a third back bracket portion 332.

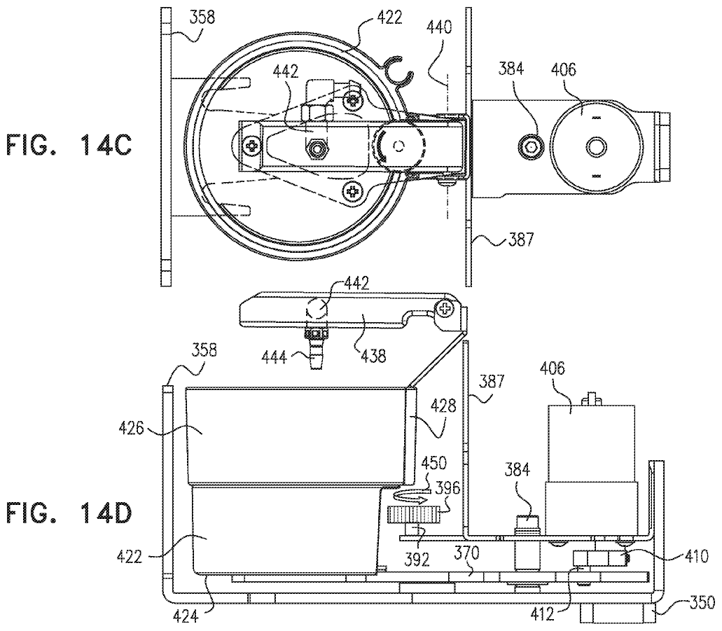

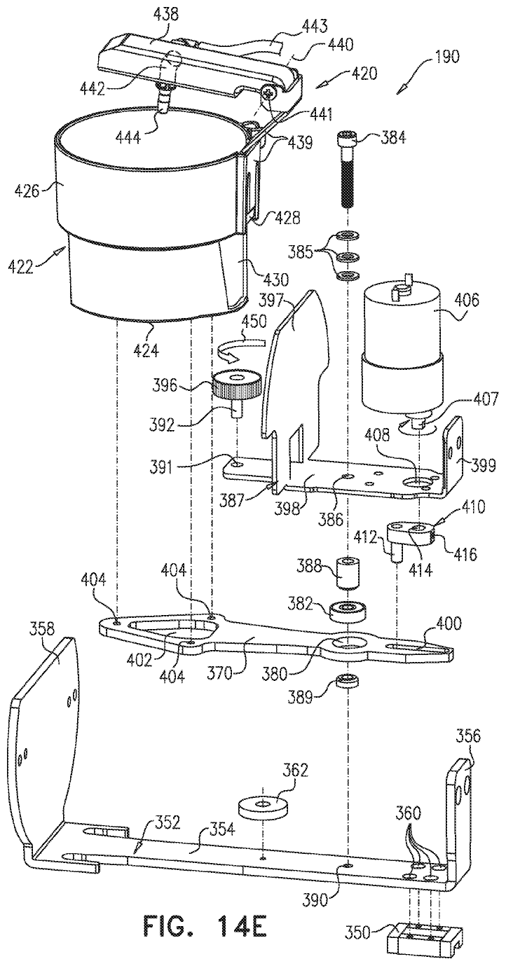

Reference is now made to FIG. 13A, which is a simplified exploded view of a first embodiment of a pre-sealed computerized cooking container containing dried contents (PSCCCCDC) 333 useful in the computer-controlled cooking system of FIGS. 1A-3. As seen in FIG. 13A, the PSCCCCDC 333 preferably includes a conventional plastic cup 334, preferably made of polypropylene, which preferably bears at least one barcode 335 or other machine-readable indicator on an outer side surface thereof.

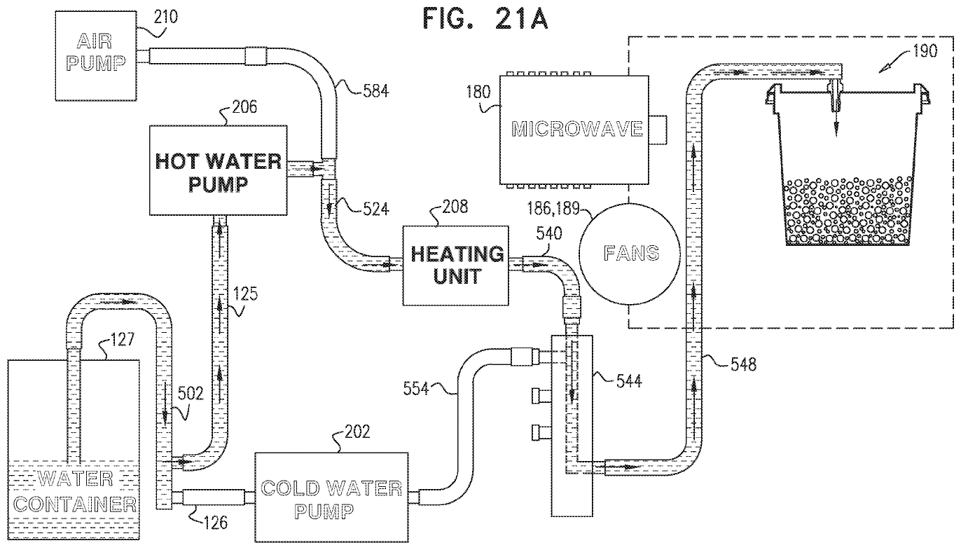

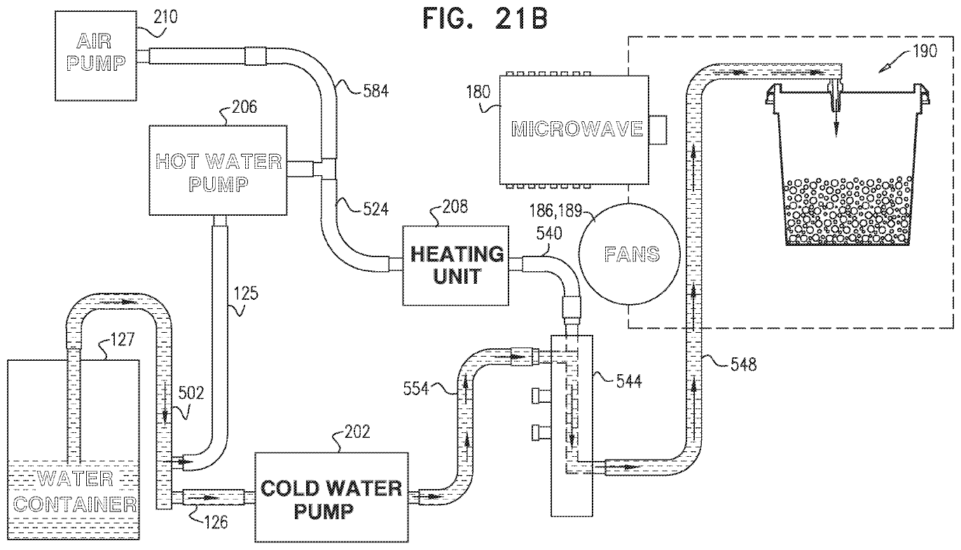

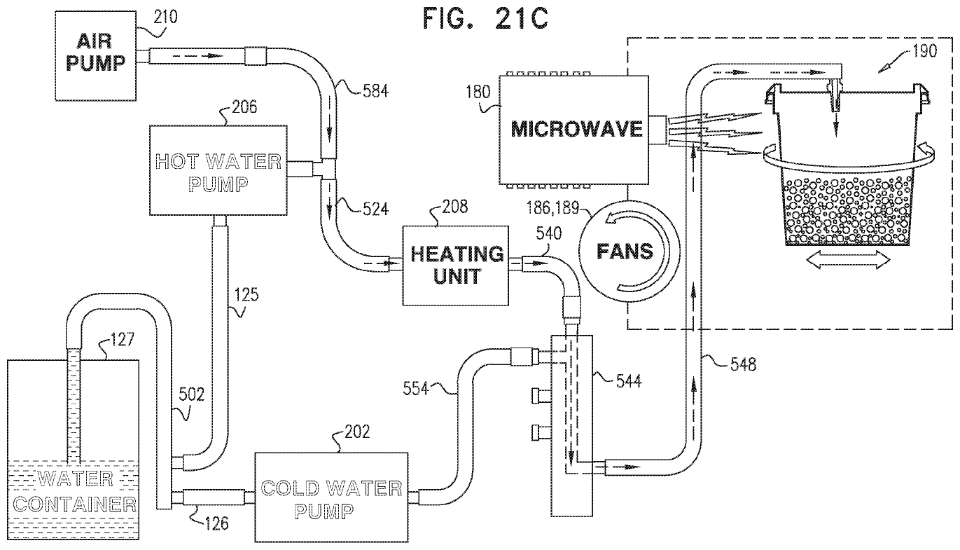

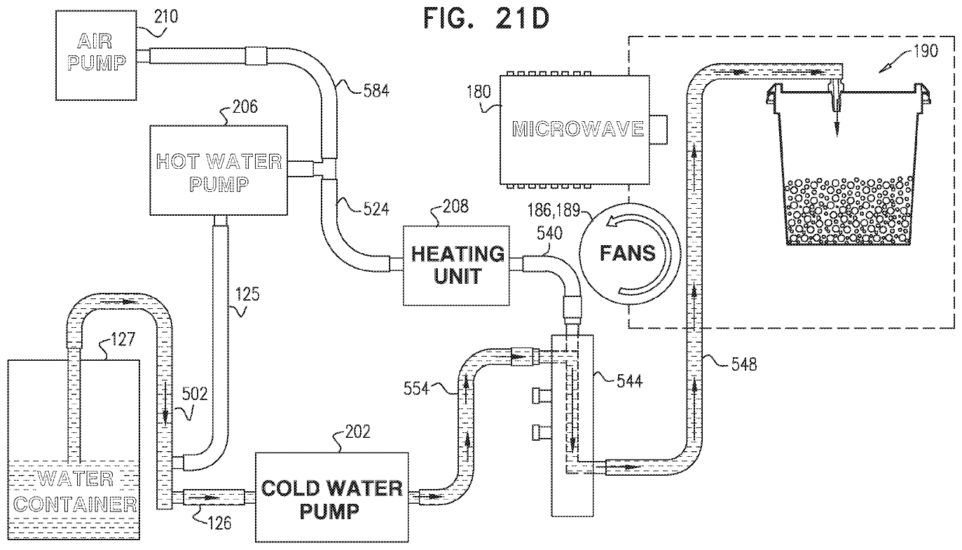

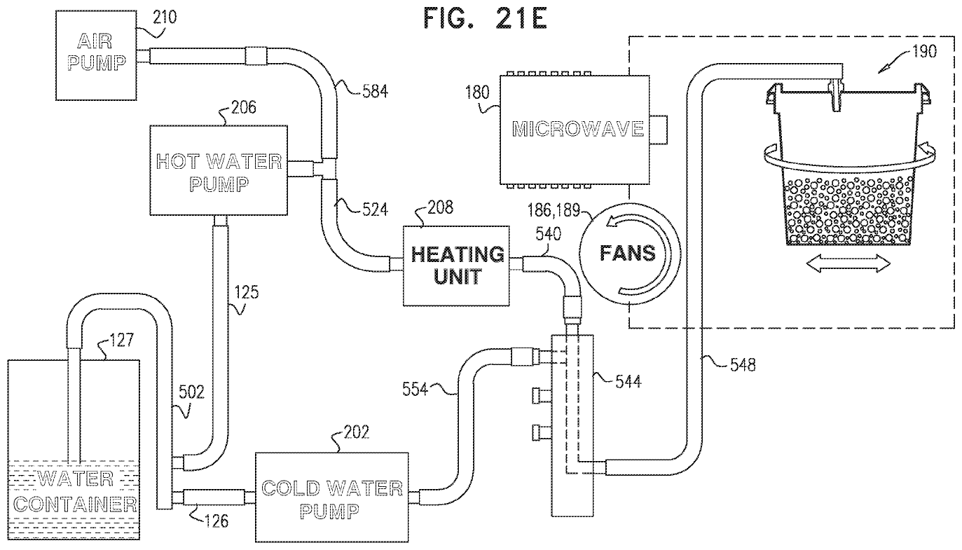

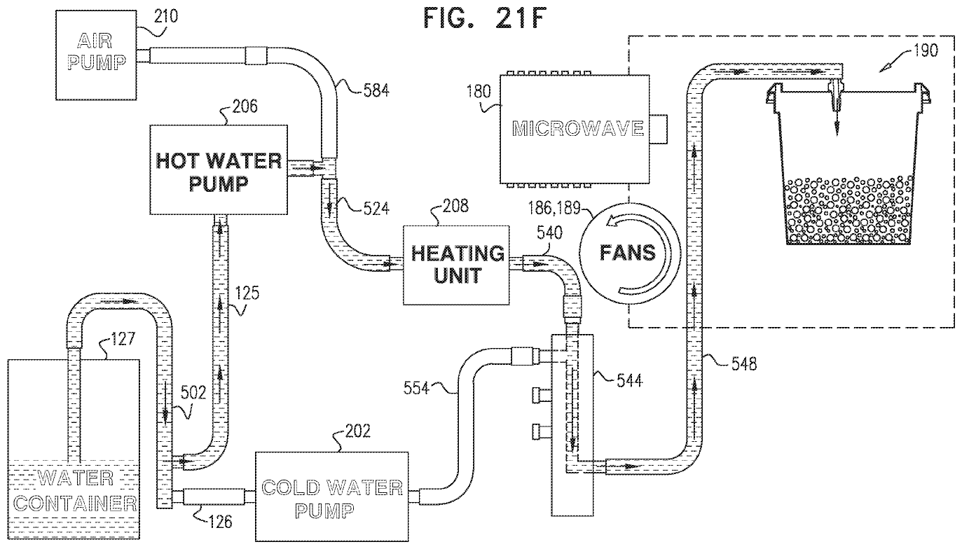

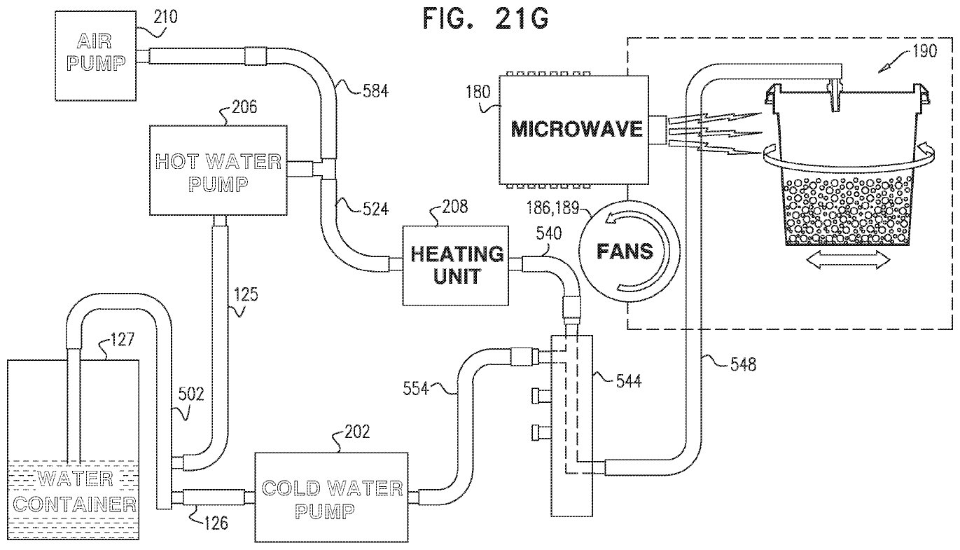

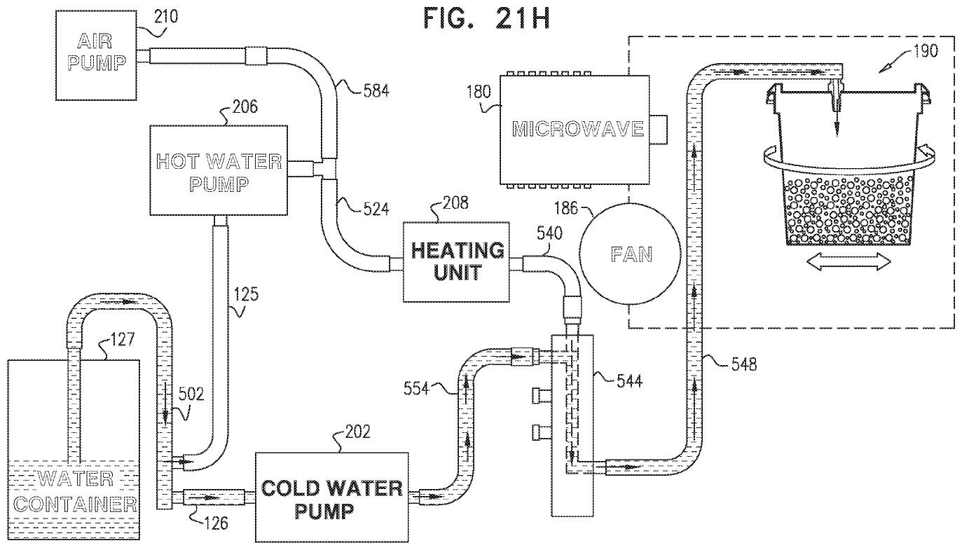

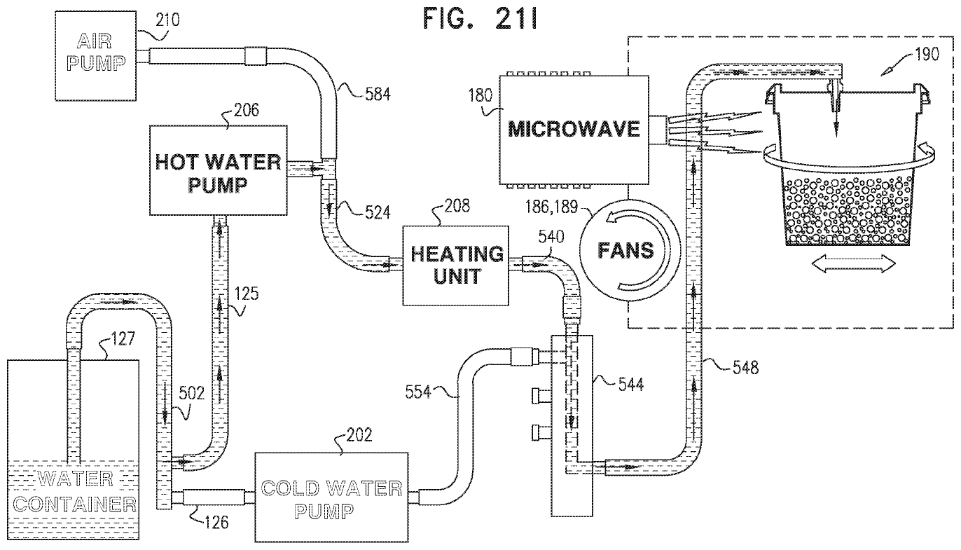

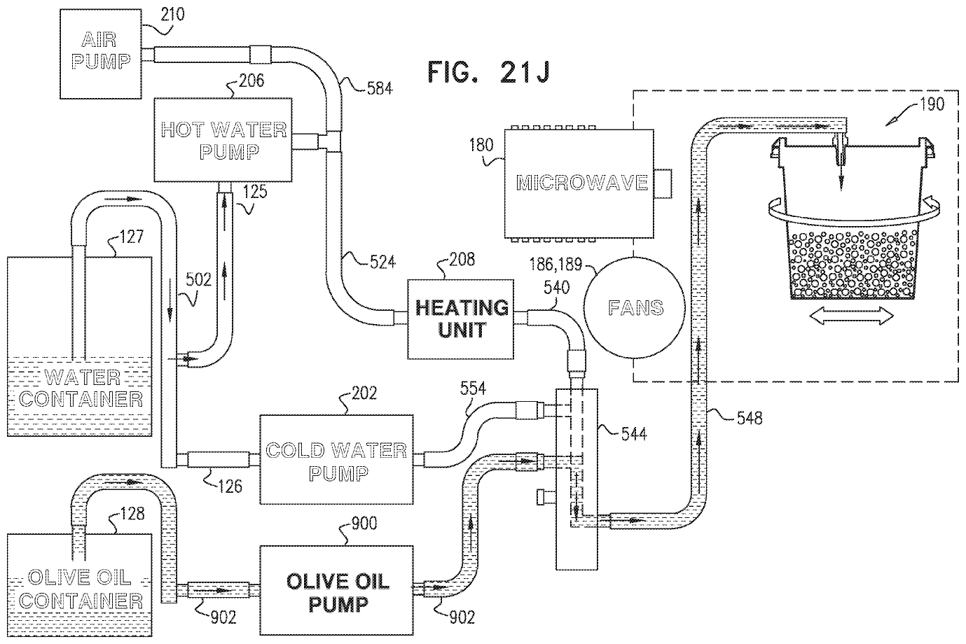

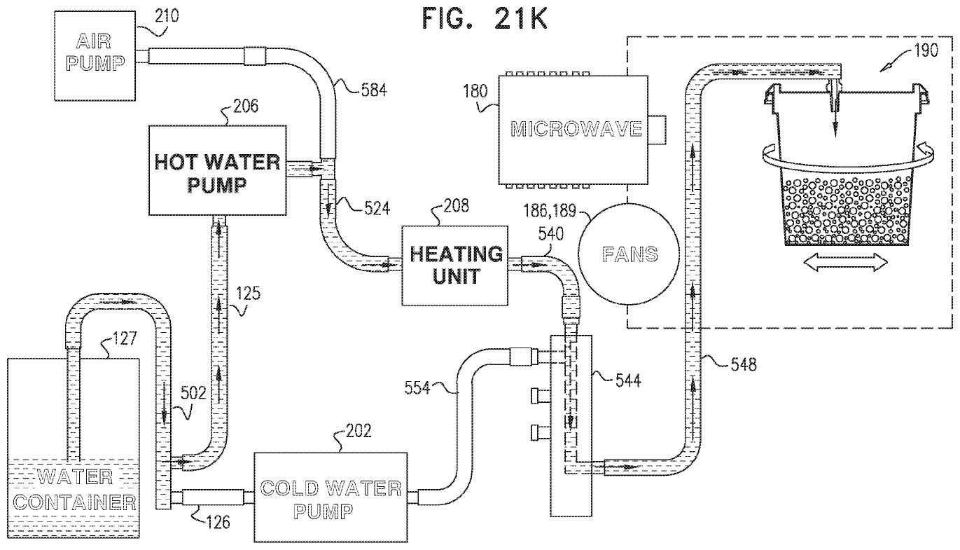

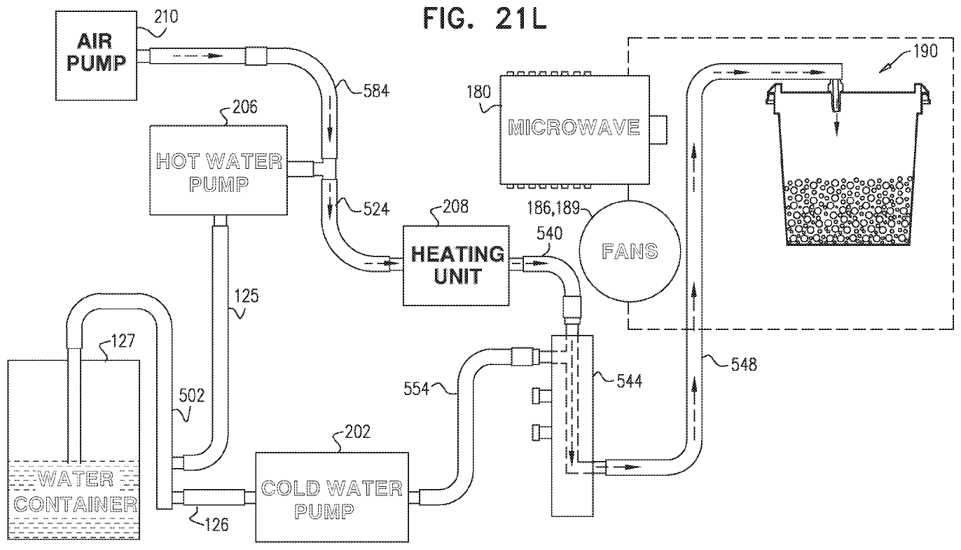

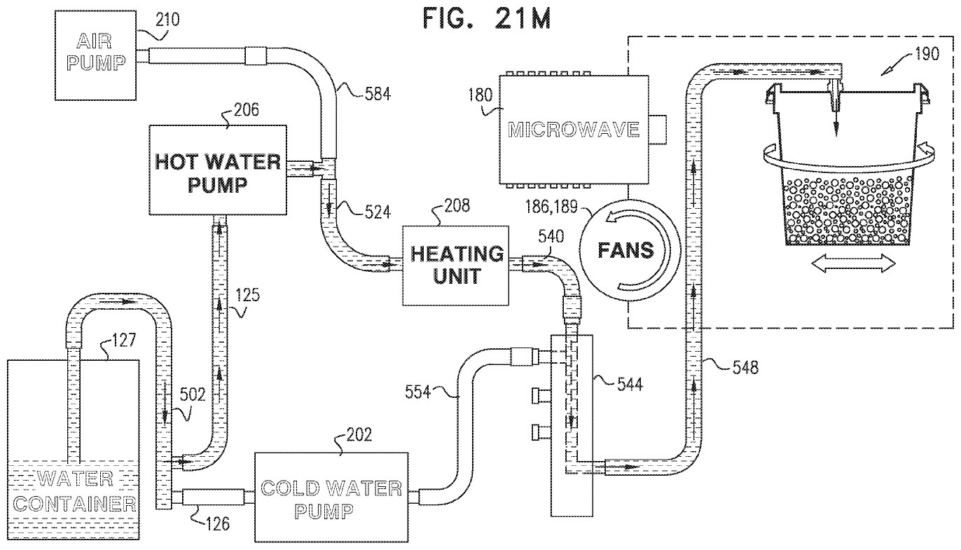

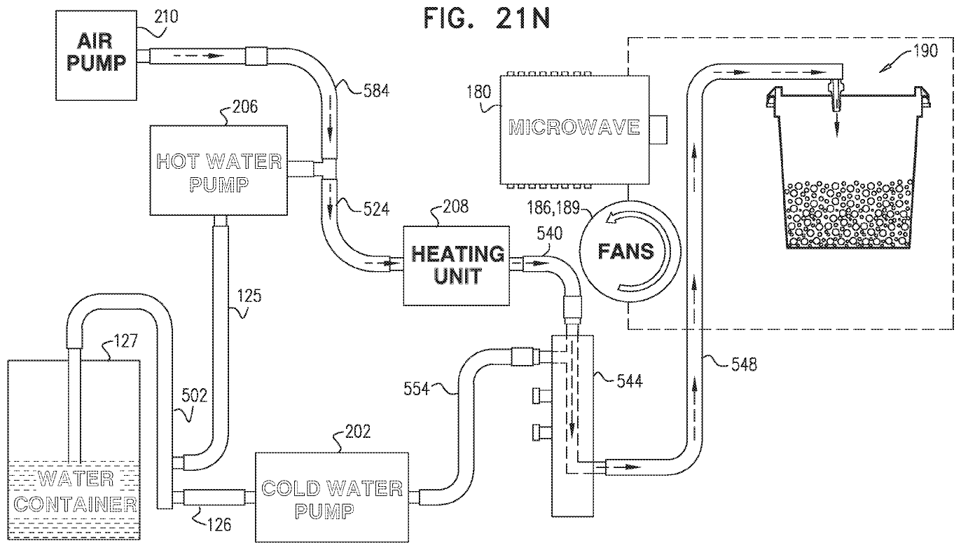

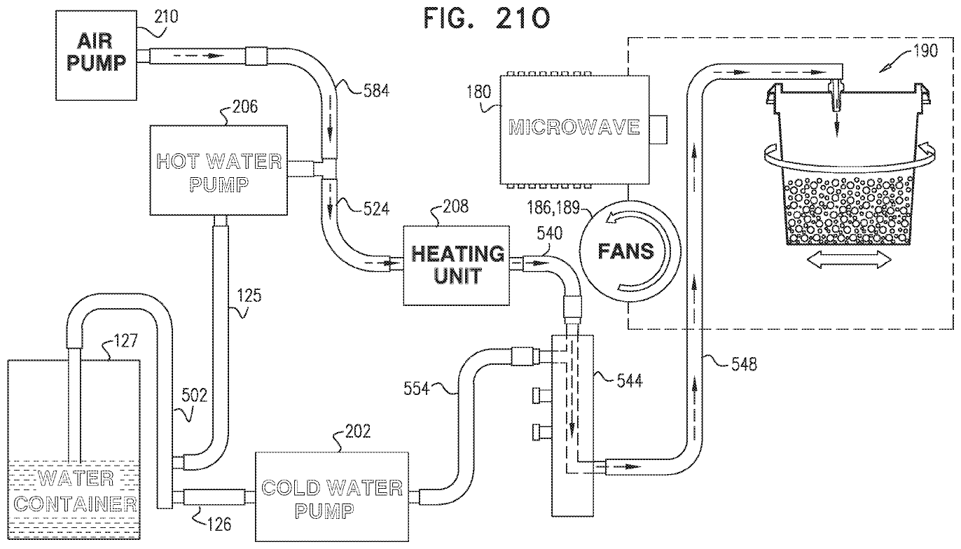

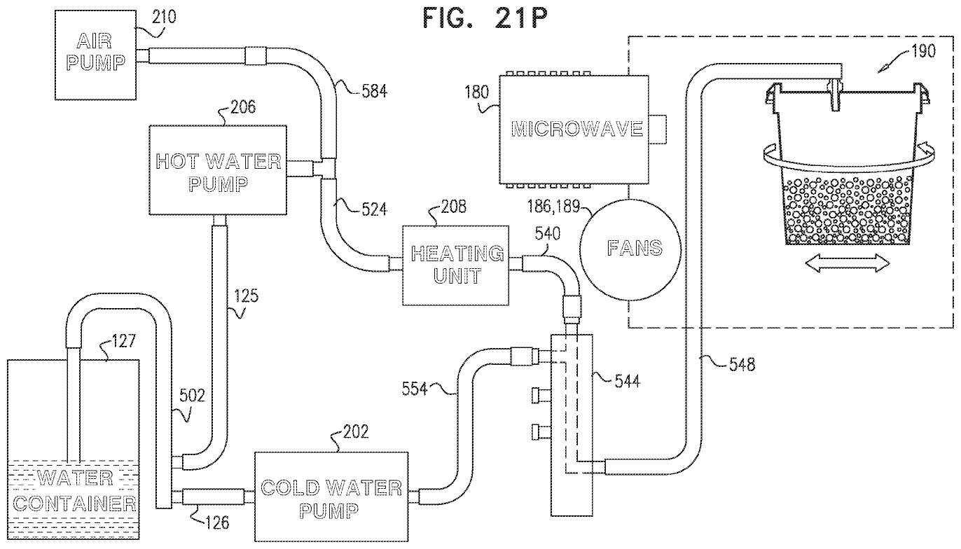

Cup 334 is typically heat sealed along a rim thereof with a sealing layer 336 preferably made of polypropylene. Preferably a conventional removable plastic cup lid 337, preferably formed of polypropylene, is formed with a precut flap incision 338, and is sealed over incision 338 with an outer seal 339, preferably formed of polypropylene. The dried contents of the PSCCCCDC 333 are selected to correspond to a predetermined, pre-engineered food product, examples of which are described hereinabove with reference to FIGS. 21A-21P, which is engineered to be cooked in accordance with at least one pre-engineered computerized cooking protocol sequence, examples of which are also described hereinabove with reference to FIGS. 21A-21P. Preferably, each bar code 337 corresponds to a different pre-engineered computerized cooking protocol sequence. Multiple bar codes 337 may be provided on one or more PSCCCCDCs 333 to enable the contents thereof to be prepared according to multiple alternative pre-engineered computerized cooking protocol sequences. One example is preparing loose scrambled eggs and an egg muffin from the same PSCCCCDC 333 based on different pre-engineered computerized cooking protocol sequences corresponding to different barcodes 337.

Reference is now made to FIG. 13B, which is a simplified exploded view of a second embodiment of a pre-sealed computerized cooking container containing dried contents (PSCCCCDC) 341 useful in the computer-controlled cooking system of FIGS. 1A-3. As seen in FIG. 13B, the PSCCCCDC 341 preferably includes a conventional plastic cup 342, preferably made of polypropylene, which preferably bears plural barcodes 343 or other machine-readable indicators on an outer side surface thereof.

Cup 342 is typically heat sealed along a rim thereof with a sealing layer 344, preferably made of polypropylene. Preferably, a removable plastic cup lid 345, preferably formed of polypropylene, is formed with an extendible, accordion-like apertured central portion 346, and is sealed over extendible, accordion-like apertured central portion 346 with an outer seal 347, preferably formed of polypropylene. The dried contents of the PSCCCCDC 341 are selected to correspond to a predetermined, pre-engineered food product, examples of which are described hereinabove with reference to FIGS. 21A-21P, which is engineered to be cooked in accordance with at least one pre-engineered computerized cooking protocol sequence, examples of which are also described hereinabove with reference to FIGS. 21A-21P. Preferably, each bar code 343 corresponds to a different pre-engineered computerized cooking protocol sequence. Multiple bar codes 343 may be provided on one or more PSCCCCDCs 341 to enable the contents thereof to be prepared according to multiple alternative pre-engineered computerized cooking protocol sequences. One example is preparing loose scrambled eggs and an egg muffin from the same PSCCCCDC 341 based on different pre-engineered computerized cooking protocol sequences corresponding to different barcodes 343.

Reference is now made to FIGS. 14A-14E, which are simplified illustrations of PSCCCCDC insertion, locking, stirring and serving subsystem 190, forming part of the computer-controlled cooking system of FIGS. 1A-3. As seen in FIGS. 14A-14E, PSCCCCDC insertion, locking, stirring and serving subsystem 190 includes a track riding element 350 which is arranged for linear sliding motion along track 198 (FIG. 3). Fixedly mounted onto track riding element 350 is a manually linearly displaceable element 352.

As seen with particular clarity in FIG. 14E, manually linearly displaceable element 352 preferably includes an elongate portion 354 terminating at the rear in an upstanding rear portion 356 and at the front in an upstanding front portion 358. Upstanding front portion 358 is preferably formed with attachment apertures enabling fixed attachment of door 119 and chassis element 168 thereto, such that manual pulling or pushing on door 119 produces a corresponding linear displacement of PSCCCCDC insertion, locking, stirring and serving subsystem 190.

Preferably, manually linearly displaceable element 352 is mounted onto track riding element 350 by screws (not shown) engaging apertures 360 formed in elongate portion 354 forward of and adjacent to upstanding rear portion 356. A low friction spacer 362 is also preferably mounted onto elongate portion 354.

A generally elongate planar element 370 is pivotably mounted onto manually linearly displaceable element 352. Element 370 is preferably formed with an aperture 380 in which is fixedly mounted a bearing 382, which rotatably supports a threaded shaft 384. Threaded shaft 384 preferably extends through a plurality of spacer washers 385, an aperture 386 in a motor mounting bracket 387, a spacer 388, bearing 382 fixed in aperture 380 and a spacer 389 and threadably engages a correspondingly threaded aperture 390 in manually linearly displaceable element 352.

Motor mounting bracket 387 is preferably formed with an aperture 391 in which is fixedly mounted an axle 392 onto which is rotatably mounted a ratcheted friction engagement wheel 396, which is enabled for rotation only in a counterclockwise direction in the sense of FIG. 14E.

Preferably, motor mounting bracket 387 is also formed with a forward upstanding portion 397, an elongate portion 398 and a rearward upstanding portion 399. Preferably, forward upstanding portion 397 of motor mounting bracket 387 and upstanding front portion 358 of manually linearly displaceable element 352 serve as microwave radiation shields.

Generally elongate planar element 370 is also formed with a longitudinal slot 400 formed at one end thereof and preferably is formed with a typically generally triangular cut out 402 at an opposite end thereof, as well as a plurality of mounting apertures 404 adjacent triangular cut out 402. Cut out 402 is preferably provided for enabling passage of microwave energy therethrough.

An electric stepper motor 406, preferably a Model DB37-528, commercially available from Hong Kong Dong Hui Motor Industrial, is fixedly mounted on motor mounting bracket 387 and includes a rotatable drive shaft 407, which extends through an aperture 408 in mounting bracket 387.

An eccentric coupler 410 slidably engages slot 400 and includes a pin portion 412 and an aperture 414 which tightly receives rotatable drive shaft 407 of motor 406. Aperture 414 is selectably engaged by a set screw 416 for providing tight engagement between drive shaft 407 and coupler 410, such that coupler 410 rotates together with drive shaft 407.

A PSCCCCDC engagement assembly 420 also forms part of PSCCCCDC insertion, locking, stirring and serving subsystem 190 and preferably includes a PSCCCCDC holding element 422 including a bottom wall portion 424, which is attached to generally elongate planar element 370 by screws (not shown) engaging apertures 404. PSCCCCDC holding element 422 also includes a generally circular circumferential wall portion 426 having a bracket recess 428 and a cut out 430 for enabling wheel 396 to extend therethrough. It is a particular feature of an embodiment of the present invention that PSCCCCDC holding element 422 and most preferably generally circular circumferential wall portion 426 thereof is formed of a material, such as silicon carbide, which is readily heatable by microwave radiation, thereby enabling heating of the contents of the PSCCCCDC not only by microwave energy and hot water but also by conduction and convection from PSCCCCDC holding element 422, which serves as a heat source as well.

A PSCCCCDC engagement arm 438 is pivotably mounted onto PSCCCCDC holding element 422 by means of a bracket 439 which seats in bracket recess 428. Bracket 439 defines a pivot axis 440 extending through apertures (not shown) formed at a top portion thereof, which receive a screw 441, which engages corresponding pivot recesses in arm 438. Arm 438 includes a fluid channel 442, which is coupled to a fluid inlet connector 443 and a barbed fluid outlet nozzle 444.

It is a particular feature of an embodiment of the present invention that operation of motor 406 driving eccentric coupler 410 which engages slot 400 in generally elongate planar element 370 produces reciprocal pivoting movement of generally elongate planar element 370 and thus of PSCCCCDC holding element 422, which is fixedly mounted thereon. This reciprocal pivoting movement is operative to provide external stirring of contents of a PSCCCCDC (not shown), without contact with the contents of the PSCCCCDC, thus obviating the need to clean elements of the system between cooking operations.

It is a further particular feature of an embodiment of the present invention that the frictional engagement of ratcheted friction engagement wheel 396, which moves in a direction indicated by an arrow 450, with an outer surface of a PSCCCCDC (not shown) held in PSCCCCDC holding element 422 produces rotation of the PSCCCCDC 333 within PSCCCCDC holding element 422, thus providing additional external driven stirring of the contents of the PSCCCCDC.

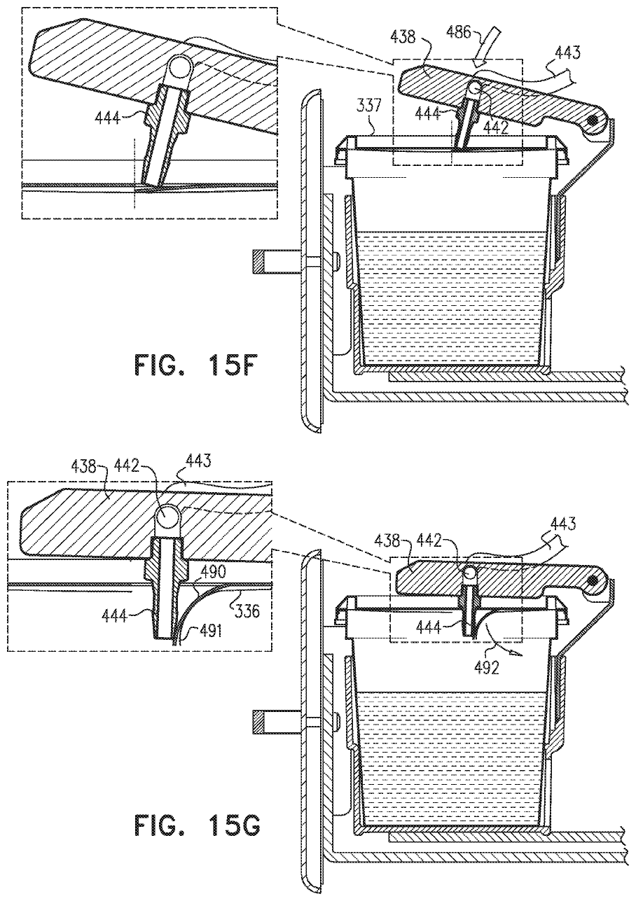

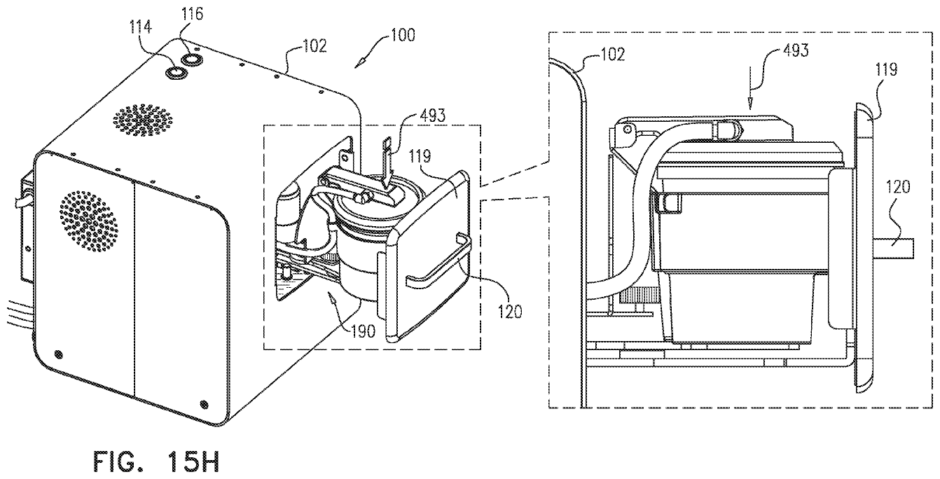

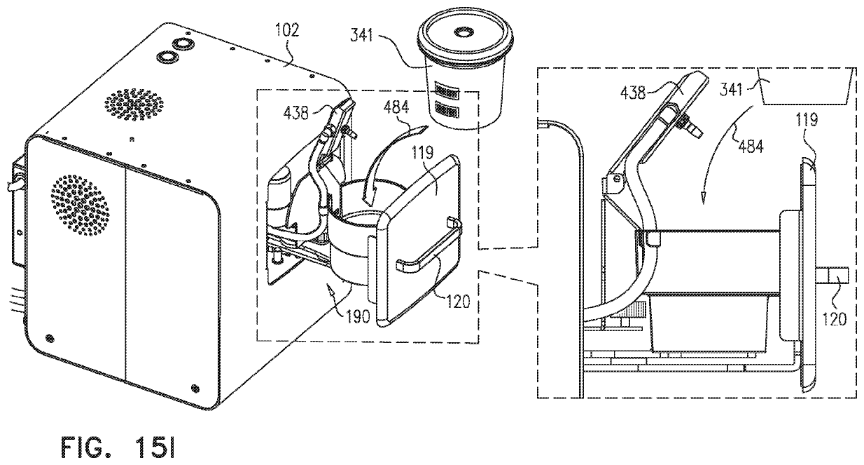

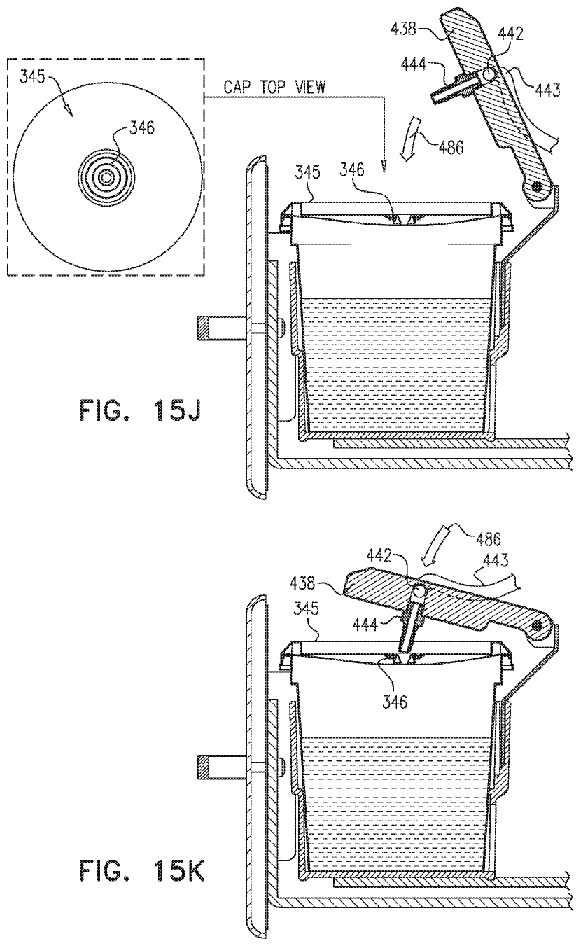

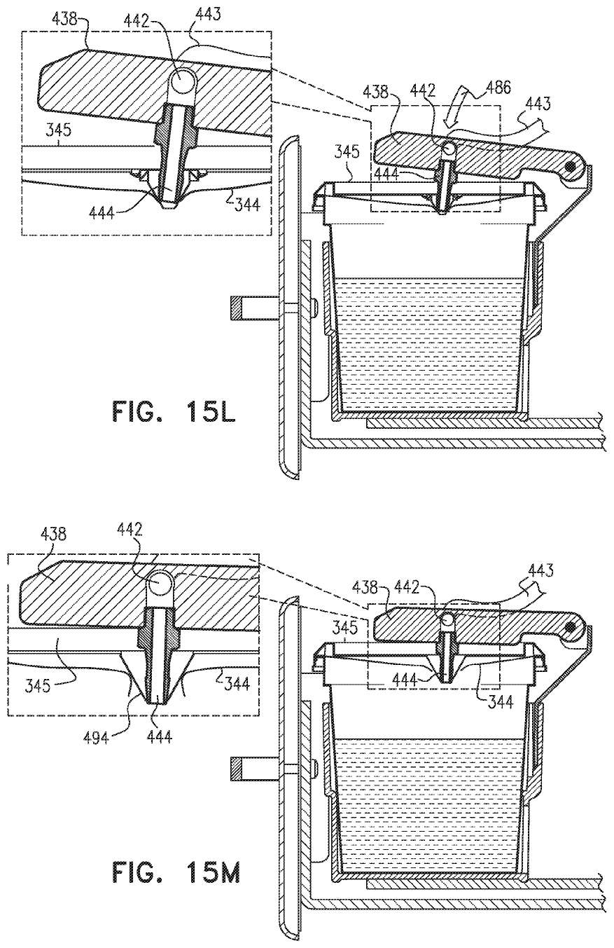

Reference is now made to FIGS. 15A, 15B, 15C, 15D, 15E, 15F, 15G and 15H, which are simplified illustrations of various stages of pre-cooking operation of the PSCCCCDC insertion, locking, stirring and serving subsystem of FIGS. 14A-14E.

FIG. 15A shows an initial stage in which PSCCCCDC insertion, locking, stirring and serving subsystem 190 is fully retracted into main housing 102 and food cooking PSCCCCDC access door 119 is fully closed. FIG. 15B shows a subsequent stage in which food cooking PSCCCCDC access door 119 is open and PSCCCCDC insertion, locking, stirring and serving subsystem 190 extends partially outside of main housing 102. FIG. 15B shows PSCCCCDC engagement arm 438 about to be raised in a direction indicated by an arrow 480. FIG. 15C shows insertion of a PSCCCCDC 333 into PSCCCCDC holding element 422 as indicated by an arrow 484, following raising of PSCCCCDC engagement arm 438. Raising of PSCCCCDC engagement arm 438 may be manual or automatic, in which latter case, a spring (not shown) may urge PSCCCCDC engagement arm 438 in an upward direction indicated by arrow 480 (FIG. 15B).

FIGS. 15D-15G are simplified sectional illustrations showing sequential stages of lowering of PSCCCCDC engagement arm 438 in a direction indicated by an arrow 486, such that barbed fluid outlet nozzle 444 of PSCCCCDC engagement arm 438 engages a location 488 on a frangible and removable lid 347 of PSCCCCDC 333 and causes a flap 490 defined by incision 338 thereof and carrying a torn portion of outer seal 339, and a correspondingly shaped flap 491 of inner seal 336 to bend inwardly in a direction indicated by an arrow 492. The interior of barbed fluid outlet nozzle 444 is thus brought into fluid communication with the interior of PSCCCCDC 333. FIG. 15H illustrates the system 100 with PSCCCCDC engagement arm 438 fully lowered, in a direction indicated by an arrow 493, and ready for full insertion of PSCCCCDC insertion, locking, stirring and serving subsystem 190 into main housing 102, closing of door 119 and initiation of cooking but a user pressing button 114.

Reference is now made to FIGS. 15I, 15J, 15K, 15L, and 15M, which are simplified illustrations of various stages of pre-cooking operation of the PSCCCCDC insertion, locking, stirring and serving subsystem of FIGS. 14A-14E employing the second embodiment of a PSCCCCDC as shown in FIG. 13B. FIGS. 15I, 15J, 15K, 15L, and 15M illustrate stages corresponding to the stages illustrated in FIGS. 15C, 15D, 15E, 15F and 15G.

FIG. 15I shows insertion of PSCCCCDC 341 into PSCCCCDC holding element 422 as indicated by an arrow 484, following raising of PSCCCCDC engagement arm 438. Raising of PSCCCCDC engagement arm 438 may be manual or automatic, in which latter case, a spring (not shown) may urge PSCCCCDC engagement arm 438 in an upward direction indicated by arrow 480 (FIG. 15B).

FIGS. 15J-15M are simplified sectional illustrations showing sequential stages of lowering of PSCCCCDC engagement arm 438 in a direction indicated by an arrow 486, such that barbed fluid outlet nozzle 444 of PSCCCCDC engagement arm 438 engages extendible, accordion-like apertured central portion 346 on removable lid 345 of PSCCCCDC 341 and causes extension of extendible accordion-like apertured central portion 346 thereof to define a spout 494 which substantially covers nozzle 444 and prevents contamination thereof during cooking of the contents of PSCCCCDC 341. The interior of barbed fluid outlet nozzle 444 is thus brought into fluid communication with the interior of PSCCCCDC 341 while being generally protected from contamination during cooking by the spout 494 defined by extension of extendible, accordion-like apertured central portion 346.

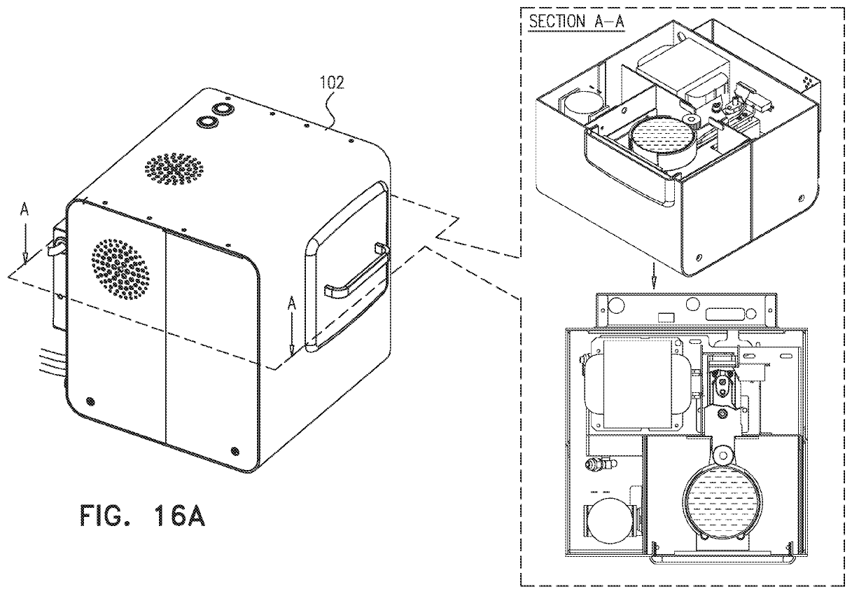

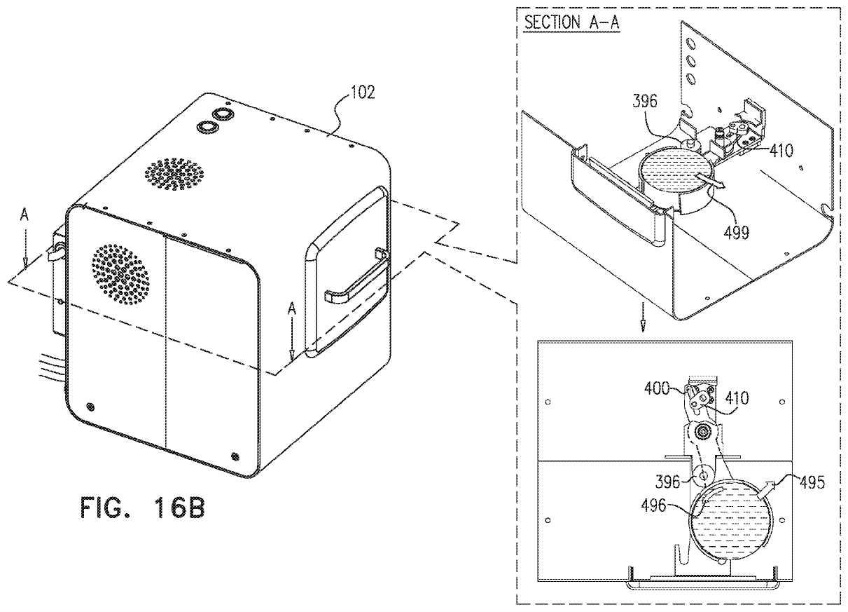

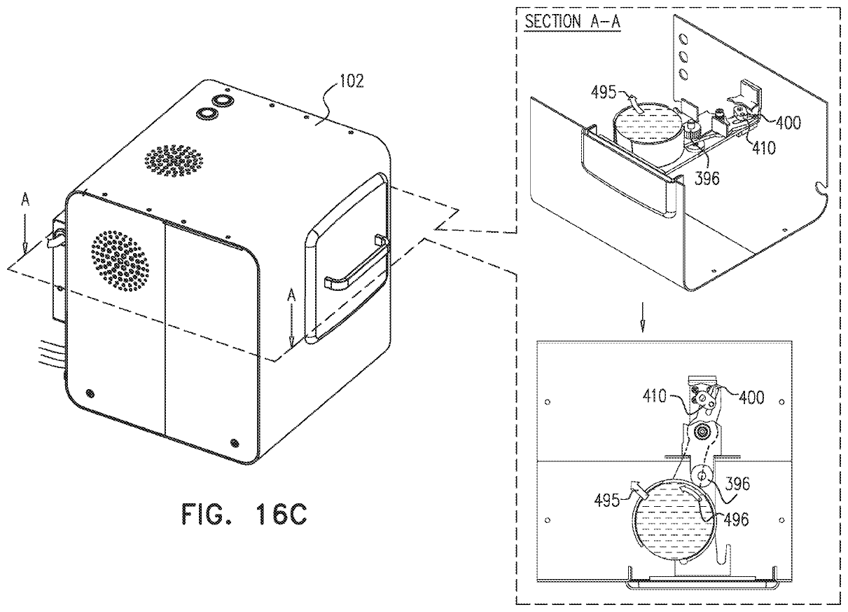

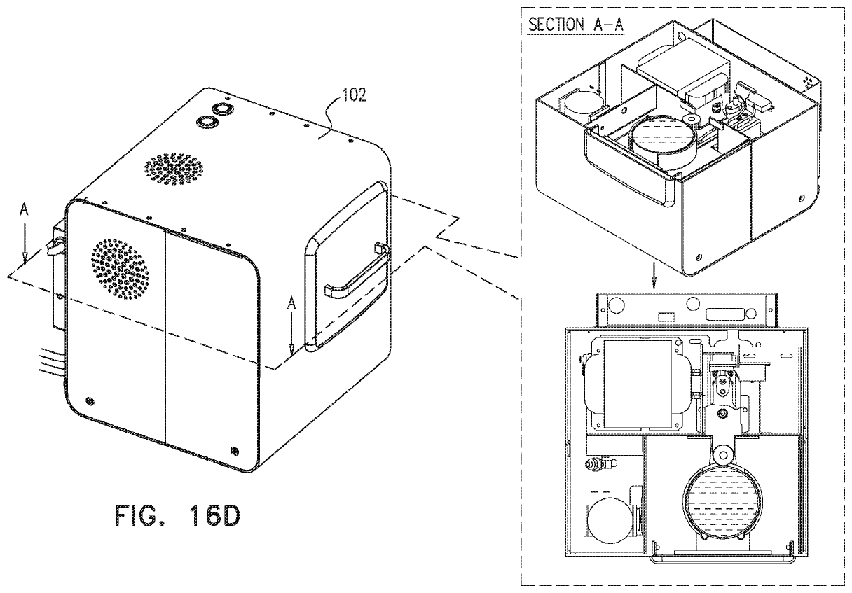

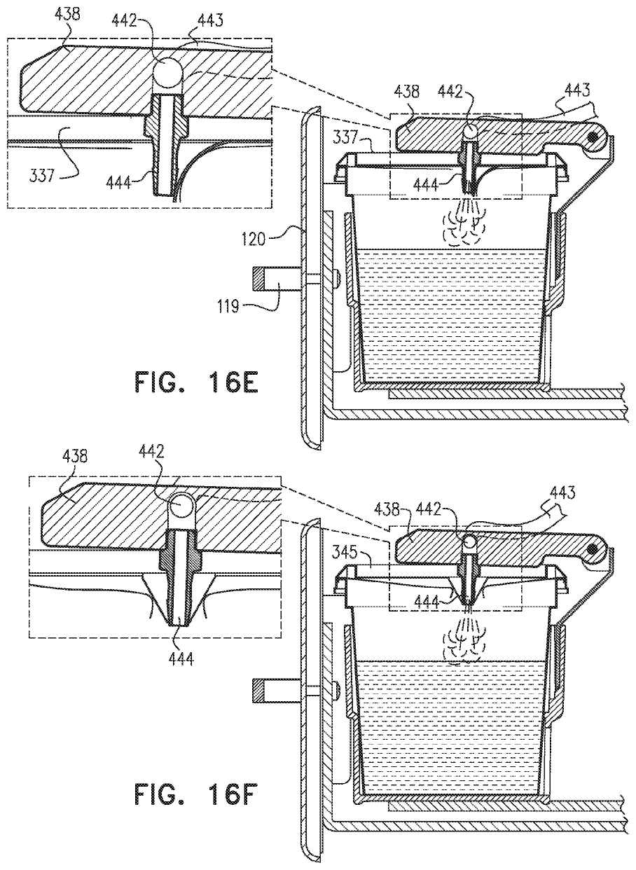

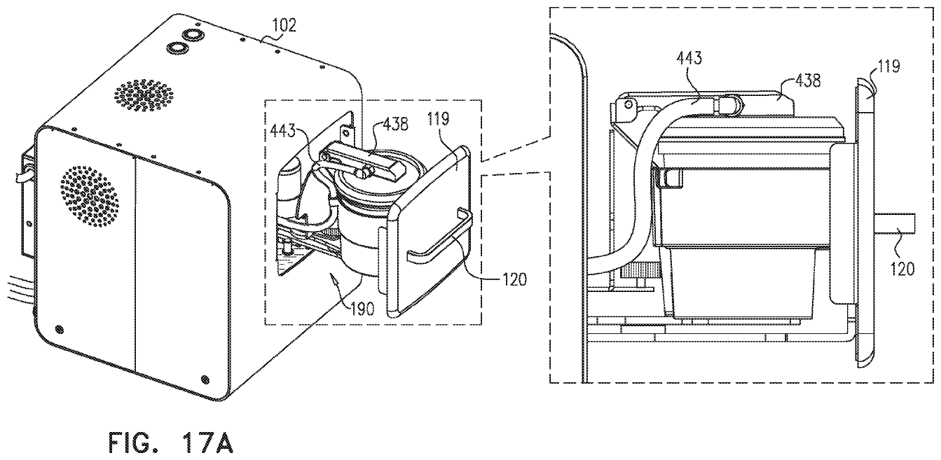

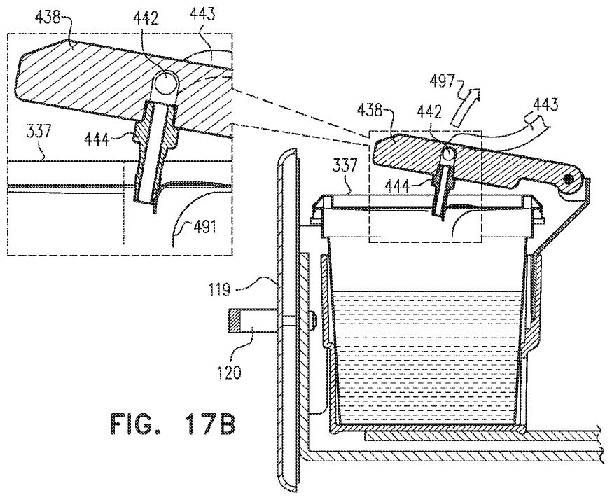

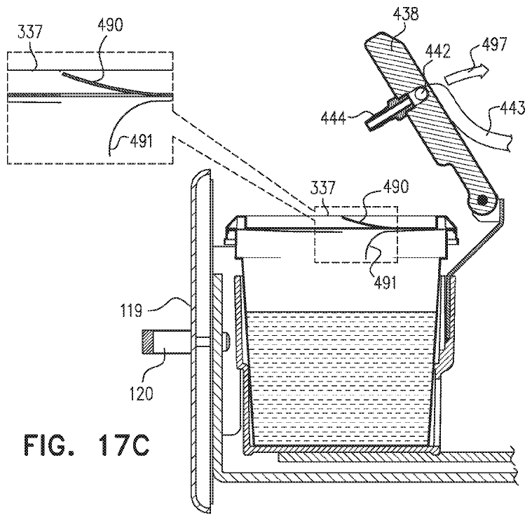

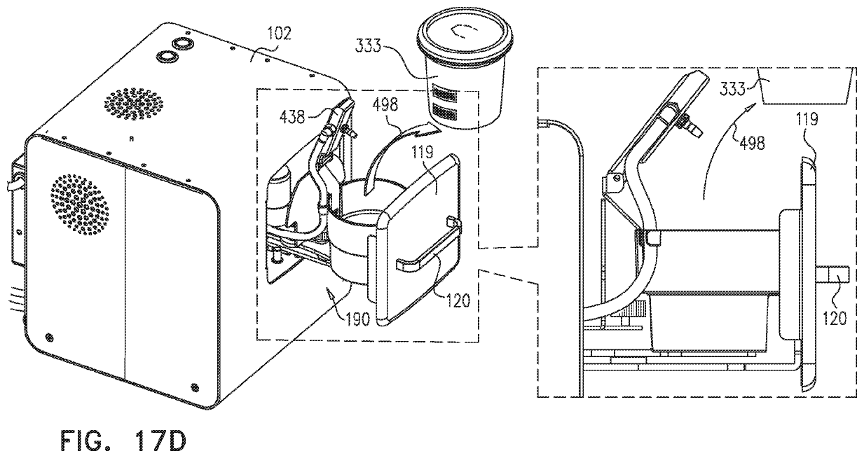

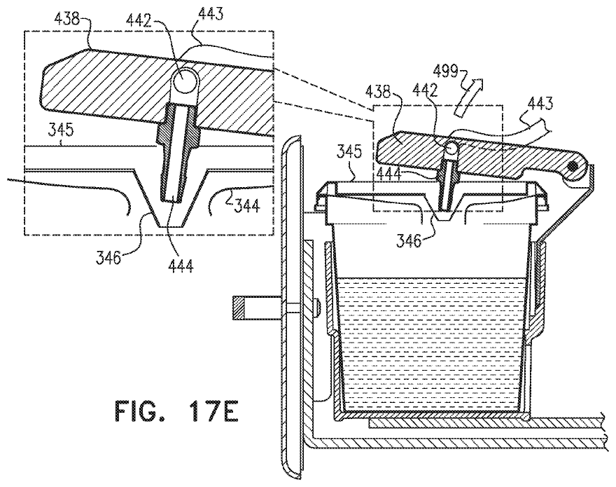

Reference is now made to FIGS. 16A, 16B, 16C, 16D and 16E, which are simplified illustrations of various stages of cooking operation of the PSCCCCDC insertion, locking, stirring and serving subsystem 190 of FIGS. 14A-14E, following full insertion thereof into main housing 102 and initiation of cooking but a user pressing button 114. It is a particular feature of an embodiment of the present invention that during cooking of the contents of a PSCCCCDC 333, PSCCCCDC insertion, locking, stirring and serving subsystem 190 is locked in its fully retracted position by operation of mechanical latch assembly 194.

It is a particular feature of an embodiment of the present invention that, as seen in FIGS. 16A-16D, stirring of the contents of PSCCCCDC 333 is achieved via external means and thus does not require insertion of a stirrer into the PSCCCCDC 333. The stirring operation is produced by operation of electric stepper motor 406, which cooperates with eccentric coupler 410, which, in turn slidably engages slot 400 of generally elongate planar element 370, causing reciprocal motion of elongate planar element 370 and thus of PSCCCCDC holding element 422, fixed thereto, as indicated by arrows 495. Additional stirring action is provided by operation of ratcheted wheel 396, which causes rotation of PSCCCCDC 333 relative to PSCCCCDC holding element 422, as indicated by arrows 496.

FIG. 16E is a simplified sectional illustration which shows insertion of fluids, such as hot water, cold water and steam, into the interior of PSCCCCDC 333 during cooking of the contents thereof.

Reference is now made to FIG. 16F, which is a simplified illustration of a stage of cooking operation of the PSCCCCDC insertion, locking, stirring and serving subsystem of FIGS. 14A-14E employing the second embodiment of a PSCCCCDC as shown in FIG. 13B. FIG. 16F corresponds to FIG. 16E and shows supply of liquid or steam into the interior of PSCCCCDC 341 during cooking of the contents thereof.

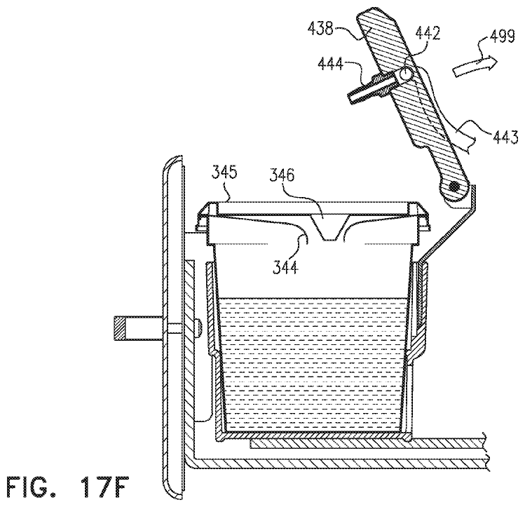

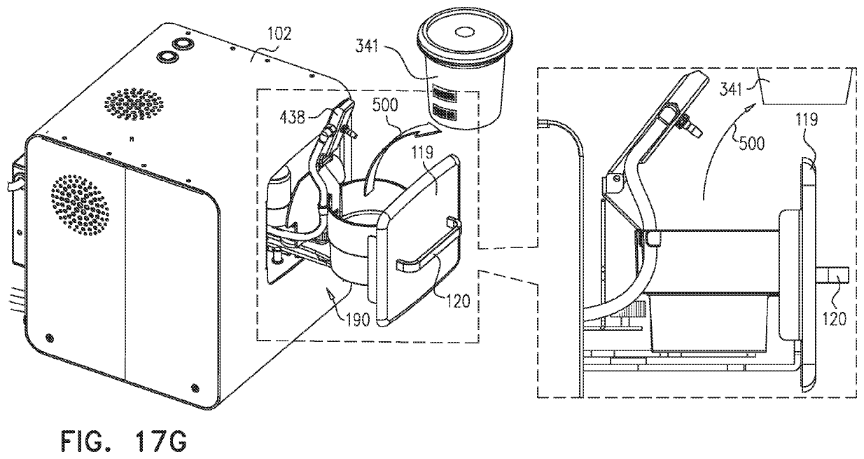

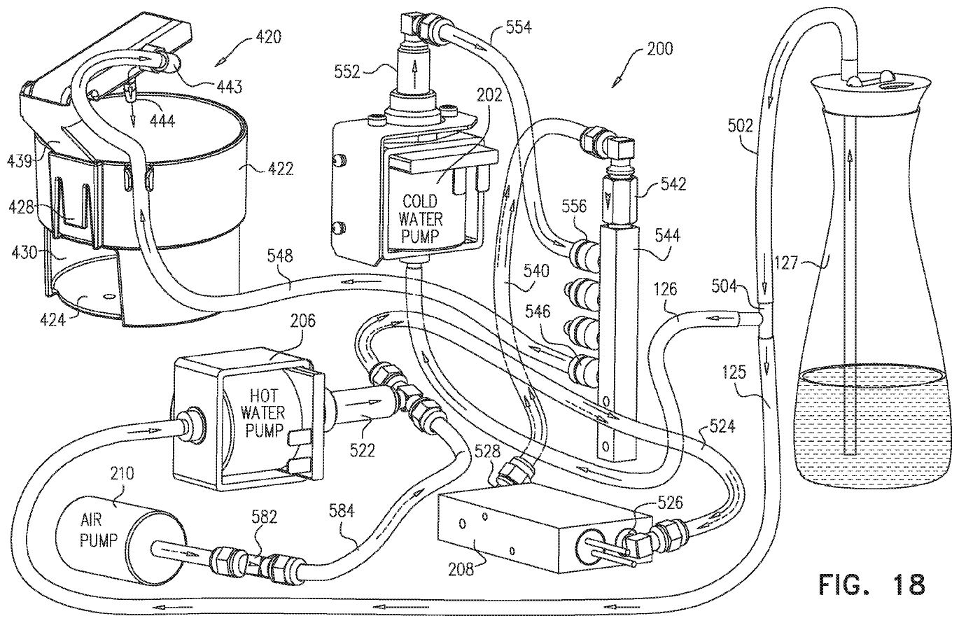

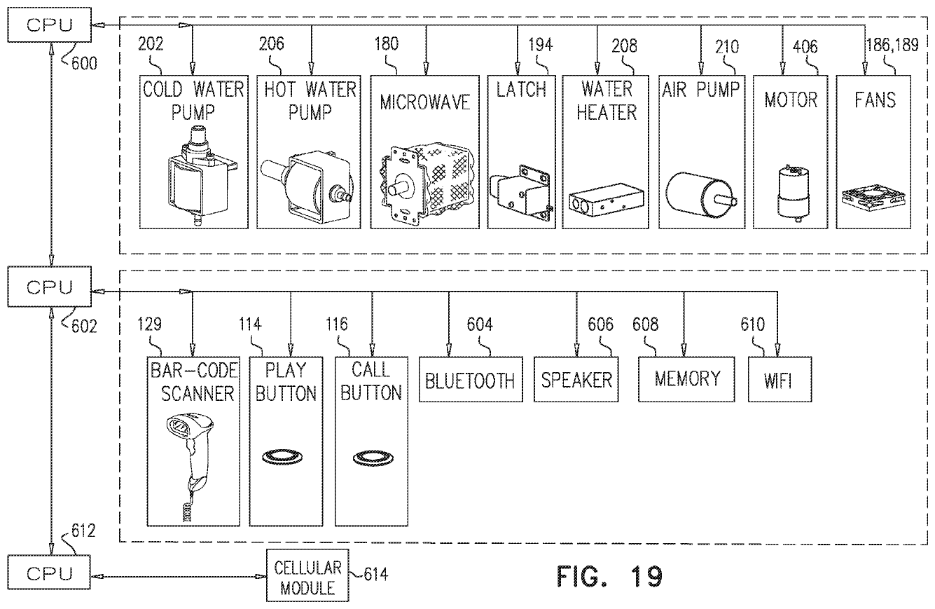

Reference is now made to FIGS. 17A, 17B, 17C and 17D, which are simplified illustrations of various stages of post-cooking operation of the PSCCCCDC insertion, locking, stirring and serving subsystem of FIGS. 14A-14E using a PSCCCCDC 333. FIG. 17A shows the system following completion of cooking and wherein PSCCCCDC insertion, locking, stirring and serving subsystem 190 is in an extended position, typically in response to a user pulling on handle 120 of door 119.

FIGS. 17B and 17C are simplified sectional illustrations showing sequential stages of raising of PSCCCCDC engagement arm 438 in a direction indicated by an arrow 497, such that barbed fluid outlet nozzle 444 of PSCCCCDC engagement arm 438 disengages from location 488 on frangible and removable lid 347 of PSCCCCDC 333 thus causing flap 490 of lid 347 to be bent upwardly and outwardly and leaving flap 491 of the underlying sealing layer 336 inwardly bent. FIG. 17D shows removal of PSCCCCDC 333 from the system following cooking as indicated by an arrow 498.

Reference is now made to FIGS. 17E, 17F and 17G, which are simplified illustrations of various stages of post-cooking operation of the PSCCCCDC insertion, locking, stirring and serving subsystem of FIGS. 14A-14E using PSCCCCDC 341.

FIGS. 17E and 17F are simplified sectional illustrations showing sequential stages of raising of PSCCCCDC engagement arm 438 in a direction indicated by an arrow 499, such that barbed fluid outlet nozzle 444 of PSCCCCDC engagement arm 438 disengages from extendible, accordion-like apertured central portion 346 of removable lid 345 of PSCCCCDC 341. FIG. 17G shows removal of PSCCCCDC 341 from the system following cooking as indicated by an arrow 500.

Reference is now made to FIG. 18, which is a simplified respective pictorial and partial exploded view illustrations of fluid supply subsystem 200, including a liquid supply subsystem and air pump 210 (FIG. 3) connect. As noted above, fluid supply subsystem 200 forms part of the computer-controlled cooking system of FIGS. 1A-3, but is only partially shown in FIGS. 1A-3.

As seen in FIG. 18, the fluid supply subsystem 200 comprises a main liquid supply tube 502, which communicates with the interior of a liquid container, such as water container 127, and is coupled, such as via a T-connector 504, with liquid supply tubes 125 and 126 (FIGS. 1A-2B).

Liquid supply tube 125 supplies water to hot water pump 206 (FIG. 3), which supplies pressurized water via a one-way valve 522 and a pressurized water tube 524 to an inlet 526 of water heater 208 (FIG. 3). Pressurized heated water or steam is supplied from an outlet 528 of water heater 208 via a heated water/steam tube 540 and a one-way valve 542 to a manifold 544, which is designed to have multiple pressurized fluid inlet/outlet connectors, most of which are seen to be closed. Pressurized heated water or steam is supplied from an outlet connector 546 of manifold 544 via a pressurized heated water/steam tube 548 to fluid inlet connector 443, fluid channel 442 and barbed fluid outlet nozzle 444 of PSCCCCDC engagement arm 438. The supply of steam is preferably useful for flushing of the various liquid supply passageways between sequential cooking operations using a given PSCCCCDC 333. It is a particular feature of an embodiment of the present invention that the flushed contents of a cooking operation may be deposited in the PSCCCCDC 333.

Liquid supply tube 126 supplies water to cold water pump 202 (FIG. 3), which supplies pressurized water, via a one-way valve 552 and pressurized water tube 554 to an inlet 556 of manifold 544. Pressurized cold water is supplied from outlet connector 546 of manifold 544 via pressurized tube 548 to fluid inlet connector 443, fluid channel 442 and barbed fluid outlet nozzle 444 of PSCCCCDC engagement arm 438.

Air pump 210 (FIG. 3) supplies pressurized air via a one-way valve 582 and a pressurized air tube 584 and tube 524 to inlet 526 of water heater 208. Pressurized heated air or steam is supplied from outlet 528 of water heater 208 via heated water/steam tube 540 and a one-way valve 542 to manifold 544, and via inlet/outlet connector 546 of manifold 544 via pressurized tube 548 to fluid inlet connector 443, fluid channel 442 and barbed fluid outlet nozzle 444 of PSCCCCDC engagement arm 438.

It is a particular feature of the present invention that, as will be described hereinbelow in detail with reference to FIG. 19, the hot water pump 206, the cold water pump 202, the air pump 210 and the water heater 208 are all computer controlled and operated at predetermined times suitable for cooking predetermined meals. Typically, the water heater 208 is operated continuously. It is appreciated that additional liquid pumps may be provided for pumping additional liquid ingredients from additional liquid storage containers 128 (FIG. 1A).

Reference is now made to FIG. 19, which is a simplified electrical functional block diagram of the electrically operated components of the computer-controlled cooking system of FIGS. 1A-3. In the illustrated embodiment, a CPU 600 preferably is in bi-directional data communication with and controls the operation of cold water pump 202, hot water pump 206, microwave heating assembly 180, mechanical latch 194, water heater 208, air pump 210, motor 406 and fans 186 and 189.

An additional CPU 602 preferably is in bi-directional data communication with CPU 600 and with buttons 114 and 116 and bar-code scanner 129 as well as a Bluetooth communicator 604, which may be used for communicating with user devices, a speaker 606, a memory 608, which preferably stores at least computerized cooking recipes, and a WIFI communicator 610, which may be used for communicating with user devices.

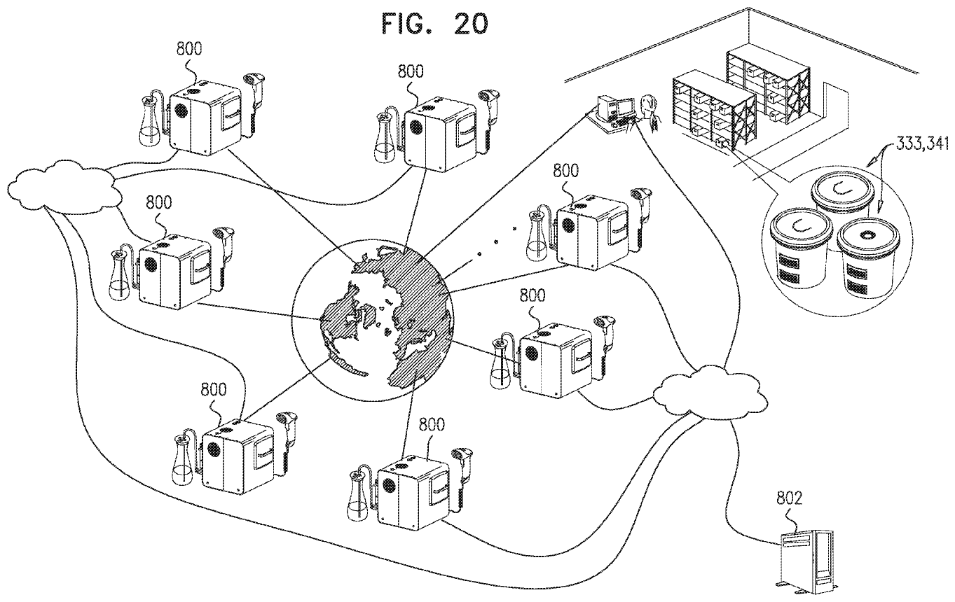

A further CPU 612 preferably is in bi-directional data communication with a cellular communications module 614 and preferably provides a network connection as described hereinbelow with reference to FIG. 20.

It is a particular feature of an embodiment of the present invention that each PSCCCCDC 333 carries a unique bar code, which is not duplicated on any other PSCCCCDC 333. This enables the purchase and use of each PSCCCCDC 333 to be individually tracked.

Reference is now made to FIG. 20, is a simplified network diagram of a cloud-based network interconnecting a multiplicity of computer-controlled cooking systems of the type illustrated in FIGS. 1A-3. As seen in FIG. 20, a multiplicity of computer-controlled cooking systems of the type illustrated in FIGS. 1A-3, here each designated by reference numeral 800, are connected in a virtual network, preferably using the internet via cellular communications module 614 to a cloud server 802 or any other suitable computer system. The various computer-controlled cooking systems 800 may also communicate directly between themselves and with other entities, such as websites of suppliers of PSCCCCDCs 333 and 341, via suitable web applications.

The network preferably enables new and modified recipes to be distributed to the various computer-controlled cooking systems 800 by cloud server 802 and to be shared among the various computer-controlled cooking systems 800. Users may also use the network to input various user inputs to the various computer-controlled cooking systems 800 by means of applications which reside on conventional mobile devices, such as smartphones. Alternatively, user input for modifying or selecting computer controlled cooking may be input to various computer-controlled cooking systems 800 via bar codes which may be user generated and read by bar code readers 129.

The network preferably enables tracking of purchase and use of specific PSCCCCDCs 333 and 341 to be tracked by the cloud server, in order to ensure that sufficient supplies of specific types of PSCCCCDCs 333 and 341 are made available to consumers. Preferably, cooking/dispensing of each PSCCCCDC 333 and 341 is reported automatically by each of the various computer-controlled cooking systems 800 to the cloud server 802 so that trends in usage of specific types of PSCCCCDCs 333 and 341 can be analyzed and predicted and quality control functionality may be provided. Accordingly, difficulties in usage of computer-controlled cooking systems 800 can also be automatically monitored, tracked and corrected.

The network also enables consumption and calorie content of cooked PSCCCCDCs 333 and 341 to be monitored for each computer-controlled cooking system 800. The network and particularly the individual coding of each PSCCCCDC 333 and 341 enables counterfeiting of PSCCCCDCs 333 and 341 to be detected and counteracted.

Reference is now made to FIGS. 21A, 21B, 21C, 21D, 21E, 21F, 21G, 21H, 21I, 21J, 21K, 21L, 21M, 21N, 21O and 21P, which are simplified schematic illustrations of operations of parts of the computer-controlled cooking system of FIGS. 1A-20B at a plurality of cooking operation stages in cooking sequence protocols described in ten examples hereinbelow. FIG. 21J shows an olive oil supply container 128 and an olive oil pump 900, as well as olive oil supply tubing 902 connecting the olive oil supply container 128, the olive oil pump 900 and manifold 544, which are not present in other figures. In each step of the sequence protocol in each example below, the corresponding schematic illustration appears in parentheses.

It is appreciated that the schematic illustrations shown in FIGS. 21A-21P are illustrative only and that other operations, not shown specifically therein may be utilized for other meal-specific cooking protocols not shown in the examples below.

Ten examples of meal-specific cooking protocols will now be set forth, each representing a predetermined sequence of computerized cooking operation stages corresponding to and specifically adapted for computerized cooking of the contents of a specific user-selected one of said plurality of different pre-sealed containers corresponding to a specific meal. The illustrations indicated in parentheses next to each numbered sub-protocol symbolically illustrate the actions occurring at each stage. It is noted that the protocols refer to supply of liquid in terms of duration of operation of pumps. In the examples which follow, the flow rate of liquid supply is typically 8 grams of water per second of pump operation.

Each of the following examples preferably employs a meal-specific pre-sealed container containing dry contents (PSCCCCDC), which contents are specifically selected and prepared for use in the specific meal which is the subject of each example. Recipes for preparation of the meal-specific PSCCCCDC used in each example are set forth at the end of each example.

### EXAMPLE 1—QUICK COOKING MACARONI AND CHEESE

COOKING OPERATION SEQUENCE:

1. (FIG. 21A) OPERATE HOT WATER PUMP 206 FOR 9 SECONDS AS FOLLOWS:

OPERATE HOT WATER PUMP 206 FOR 3 CYCLES OF 3 SECONDS DURATION EACH, EACH CYCLE BEING SEPARATED BY A REST PERIOD OF 0.5 SECOND.

2. (FIG. 21B) OPERATE COLD WATER PUMP 202 FOR 2 SECONDS.

3. (FIG. 21A) OPERATE HOT WATER PUMP 206 FOR 9 SECONDS AS FOLLOWS:

OPERATE HOT WATER PUMP 206 FOR 3 CYCLES OF 3 SECONDS DURATION EACH, EACH CYCLE BEING SEPARATED BY A REST PERIOD OF 0.5 SECOND.

4. (FIG. 21C) OPERATE MICROWAVE ENERGY GENERATING ASSEMBLY 180 FOR 25 SECONDS AND ALSO OPERATE STIRRING MOTOR 406 AS FOLLOWS:

OPERATE AIR PUMP 210 FOR 5 SECONDS.

OPERATE STIRRING MOTOR 406 FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY 180.

OPERATE FANS 186 and 189 DURING OPERATION OF MICROWAVE ENERGY GENERATING ASSEMBLY 180 AND FOR AN ADDITIONAL APPROXIMATELY 20 MINUTES THEREAFTER.

5. (FIG. 21D) OPERATE COLD WATER PUMP 202 FOR 1 SECOND.

6. (FIG. 21E) OPERATE STIRRING MOTOR 406 CONTINUOUSLY FOR 4 SECONDS.

7 (FIG. 21C) OPERATE MICROWAVE ENERGY GENERATING ASSEMBLY 180 FOR 11 SECONDS AND ALSO OPERATE STIRRING MOTOR 406 AS FOLLOWS:

OPERATE AIR PUMP 210 FOR 5 SECONDS.

OPERATE STIRRING MOTOR 406 FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY 180.

OPERATE FANS 186 AND 189 DURING OPERATION OF MICROWAVE ENERGY GENERATING ASSEMBLY 180 AND FOR AN ADDITIONAL APPROXIMATELY 20 MINUTES THEREAFTER.

8. (FIG. 21D) OPERATE COLD WATER PUMP 202 FOR 1 SECOND.

9. (FIG. 21F) OPERATE HOT WATER PUMP 206 FOR 4 SECONDS AS FOLLOWS:

OPERATE HOT WATER PUMP 206 FOR 1 CYCLE OF 3 SECONDS DURATION, FOLLOWED BY A REST PERIOD OF 0.5 SECOND.

10. (FIG. 21D) OPERATE COLD WATER PUMP 202 FOR 2 SECONDS.

11. (FIG. 21C) OPERATE MICROWAVE ENERGY GENERATING ASSEMBLY 180 FOR 4 SECONDS AND ALSO OPERATE STIRRING MOTOR 406 AS FOLLOWS:

OPERATE AIR PUMP 210 FOR 5 SECONDS.

OPERATE STIRRING MOTOR 406 FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY 180.

OPERATE FANS 186 AND 189 DURING OPERATION OF MICROWAVE ENERGY GENERATING ASSEMBLY 180 AND FOR AN ADDITIONAL APPROXIMATELY 20 MINUTES THEREAFTER.

12. (FIG. 21D) OPERATE COLD WATER PUMP 202 FOR 2 SECONDS.

13. (FIG. 21C) OPERATE MICROWAVE ENERGY GENERATING ASSEMBLY 180 FOR 5 SECONDS AND ALSO OPERATE STIRRING MOTOR 406 AS FOLLOWS:

OPERATE AIR PUMP 210 FOR 5 SECONDS.

OPERATE STIRRING MOTOR 406 FOR MULTIPLE CYCLES,

EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY 180.

OPERATE FANS 186 AND 189 DURING OPERATION OF MICROWAVE ENERGY GENERATING ASSEMBLY 180 AND FOR AN ADDITIONAL APPROXIMATELY 20 MINUTES THEREAFTER.

14. (FIG. 21E) OPERATE STIRRING MOTOR 406 FOR 500 CYCLES, EACH CYCLE HAVING A DURATION OF 0.02 SECOND FOLLOWED BY A REST PERIOD OF 0.2 SECOND.

15. (FIG. 21G) OPERATE MICROWAVE ENERGY GENERATING ASSEMBLY 180 FOR 2 SECONDS AND ALSO OPERATE STIRRING MOTOR 406 AS FOLLOWS:

OPERATE STIRRING MOTOR 406 FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY 180.

OPERATE FANS 186 AND 189 DURING OPERATION OF MICROWAVE ENERGY GENERATING ASSEMBLY 180 AND FOR AN ADDITIONAL APPROXIMATELY 20 MINUTES THEREAFTER.

16. (FIG. 21E) OPERATE STIRRING MOTOR 406 FOR 500 CYCLES, EACH CYCLE HAVING A DURATION OF 0.02 SECOND FOLLOWED BY A REST PERIOD OF 0.2 SECOND.

17. (FIG. 21G) OPERATE MICROWAVE ENERGY GENERATING ASSEMBLY 180 FOR 2 SECONDS AND ALSO OPERATE STIRRING MOTOR 406 AS FOLLOWS:

OPERATE STIRRING MOTOR 406 FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY 180.

OPERATE FANS 186 AND 189 DURING OPERATION OF MICROWAVE ENERGY GENERATING ASSEMBLY AND FOR AN ADDITIONAL APPROXIMATELY 20 MINUTES THEREAFTER.

18. (FIG. 21E) OPERATE STIRRING MOTOR 406 FOR 400 CYCLES, EACH CYCLE HAVING A DURATION OF 0.02 SECOND FOLLOWED BY A REST PERIOD OF 0.2 SECOND.

19. (FIG. 21G) OPERATE MICROWAVE ENERGY GENERATING ASSEMBLY 180 FOR 2 SECONDS AND ALSO OPERATE STIRRING MOTOR 406 AS FOLLOWS:

OPERATE STIRRING MOTOR 406 FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY 180.

OPERATE FANS 186 AND 189 DURING OPERATION OF MICROWAVE ENERGY GENERATING ASSEMBLY 180 AND FOR AN ADDITIONAL APPROXIMATELY 20 MINUTES THEREAFTER.

20. (FIG. 21D) OPERATE COLD WATER PUMP 202 FOR 1 SECOND.

21. (FIG. 21E) OPERATE STIRRING MOTOR 406 FOR 400 CYCLES, EACH CYCLE HAVING A DURATION OF 0.02 SECOND FOLLOWED BY A REST PERIOD OF 0.2 SECOND.

22. (FIG. 21E) OPERATE STIRRING MOTOR 406 FOR 300 CYCLES, EACH CYCLE HAVING A DURATION OF 0.02 SECOND FOLLOWED BY A REST PERIOD OF 0.2 SECOND.

RECIPE: QUICK COOKING MACARONI & CHEESE

DRY INGREDIENTS

| GRAMS | ITEMS |
|---|---|
| 56 | FREEZE DRIED QUICK COOKING MACARONI |
| 17 | FREEZE DRIED MILK POWDER |
| 12 | FREEZE DRIED CHEDDAR CHEESE |
| 9 | FREEZE DRIED PARMESAN CHEESE |
| 9 | FREEZE DRIED MOZZARELLA CHEESE |
| 9 | AIR DRIED PRE-COOKED COATED SEASONED |
| | ONIONS |
| 6 | FREEZE DRIED SOUR CREAM POWDER |
| 3 | TOASTED BREAD CRUMBS |
| 1.3 | SALT |
| 0.4 | GROUND NUTMEG |
| 0.3 | GROUND BLACK PEPPER |

220 GRAMS OF WATER ARE SUBSEQUENTLY ADDED DURING COOKING

### EXAMPLE 2—SCRAMBLED EGGS WITH VEGETABLES

COOKING OPERATION SEQUENCE:

1. (FIG. 21H) OPERATE COLD WATER PUMP 202 FOR 10 SECONDS.

OPERATE STIRRING MOTOR 406 DURING THE ENTIRE PERIOD OF OPERATION OF COLD WATER PUMP 202.

2. (FIG. 21I) OPERATE HOT WATER PUMP 206 FOR 19 SECONDS AS FOLLOWS:

OPERATE HOT WATER PUMP 206 FOR 6 CYCLES OF 3 SECONDS DURATION EACH, EACH CYCLE BEING SEPARATED BY A REST PERIOD OF 0.5 SECOND.

OPERATE MICROWAVE ENERGY GENERATING ASSEMBLY 180 DURING THE ENTIRE DURATION OF OPERATION OF HOT WATER PUMP 206.

OPERATE FANS 186 AND 189 DURING OPERATION OF MICROWAVE ENERGY GENERATING ASSEMBLY 180 AND FOR AN ADDITIONAL APPROXIMATELY 20 MINUTES THEREAFTER.

OPERATE STIRRING MOTOR 406 FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY 180.

3. (FIG. 21E) OPERATE STIRRING MOTOR 406 CONTINUOUSLY FOR 2 SECONDS.

4. (FIG. 21C) OPERATE MICROWAVE ENERGY GENERATING ASSEMBLY 180 FOR 35 SECONDS AND EVERY 7.50 SECONDS DURING OPERATION OF THE MICROWAVE ENERGY GENERATING ASSEMBLY 180 OPERATE AIR PUMP 210 FOR 5 SECONDS.

ALSO OPERATE STIRRING MOTOR 406 AS FOLLOWS:

OPERATE STIRRING MOTOR 406 FOR 5 CYCLES, EACH CYCLE OF 0.02 SECOND FOLLOWED BY A REST PERIOD OF 0.2 SECOND.

OPERATE FANS 186 AND 189 DURING OPERATION OF MICROWAVE ENERGY GENERATING ASSEMBLY 180 AND FOR AN ADDITIONAL APPROXIMATELY 20 MINUTES THEREAFTER.

5. (FIG. 21E) OPERATE STIRRING MOTOR 406 CONTINUOUSLY FOR 3 SECONDS.

6. (FIG. 21G) OPERATE MICROWAVE ENERGY GENERATING ASSEMBLY 180 FOR 45 SECONDS AND EVERY 7.50 SECONDS DURING OPERATION OF THE MICROWAVE ENERGY GENERATING ASSEMBLY 180.

ALSO OPERATE STIRRING MOTOR 406 AS FOLLOWS:

OPERATE STIRRING MOTOR 406 FOR 5 CYCLES, EACH CYCLE OF 0.02 SECOND FOLLOWED BY A REST PERIOD OF 0.2 SECOND.

OPERATE FANS 186 AND 189 DURING OPERATION OF MICROWAVE ENERGY GENERATING ASSEMBLY 180 AND FOR AN ADDITIONAL APPROXIMATELY 20 MINUTES THEREAFTER.

7. (FIG. 21E) OPERATE STIRRING MOTOR 406 CONTINUOUSLY FOR 2 SECONDS.

8. (FIG. 21J) OPERATE OLIVE OIL PUMP 900 TO SUPPLY 20 GRAMS OF OLIVE OIL.

RECIPE: SCRAMBLED EGGS WITH VEGETABLES

DRY INGREDIENTS:

| GRAMS | ITEMS |
|---|---|
| 26 | FREEZE DRIED EGG POWDER |
| 10 | FREEZE DRIED DICED TOMATOES |
| 6 | FREEZE DRIED PUREED TOMATO PASTE |
| 4 | FREEZE DRIED DICED WHITE ONIONS |
| 3.5 | FREEZE DRIED DICED RED PEPPERS |
| 1.6 | SALT |
| 0.5 | FREEZE DRIED PARSLEY FLAKES |
| 0.5 | WHITE SUGAR |
| 0.2 | GROUND CHILI PEPPER |
| 0.1 | FREEZE DRIED OREGANO |

165 GRAMS OF WATER ARE SUBSEQUENTLY ADDED DURING COOKING.

20 GRAMS OF OLIVE OIL ARE SUBSEQUENTLY ADDED DURING COOKING.

### EXAMPLE 3—LENTIL STEW

COOKING OPERATION SEQUENCE:

1. (FIG. 21A) OPERATE HOT WATER PUMP 206 FOR 10 SECONDS AS FOLLOWS:

OPERATE HOT WATER PUMP 206 FOR 3 CYCLES OF 3 SECONDS DURATION EACH, EACH CYCLE BEING SEPARATED BY A REST PERIOD OF 0.5 SECOND.

2. STAND BY FOR 3 SECONDS.

3. (FIG. 21K) OPERATE HOT WATER PUMP 206 FOR 10 SECONDS AS FOLLOWS:

OPERATE HOT WATER PUMP 206 FOR 3 CYCLES OF 3 SECONDS DURATION EACH, EACH CYCLE BEING SEPARATED BY A REST PERIOD OF 0.5 SECOND.

OPERATE STIRRING MOTOR 406 DURING THE ENTIRE PERIOD OF OPERATION OF HOT WATER PUMP.

4. (FIG. 21A) OPERATE HOT WATER PUMP 206 FOR 5 SECONDS AS FOLLOWS:

OPERATE HOT WATER PUMP 206 FOR 1 CYCLE OF 3 SECONDS DURATION, FOLLOWED BY A REST PERIOD OF 0.5 SECOND.

5. (FIG. 21L) OPERATE AIR PUMP 210 FOR 5 SECONDS.

6. (FIG. 21G) OPERATE MICROWAVE ENERGY GENERATING ASSEMBLY 180 FOR 20 SECONDS AND ALSO OPERATE STIRRING MOTOR 406 AS FOLLOWS:

OPERATE STIRRING MOTOR 406 FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY 180.

OPERATE FANS 186 AND 189 DURING OPERATION OF MICROWAVE ENERGY GENERATING ASSEMBLY 180 AND FOR AN ADDITIONAL APPROXIMATELY 20 MINUTES THEREAFTER.

7. STAND BY FOR 5 SECONDS.

8. (FIG. 21M) OPERATE HOT WATER PUMP 206 FOR 9 SECONDS AS FOLLOWS:

OPERATE HOT WATER PUMP 206 FOR 3 CYCLES OF 3 SECONDS DURATION EACH, EACH CYCLE BEING SEPARATED BY A REST PERIOD OF 0.5 SECOND.

OPERATE STIRRING MOTOR 406 DURING THE ENTIRE PERIOD OF OPERATION OF HOT WATER PUMP.

9. (FIG. 21F) OPERATE HOT WATER PUMP 206 FOR 5 SECONDS AS FOLLOWS:

OPERATE HOT WATER PUMP 206 FOR 1 CYCLE OF 3 SECONDS DURATION, FOLLOWED BY A REST PERIOD OF 0.5 SECONDS.

10. (FIG. 21N) OPERATE AIR PUMP 210 FOR 5 SECONDS.

11. (FIG. 21F) OPERATE THE MICROWAVE ENERGY GENERATING ASSEMBLY 180 FOR 30 SECONDS AND ALSO OPERATE STIRRING MOTOR 406 AS FOLLOWS:

OPERATE STIRRING MOTOR 406 FOR MULTIPLE CYCLES, EACH CYCLE OF 0.02 SECONDS FOLLOWED BY A REST PERIOD OF 0.2 SECONDS FOR THE DURATION OF OPERATION OF MICROWAVE ENERGY GENERATING ASSEMBLY 180.

OPERATE FANS 186 AND 189 DURING OPERATION OF MICROWAVE ENERGY GENERATING ASSEMBLY 180 AND FOR AN ADDITIONAL APPROXIMATELY 20 MINUTES THEREAFTER.

12. (FIG. 21N) OPERATE AIR PUMP 210 FOR 5 SECONDS.

13. STAND BY FOR 6 SECONDS.

14. (FIG. 21G) OPERATE MICROWAVE ENERGY GENERATING ASSEMBLY 180 FOR 20 SECONDS AND ALSO OPERATE STIRRING MOTOR 406 AS FOLLOWS:

OPERATE STIRRING MOTOR 406 FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY 180.

OPERATE FANS 186 AND 189 DURING OPERATION OF MICROWAVE ENERGY GENERATING ASSEMBLY 180 AND FOR AN ADDITIONAL APPROXIMATELY 20 MINUTES THEREAFTER.

15. STAND BY FOR 6 SECONDS.

16. (FIG. 21G) OPERATE MICROWAVE ENERGY GENERATING ASSEMBLY 180 FOR 10 SECONDS AND ALSO OPERATE STIRRING MOTOR 406 AS FOLLOWS:

OPERATE STIRRING MOTOR 406 FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY 180.

OPERATE FANS 186 AND 189 DURING OPERATION OF MICROWAVE ENERGY GENERATING ASSEMBLY 180 AND FOR AN ADDITIONAL APPROXIMATELY 20 MINUTES THEREAFTER.

17. (FIG. 21N) OPERATE AIR PUMP 210 FOR 3 SECONDS.

18. (FIG. 21G) OPERATE MICROWAVE ENERGY GENERATING ASSEMBLY 180 FOR 10 SECONDS AND ALSO OPERATE STIRRING MOTOR 406 AS FOLLOWS:

OPERATE STIRRING MOTOR 406 FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY 180.

OPERATE FANS 186 AND 189 DURING OPERATION OF MICROWAVE ENERGY GENERATING ASSEMBLY 180 AND FOR AN ADDITIONAL APPROXIMATELY 20 MINUTES THEREAFTER.

19. STAND BY FOR 2 SECONDS.

20. (FIG. 21G) OPERATE MICROWAVE ENERGY GENERATING ASSEMBLY 180 FOR 10 SECONDS AND ALSO OPERATE STIRRING MOTOR 406 AS FOLLOWS:

OPERATE STIRRING MOTOR 406 FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY 180.

OPERATE FANS 186 AND 189 DURING OPERATION OF MICROWAVE ENERGY GENERATING ASSEMBLY 180 AND FOR AN ADDITIONAL APPROXIMATELY 20 MINUTES THEREAFTER.

21. STAND BY FOR 2 SECONDS.

22. (FIG. 21G) OPERATE MICROWAVE ENERGY GENERATING ASSEMBLY 180 FOR 10 SECONDS AND ALSO OPERATE STIRRING MOTOR 406 AS FOLLOWS:

OPERATE STIRRING MOTOR 406 FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY 180.

OPERATE FANS 186 AND 189 DURING OPERATION OF MICROWAVE ENERGY GENERATING ASSEMBLY 180 AND FOR AN ADDITIONAL APPROXIMATELY 20 MINUTES THEREAFTER.

RECIPE: LENTIL STEW

DRY INGREDIENTS:

| GRAMS | ITEMS |
|---|---|
| 36 | FREEZE DRIED PRE-COOKED BASMATI RICE |
| 24 | AIR DRIED PRE-COOKED COATED SEASONED |
| | ONIONS |
| 13 | SPLIT ORANGE LENTILS |
| 8 | FREEZE DRIED BLACK LENTILS. |
| 7 | FREEZE DRIED BROWN LENTILS |
| 2 | SALT |
| 0.8 | FREEZE DRIED MINCED GARLIC |
| 0.4 | GROUND CINNAMON |
| 0.2 | GROUND CUMIN |
| 0.2 | GROUND PEPPER |
| 0.1 | GROUND CURCUMIN |

220 GRAMS OF WATER ARE SUBSEQUENTLY ADDED DURING COOKING.

### EXAMPLE 4—OATMEAL

COOKING OPERATION SEQUENCE:

1. (FIG. 21B) OPERATE COLD WATER PUMP 202 FOR 3 SECONDS.

2. (FIG. 21O) OPERATE STIRRING MOTOR 406 CONTINUOUSLY FOR 3 SECONDS.

3. (FIG. 21B) OPERATE COLD WATER PUMP 202 FOR 3 SECONDS.

4. (FIG. 21O) OPERATE STIRRING MOTOR 406 CONTINUOUSLY FOR 3 SECONDS.

5. (FIG. 21B) OPERATE COLD WATER PUMP 202 FOR 3 SECONDS.

6. (FIG. 21O) OPERATE STIRRING MOTOR 406 CONTINUOUSLY FOR 3 SECONDS.

7. (FIG. 21B) OPERATE COLD WATER PUMP 202 FOR 3 SECONDS.

8. (FIG. 21O) OPERATE STIRRING MOTOR 406 CONTINUOUSLY FOR 3 SECONDS.

9. (FIG. 21A) OPERATE HOT WATER PUMP 206 FOR 2 SECONDS.

10. (FIG. 21O) OPERATE STIRRING MOTOR 406 CONTINUOUSLY FOR 3 SECONDS.

11. (FIG. 21M) OPERATE HOT WATER PUMP 206 FOR 6 SECONDS AS FOLLOWS:

OPERATE HOT WATER PUMP 206 FOR 2 CYCLES OF 3 SECONDS DURATION EACH, EACH CYCLE BEING SEPARATED BY A REST PERIOD OF 0.5 SECOND.

OPERATE STIRRING MOTOR 406 DURING THE ENTIRE PERIOD OF OPERATION OF THE HOT WATER PUMP 206.

12. STAND BY FOR 5 SECONDS.

13. (FIG. 21I) OPERATE HOT WATER PUMP 206 FOR 6 SECONDS AS FOLLOWS:

OPERATE HOT WATER PUMP 206 FOR 2 CYCLES OF 3 SECONDS DURATION EACH, EACH CYCLE BEING SEPARATED BY A REST PERIOD OF 0.5 SECOND.

OPERATE MICROWAVE ENERGY GENERATING ASSEMBLY 180 DURING THE ENTIRE DURATION OF OPERATION OF HOT WATER PUMP 206.

OPERATE STIRRING MOTOR 406 FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY 180.

OPERATE FANS 186 AND 189 DURING OPERATION OF MICROWAVE ENERGY GENERATING ASSEMBLY 180 AND FOR AN ADDITIONAL APPROXIMATELY 20 MINUTES THEREAFTER.

14. (FIG. 21N) OPERATE AIR PUMP 210 FOR 5 SECONDS.

15. (FIG. 21C) OPERATE MICROWAVE ENERGY GENERATING ASSEMBLY 180 FOR 12 SECONDS AND ALSO OPERATE STIRRING MOTOR 406 AS FOLLOWS:

OPERATE AIR PUMP 210 FOR 5 SECONDS.

OPERATE STIRRING MOTOR 406 FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY 180.

OPERATE FANS 186 AND 189 DURING OPERATION OF MICROWAVE ENERGY GENERATING ASSEMBLY 180 AND FOR AN ADDITIONAL APPROXIMATELY 20 MINUTES THEREAFTER.

16. (FIG. 21D) OPERATE COLD WATER PUMP 202 FOR 1 SECOND.

17. (FIG. 21N) OPERATE AIR PUMP 210 FOR 5 SECONDS.

18. (FIG. 21C) OPERATE MICROWAVE ENERGY GENERATING ASSEMBLY 180 FOR 12 SECONDS AND ALSO OPERATE STIRRING MOTOR 406 AS FOLLOWS:

OPERATE STIRRING MOTOR 406 FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY 180.

OPERATE FANS 186 AND 189 DURING OPERATION OF MICROWAVE ENERGY GENERATING ASSEMBLY 180 AND FOR AN ADDITIONAL APPROXIMATELY 20 MINUTES THEREAFTER.

19. (FIG. 21D) OPERATE COLD WATER PUMP 202 FOR 1 SECOND.

20. (FIG. 21N) OPERATE AIR PUMP 210 FOR 5 SECONDS.

21. (FIG. 21G) OPERATE MICROWAVE ENERGY GENERATING ASSEMBLY 180 FOR 12 SECONDS AND ALSO OPERATE STIRRING MOTOR 406 AS FOLLOWS:

OPERATE STIRRING MOTOR 406 FOR MULTIPLE CYCLES, EACH CYCLE OF 0.02 SECOND FOLLOWED BY A REST PERIOD OF 0.2 SECONDS FOR THE DURATION OF OPERATION OF MICROWAVE ENERGY GENERATING ASSEMBLY 180.

OPERATE FANS 186 AND 189 DURING OPERATION OF MICROWAVE ENERGY GENERATING ASSEMBLY 180 AND FOR AN ADDITIONAL APPROXIMATELY 20 MINUTES THEREAFTER.

RECIPE: OATMEAL

DRY INGREDIENTS

| GRAMS | ITEMS |
|---|---|
| 40 | INSTANT OATMEAL |
| 12 | DEMERARA SUGAR |
| 9 | FREEZE DRIED BANANA SLICES, 4-5 mm THICK |
| 8 | DRIED CRANBERRIES |
| 8 | FREEZE DRIED MILK POWDER |
| 0.3 | GROUND CINNAMON |
| 0.1 | GRATED VANILLA BEAN |

185 GRAMS OF WATER ARE SUBSEQUENTLY ADDED DURING COOKING.

### EXAMPLE 5—TOMATO SOUP

COOKING OPERATION SEQUENCE:

1. (FIG. 21K) OPERATE HOT WATER PUMP 206 FOR 15 SECONDS AS FOLLOWS:

OPERATE HOT WATER PUMP 206 FOR 5 CYCLES OF 3 SECONDS DURATION EACH, EACH CYCLE BEING SEPARATED BY A REST PERIOD OF 0.5 SECOND.

OPERATE STIRRING MOTOR 406 DURING THE ENTIRE PERIOD OF OPERATION OF HOT WATER PUMP.

2. (FIG. 21C) OPERATE MICROWAVE ENERGY GENERATING ASSEMBLY 180 FOR 15 SECONDS AND EVERY 7.50 SECONDS DURING OPERATION OF MICROWAVE ENERGY GENERATING ASSEMBLY 180 ALSO OPERATE STIRRING MOTOR 406 AS FOLLOWS:

OPERATE AIR PUMP 210 FOR 5 SECONDS.

OPERATE STIRRING MOTOR 406 FOR 5 CYCLES, EACH CYCLE OF 0.02 SECOND FOLLOWED BY A REST PERIOD OF 0.2 SECOND.

OPERATE FANS 186 AND 189 DURING OPERATION OF MICROWAVE ENERGY GENERATING ASSEMBLY 180 AND FOR AN ADDITIONAL APPROXIMATELY 20 MINUTES THEREAFTER.

3. (FIG. 21I) OPERATE HOT WATER PUMP 206 FOR 10 SECONDS AS FOLLOWS:

OPERATE HOT WATER PUMP 206 FOR 3 CYCLES OF 3 SECONDS DURATION EACH, EACH CYCLE BEING SEPARATED BY A REST PERIOD OF 0.5 SECOND.

OPERATE MICROWAVE ENERGY GENERATING ASSEMBLY 180 DURING THE ENTIRE DURATION OF OPERATION OF HOT WATER PUMP 206.

OPERATE STIRRING MOTOR 406 FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY 180.

4. STAND BY FOR 5 SECONDS.

5. (FIG. 21I) OPERATE HOT WATER PUMP 206 FOR 15 SECONDS AS FOLLOWS:

OPERATE HOT WATER PUMP 206 FOR 5 CYCLES OF 3 SECONDS DURATION EACH, EACH CYCLE BEING SEPARATED BY A REST PERIOD OF 0.5 SECONDS.

OPERATE MICROWAVE ENERGY GENERATING ASSEMBLY 180 DURING THE ENTIRE DURATION OF OPERATION OF HOT WATER PUMP.

OPERATE STIRRING MOTOR 406 FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY 180.

6. (FIG. 21C) OPERATE MICROWAVE ENERGY GENERATING ASSEMBLY 180 FOR 20 SECONDS AND EVERY 7.50 SECONDS DURING OPERATION OF MICROWAVE ENERGY GENERATING ASSEMBLY 180 ALSO OPERATE STIRRING MOTOR 406 AS FOLLOWS:

OPERATE AIR PUMP 210 FOR 5 SECONDS.

OPERATE STIRRING MOTOR 406 FOR 5 CYCLES, EACH CYCLE OF 0.02 SECOND FOLLOWED BY A REST PERIOD OF 0.2 SECOND.

OPERATE FANS 186 AND 189 DURING OPERATION OF MICROWAVE ENERGY GENERATING ASSEMBLY 180 AND FOR AN ADDITIONAL APPROXIMATELY 20 MINUTES THEREAFTER.

7. (FIG. 21N) OPERATE AIR PUMP 210 FOR 5 SECONDS.

8. (FIG. 21G) OPERATE MICROWAVE ENERGY GENERATING ASSEMBLY 180 FOR 15 SECONDS AND EVERY 7.50 SECONDS DURING OPERATION OF MICROWAVE ENERGY GENERATING ASSEMBLY 180 ALSO OPERATE STIRRING MOTOR 406 AS FOLLOWS:

OPERATE STIRRING MOTOR 406 FOR 5 CYCLES, EACH CYCLE OF 0.02 SECOND FOLLOWED BY A REST PERIOD OF 0.2 SECOND.

OPERATE FANS 186 AND 189 DURING OPERATION OF MICROWAVE ENERGY GENERATING ASSEMBLY 180 AND FOR AN ADDITIONAL APPROXIMATELY 20 MINUTES THEREAFTER.

9. (FIG. 21J) OPERATE OLIVE OIL PUMP 900 TO SUPPLY 20 GRAMS OF OLIVE OIL.

RECIPE: TOMATO SOUP

DRY INGREDIENTS

| GRAMS | ITEMS |
|---|---|
| 23 | SEASONED BREAD CROUTONS |
| 12 | FREEZED DRIED PUREED TOMATOES |
| 4.5 | FREEZE DRIED TOMATO PASTE POWDER |
| 3.5 | FREEZE DRIED DICED TOMATOES |
| 2.5 | SALT |
| 2.0 | FREEZE DRIED DICED WHITE ONIONS |
| 1.5 | WHITE SUGAR |
| 0.9 | FREEZE DRIED MINCED GARLIC |
| 0.3 | FREEZE DRIED BASIL FLAKES |
| 0.2 | COARSELY GROUND BLACK PEPPER |

290 GRAMS OF WATER ARE SUBSEQUENTLY ADDED DURING COOKING.

20 GRAMS OF OLIVE OIL ARE SUBSEQUENTLY ADDED DURING COOKING.

### EXAMPLE 6—CHOCOLATE MOLTEN CAKE

COOKING OPERATION SEQUENCE:

1. (FIG. 21B) OPERATE COLD WATER PUMP 202 FOR 6 SECONDS.

2. (FIG. 21P) OPERATE STIRRING MOTOR 406 CONTINUOUSLY FOR 7 SECONDS.

3. (FIG. 21G) OPERATE MICROWAVE ENERGY GENERATING ASSEMBLY 180 FOR 5 SECONDS.

OPERATE AIR PUMP 210 FOR 5 SECONDS.

OPERATE FANS 186 AND 189 DURING OPERATION OF MICROWAVE ENERGY GENERATING ASSEMBLY 180 AND FOR AN ADDITIONAL APPROXIMATELY 20 MINUTES THEREAFTER.

4. (FIG. 21E) OPERATE STIRRING MOTOR 406 CONTINUOUSLY FOR 5 SECONDS.

5. (FIG. 21G) OPERATE MICROWAVE ENERGY GENERATING ASSEMBLY 180 FOR 40 SECONDS AND EVERY 10 SECONDS DURING OPERATION OF MICROWAVE ENERGY GENERATING ASSEMBLY 180 ALSO OPERATE STIRRING MOTOR 406 AS FOLLOWS:

OPERATE STIRRING MOTOR 406 FOR 5 CYCLES, EACH CYCLE OF 0.02 SECOND FOLLOWED BY A REST PERIOD OF 0.2 SECOND.

OPERATE FANS 186 AND 189 DURING OPERATION OF MICROWAVE ENERGY GENERATING ASSEMBLY 180 AND FOR AN ADDITIONAL APPROXIMATELY 20 MINUTES THEREAFTER.

RECIPE: CHOCOLATE MOLTEN CAKE

DRY INGREDIENTS

| GRAMS | ITEMS |
|---|---|
| 28 | WHITE SUGAR |
| 11 | STANDARD WHEAT FLOUR |
| 9 | FREEZE DRIED EGG POWDER |
| 8 | BITTERSWEET CHOCOLATE CHIPS |
| 6.5 | BAKING COCOA POWDER |
| 1.5 | BAKING POWDER |
| 0.1 | GRATED VANILLA BEAN |

40 GRAMS OF WATER ARE SUBSEQUENTLY ADDED DURING COOKING.

### EXAMPLE 7—SAVORY NOODLES

COOKING OPERATION SEQUENCE:

1. (FIG. 21K) OPERATE HOT WATER PUMP 206 FOR 5 SECONDS AS FOLLOWS:

OPERATE HOT WATER PUMP 206 FOR 1 CYCLE OF 3 SECONDS DURATION, WITH THE CYCLE FOLLOWED BY A REST PERIOD OF 0.5 SECOND.

OPERATE STIRRING MOTOR 406 DURING THE ENTIRE PERIOD OF OPERATION OF HOT WATER PUMP.

2. (FIG. 21I) OPERATE HOT WATER PUMP 206 FOR 18 SECONDS AS FOLLOWS:

OPERATE HOT WATER PUMP 206 FOR 6 CYCLES OF 3 SECONDS DURATION EACH, EACH CYCLE BEING SEPARATED BY A REST PERIOD OF 0.5 SECONDS.

OPERATE MICROWAVE ENERGY GENERATING ASSEMBLY 180 DURING THE ENTIRE DURATION OF OPERATION OF HOT WATER PUMP.

OPERATE STIRRING MOTOR 406 FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY 180.

3. (FIG. 21P) OPERATE STIRRING MOTOR 406 CONTINUOUSLY FOR 2 SECONDS.

4. (FIG. 21C) OPERATE MICROWAVE ENERGY GENERATING ASSEMBLY 180 FOR 60 SECONDS AND EVERY 10 SECONDS DURING OPERATION OF THE MICROWAVE ENERGY GENERATING ASSEMBLY 180 ALSO OPERATE STIRRING MOTOR 406 AS FOLLOWS:

OPERATE AIR PUMP 210 FOR 5 SECONDS.

OPERATE STIRRING MOTOR 406 FOR 5 CYCLES, EACH CYCLE OF 0.02 SECOND FOLLOWED BY A REST PERIOD OF 0.2 SECOND.

OPERATE FANS 186 AND 189 DURING OPERATION OF MICROWAVE ENERGY GENERATING ASSEMBLY 180 AND FOR AN ADDITIONAL APPROXIMATELY 20 MINUTES THEREAFTER.

5. (FIG. 21E) OPERATE STIRRING MOTOR 406 CONTINUOUSLY FOR 3 SECONDS.

RECIPE: SAVORY NOODLES

DRY INGREDIENTS

| GRAMS | ITEMS |
|---|---|
| 29 | FREEZE DRIED NOODLES |
| 15 | FREEZE DRIED PEANUT BUTTER POWDER |
| 12 | FREEZE DRIED COCONUT MILK POWDER |
| 11 | DICED ROASTED PEANUTS |
| 4 | FREEZE DRIED CORN KERNELS |
| 4 | FREEZE DRIED SOY POWDER |
| 3 | FREEZE DRIED SLICED WHITE BUTTON MUSHROOMS |
| 3 | FREEZE DRIED GARDEN PEAS |
| 3 | FREEZE DRIED DICED CARROTS |
| 1.5 | FREEZE DRIED MINCED GREEN ONIONS |
| 0.8 | FREEZE DRIED GRATED GINGER |
| 0.7 | FREEZE DRIED MINCED GARLIC |
| 0.2 | FREEZE DRIED CHOPPED CORIANDER LEAF FLAKES |
| 0.2 | FREEZE DRIED GRATED LEMON PEEL |
| 0.2 | FREEZE DRIED CHOPPED BASIL |

170 GRAMS OF WATER ARE SUBSEQUENTLY ADDED DURING COOKING.

### EXAMPLE 8—RED QUINOA

COOKING OPERATION SEQUENCE

1. (FIG. 21K) OPERATE HOT WATER PUMP 206 FOR 6 SECONDS AS FOLLOWS:

OPERATE HOT WATER PUMP 206 FOR 2 CYCLES OF 3 SECONDS DURATION EACH, EACH CYCLE BEING SEPARATED BY A REST PERIOD OF 0.5 SECOND.

OPERATE STIRRING MOTOR 406 DURING THE ENTIRE PERIOD OF OPERATION OF HOT WATER PUMP.

2. (FIG. 21I) OPERATE HOT WATER PUMP 206 FOR 18 SECONDS AS FOLLOWS:

OPERATE HOT WATER PUMP 206 FOR 6 CYCLES OF 3 SECONDS DURATION EACH, EACH CYCLE BEING SEPARATED BY A REST PERIOD OF 0.5 SECOND.

OPERATE MICROWAVE ENERGY GENERATING ASSEMBLY 180 DURING THE ENTIRE DURATION OF OPERATION OF HOT WATER PUMP 206.

OPERATE STIRRING MOTOR 406 FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY 180.

OPERATE FANS 186 AND 189 DURING OPERATION OF MICROWAVE ENERGY GENERATING ASSEMBLY 180 AND FOR AN ADDITIONAL APPROXIMATELY 20 MINUTES THEREAFTER.

3. (FIG. 21E) OPERATE STIRRING MOTOR 406 CONTINUOUSLY FOR 2 SECONDS.

4. (FIG. 21C) OPERATE MICROWAVE ENERGY GENERATING ASSEMBLY 180 FOR 60 SECONDS AND EVERY 10 SECONDS DURING OPERATION OF THE MICROWAVE ENERGY GENERATING ASSEMBLY 180 ALSO OPERATE STIRRING MOTOR 406 AS FOLLOWS:

OPERATE AIR PUMP 210 FOR 5 SECONDS.

OPERATE STIRRING MOTOR 406 FOR 5 CYCLES, EACH CYCLE OF 0.02 SECOND FOLLOWED BY A REST PERIOD OF 0.2 SECOND.

OPERATE FANS 186 AND 189 DURING OPERATION OF MICROWAVE ENERGY GENERATING ASSEMBLY 180 AND FOR AN ADDITIONAL APPROXIMATELY 20 MINUTES THEREAFTER.

5. (FIG. 21E) OPERATE STIRRING MOTOR 406 CONTINUOUSLY FOR 2 SECONDS.

6. (FIG. 21J) OPERATE OLIVE OIL PUMP 900 TO SUPPLY 18 GRAMS OF OLIVE OIL.

RECIPE: RED QUINOA

DRY INGREDIENTS

| GRAMS | ITEMS |
|---|---|
| 27 | RED QUINOA |
| 10 | ROASTED UNPEELED SMALL WHOLE ALMONDS |
| 7 | FREEZE DRIED WASABI COATED PEAS |
| 7 | FREEZE DRIED FIRM TOFU CUBES |
| 4 | FREEZE DRIED SOY POWDER |
| 3 | FREEZE DRIED ZUCCHINI 2 MM HALF SLICE |
| | MEDALLIONS |
| 3 | FREEZE DRIED ASPARAGUS 2 MM MEDALLIONS |
| 2 | FREEZE DRIED CHOPPED BLANCHED SPINACH |
| 1.5 | FREEZE DRIED DICED GREEN ONIONS |
| 1 | FREEZE DRIED DICED CELERY STALK |
| 0.4 | FREEZE DRIED MINCED PARSLEY |
| 0.4 | FREEZE DRIED MINCED GARLIC |
| 0.3 | GROUND BLACK PEPPER |

160 GRAMS OF HOT WATER ARE SUBSEQUENTLY ADDED DURING COOKING

18 GRAMS OF OLIVE OIL ARE SUBSEQUENTLY ADDED DURING COOKING.

### EXAMPLE 9—TOMATO PASTA

COOKING OPERATION SEQUENCE:

1. (FIG. 21A) OPERATE HOT WATER PUMP 206 FOR 1 CYCLE OF 2 SECONDS DURATION FOLLOWED BY A REST PERIOD OF 0.5 SECOND.

2. STAND BY FOR 5 SECONDS.

3. (FIG. 21K) OPERATE HOT WATER PUMP 206 FOR 9 SECONDS AS FOLLOWS:

OPERATE HOT WATER PUMP 206 FOR 3 CYCLES OF 3 SECONDS DURATION EACH, EACH CYCLE BEING SEPARATED BY A REST PERIOD OF 0.5 SECOND.

OPERATE STIRRING MOTOR 406 DURING THE ENTIRE PERIOD OF OPERATION OF HOT WATER PUMP 206.

4. (FIG. 21I) OPERATE HOT WATER PUMP 206 FOR 12 SECONDS AS FOLLOWS:

OPERATE HOT WATER PUMP 206 FOR 4 CYCLES OF 3 SECONDS DURATION EACH, EACH CYCLE BEING SEPARATED BY A REST PERIOD OF 0.5 SECOND.

OPERATE MICROWAVE ENERGY GENERATING ASSEMBLY 180 DURING THE ENTIRE DURATION OF OPERATION OF HOT WATER PUMP 206.

OPERATE STIRRING MOTOR 406 FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY 180.

OPERATE FANS 186 AND 189 DURING OPERATION OF MICROWAVE ENERGY GENERATING ASSEMBLY 180 AND FOR AN ADDITIONAL APPROXIMATELY 20 MINUTES THEREAFTER.

5. (FIG. 21C) OPERATE MICROWAVE ENERGY GENERATING ASSEMBLY 180 FOR 15 SECONDS AND EVERY 7.50 SECONDS DURING OPERATION OF MICROWAVE ENERGY GENERATING ASSEMBLY 180 ALSO OPERATE STIRRING MOTOR 406 AS FOLLOWS:

OPERATE AIR PUMP 210 FOR 5 SECONDS.

OPERATE STIRRING MOTOR 406 FOR 5 CYCLES, EACH CYCLE OF 0.02 SECOND FOLLOWED BY A REST PERIOD OF 0.2 SECOND.

OPERATE FANS 186 AND 189 DURING OPERATION OF MICROWAVE ENERGY GENERATING ASSEMBLY 180 AND FOR AN ADDITIONAL APPROXIMATELY 20 MINUTES THEREAFTER.

6. (FIG. 21I) OPERATE HOT WATER PUMP 206 FOR 9 SECONDS AS FOLLOWS:

OPERATE HOT WATER PUMP 206 FOR 3 CYCLES OF 3 SECONDS DURATION EACH, EACH CYCLE BEING SEPARATED BY A REST PERIOD OF 0.5 SECOND.

OPERATE MICROWAVE ENERGY GENERATING ASSEMBLY 180 DURING THE ENTIRE DURATION OF OPERATION OF HOT WATER PUMP 206.

OPERATE STIRRING MOTOR 406 FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY 180.

OPERATE FANS 186 AND 189 DURING OPERATION OF MICROWAVE ENERGY GENERATING ASSEMBLY 180 AND FOR AN ADDITIONAL APPROXIMATELY 20 MINUTES THEREAFTER.

7. (FIG. 21G) OPERATE MICROWAVE ENERGY GENERATING ASSEMBLY 180 FOR 15 SECONDS AND EVERY 7.50 SECONDS DURING OPERATION OF MICROWAVE ENERGY GENERATING ASSEMBLY 180 ALSO OPERATE STIRRING MOTOR 406 AS FOLLOWS:

OPERATE STIRRING MOTOR 406 FOR 5 CYCLES, EACH CYCLE OF 0.02 SECOND FOLLOWED BY A REST PERIOD OF 0.2 SECOND.

OPERATE FANS 186 AND 189 DURING OPERATION OF MICROWAVE ENERGY GENERATING ASSEMBLY 180 AND FOR AN ADDITIONAL APPROXIMATELY 20 MINUTES THEREAFTER.

8. (FIG. 21N) OPERATE AIR PUMP 210 FOR 2 SECONDS.

9. (FIG. 21G) OPERATE MICROWAVE ENERGY GENERATING ASSEMBLY 180 FOR 15 SECONDS AND EVERY 7.50 SECONDS DURING OPERATION OF THE MICROWAVE ENERGY GENERATING ASSEMBLY 180 ALSO OPERATE STIRRING MOTOR 406 AS FOLLOWS:

OPERATE STIRRING MOTOR 406 FOR 5 CYCLES, EACH CYCLE OF 0.02 SECOND FOLLOWED BY A REST PERIOD OF 0.2 SECOND.

OPERATE FANS 186 AND 189 DURING OPERATION OF MICROWAVE ENERGY GENERATING ASSEMBLY 180 AND FOR AN ADDITIONAL APPROXIMATELY 20 MINUTES THEREAFTER.

10. STAND BY FOR 4 SECONDS.

11. (FIG. 21G) OPERATE MICROWAVE ENERGY GENERATING ASSEMBLY 180 FOR 15 SECONDS AND EVERY 7.50 SECONDS DURING OPERATION OF THE MICROWAVE ENERGY GENERATING ASSEMBLY 180 ALSO OPERATE STIRRING MOTOR 406 AS FOLLOWS:

OPERATE STIRRING MOTOR 406 FOR 5 CYCLES, EACH CYCLE OF 0.02 SECOND FOLLOWED BY A REST PERIOD OF 0.2 SECOND.

OPERATE FANS 186 AND 189 DURING OPERATION OF MICROWAVE ENERGY GENERATING ASSEMBLY 180 AND FOR AN ADDITIONAL APPROXIMATELY 20 MINUTES THEREAFTER.

12. (FIG. 21N) OPERATE AIR PUMP 210 FOR 2 SECONDS.

13. (FIG. 21G) OPERATE MICROWAVE ENERGY GENERATING ASSEMBLY 180 FOR 15 SECONDS AND EVERY 7.50 SECONDS DURING OPERATION OF THE MICROWAVE ENERGY GENERATING ASSEMBLY 180 ALSO OPERATE STIRRING MOTOR 406 AS FOLLOWS:

OPERATE STIRRING MOTOR 406 FOR 5 CYCLES, EACH CYCLE OF 0.02 SECOND FOLLOWED BY A REST PERIOD OF 0.2 SECOND.

OPERATE FANS 186 AND 189 DURING OPERATION OF MICROWAVE ENERGY GENERATING ASSEMBLY 180 AND FOR AN ADDITIONAL APPROXIMATELY 20 MINUTES THEREAFTER.

14. STAND BY FOR 4 SECONDS.

15. (FIG. 21G) OPERATE MICROWAVE ENERGY GENERATING ASSEMBLY 180 FOR 15 SECONDS AND EVERY 7.50 SECONDS DURING OPERATION OF MICROWAVE ENERGY GENERATING ASSEMBLY 180 ALSO OPERATE STIRRING MOTOR 406 AS FOLLOWS:

OPERATE STIRRING MOTOR 406 FOR 5 CYCLES, EACH CYCLE OF 0.02 SECOND FOLLOWED BY A REST PERIOD OF 0.2 SECOND.

OPERATE FANS 186 AND 189 DURING OPERATION OF MICROWAVE ENERGY GENERATING ASSEMBLY 180 AND FOR AN ADDITIONAL APPROXIMATELY 20 MINUTES THEREAFTER.

16. STAND BY FOR 8 SECONDS.

17. (FIG. 21G) OPERATE MICROWAVE ENERGY GENERATING ASSEMBLY 180 FOR 15 SECONDS AND EVERY 7.50 SECONDS DURING OPERATION OF MICROWAVE ENERGY GENERATING ASSEMBLY 180 ALSO OPERATE STIRRING MOTOR 406 AS FOLLOWS:

OPERATE STIRRING MOTOR 406 FOR 5 CYCLES, EACH CYCLE OF 0.02 SECOND FOLLOWED BY A REST PERIOD OF 0.2 SECOND.

OPERATE FANS 186 AND 189 DURING OPERATION OF MICROWAVE ENERGY GENERATING ASSEMBLY 180 AND FOR AN ADDITIONAL APPROXIMATELY 20 MINUTES THEREAFTER.

18. (FIG. 21J) OPERATE OLIVE OIL PUMP 900 TO SUPPLY 18 GRAMS OF OLIVE OIL.

RECIPE: TOMATO PASTA

DRY INGREDIENTS

| GRAMS | ITEMS |
|---|---|
| 45 | QUICK COOKING ELBOW PASTA |
| 10 | FREEZE DRIED PUREED TOMATOES |
| 5 | FREEZE DRIED DICED TOMATOES |
| 4 | TOMATO PASTE POWDER |
| 2.5 | SALT |
| 1.7 | WHITE SUGAR |
| 0.8 | FREEZE DRIED GARLIC POWDER |
| 0.3 | FREEZE DRIED BASIL |
| 0.2 | GROUND CHILI PEPPER |
| 0.2 | FREEZE DRIED FINELY GROUND BEET POWDER |
| 0.2 | FREEZE DRIED OREGANO |

245 GRAMS OF WATER ARE ADDED SUBSEQUENTLY DURING COOKING.

12 GRAMS OF OLIVE OIL ARE SUBSEQUENTLY ADDED DURING COOKING.

### EXAMPLE 10 COUSCOUS

COOKING OPERATION SEQUENCE:

1. (FIG. 21A) OPERATE HOT WATER PUMP 206 FOR 30 SECONDS AS FOLLOWS:

OPERATE HOT WATER PUMP 206 FOR 10 CYCLES OF 3 SECONDS DURATION EACH, EACH CYCLE BEING SEPARATED BY A REST PERIOD OF 0.5 SECOND.

2. (FIG. 21I) OPERATE HOT WATER PUMP 206 FOR 7 SECONDS AS FOLLOWS:

OPERATE HOT WATER PUMP 206 FOR 2 CYCLES OF 3 SECONDS DURATION EACH, EACH CYCLE BEING SEPARATED BY A REST PERIOD OF 0.5 SECOND.

OPERATE MICROWAVE ENERGY GENERATING ASSEMBLY 180 DURING THE ENTIRE DURATION OF OPERATION OF HOT WATER PUMP 206.

OPERATE STIRRING MOTOR 406 FOR MULTIPLE CYCLES, EACH CYCLE OF 0.02 SECOND FOLLOWED BY A REST PERIOD OF 0.2 SECONDS FOR THE 7 SECONDS DURATION OF OPERATION OF MICROWAVE ENERGY GENERATING ASSEMBLY 180.

OPERATE FANS 186 AND 189 DURING OPERATION OF MICROWAVE ENERGY GENERATING ASSEMBLY 180 AND FOR AN ADDITIONAL APPROXIMATELY 20 MINUTES THEREAFTER.

3. (FIG. 21I) OPERATE HOT WATER PUMP 206 FOR 4 SECONDS AS FOLLOWS:

OPERATE HOT WATER PUMP 206 FOR 1 CYCLE OF 3 SECONDS DURATION, WITH A REST PERIOD OF 0.5 SECONDS, FOLLOWED BY 1 CYCLE OF 1 SECOND DURATION.

OPERATE MICROWAVE ENERGY GENERATING ASSEMBLY 180 DURING THE ENTIRE 4 SECONDS DURATION OF OPERATION OF HOT WATER PUMP 206.

OPERATE STIRRING MOTOR 406 FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY 180.

OPERATE FANS 186 AND 189 DURING OPERATION OF MICROWAVE ENERGY GENERATING ASSEMBLY 180 AND FOR AN ADDITIONAL APPROXIMATELY 20 MINUTES THEREAFTER.

4. (FIG. 21G) OPERATE MICROWAVE ENERGY GENERATING ASSEMBLY 180 FOR 15 SECONDS AND ALSO OPERATE STIRRING MOTOR 406 AS FOLLOWS:

OPERATE AIR PUMP 210 FOR 5 SECONDS.

OPERATE STIRRING MOTOR 406 FOR MULTIPLE CYCLES, EACH CYCLE OF 0.02 SECOND FOLLOWED BY A REST PERIOD OF 0.2 SECONDS FOR THE DURATION OF OPERATION OF MICROWAVE ENERGY GENERATING ASSEMBLY 180.

OPERATE FANS 186 AND 189 DURING OPERATION OF MICROWAVE ENERGY GENERATING ASSEMBLY 180 AND FOR AN ADDITIONAL APPROXIMATELY 20 MINUTES THEREAFTER.

5. (FIG. 21G) OPERATE MICROWAVE ENERGY GENERATING ASSEMBLY 180 FOR 15 SECONDS AND ALSO OPERATE STIRRING MOTOR 406 AS FOLLOWS:

OPERATE STIRRING MOTOR 406 FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY 180.

OPERATE FANS 186 AND 189 DURING OPERATION OF MICROWAVE ENERGY GENERATING ASSEMBLY 180 AND FOR AN ADDITIONAL APPROXIMATELY 20 MINUTES THEREAFTER.

6. (FIG. 21G) OPERATE MICROWAVE ENERGY GENERATING ASSEMBLY 180 FOR 15 SECONDS AND ALSO OPERATE STIRRING MOTOR 406 AS FOLLOWS:

OPERATE STIRRING MOTOR 406 FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY 180.

OPERATE FANS 186 AND 189 DURING OPERATION OF MICROWAVE ENERGY GENERATING ASSEMBLY 180 AND FOR AN ADDITIONAL APPROXIMATELY 20 MINUTES THEREAFTER.

7. (FIG. 21G) OPERATE MICROWAVE ENERGY GENERATING ASSEMBLY 180 FOR 15 SECONDS AND ALSO OPERATE STIRRING MOTOR 406 AS FOLLOWS:

OPERATE STIRRING MOTOR 406 FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY 180.

OPERATE FANS 186 AND 189 DURING OPERATION OF MICROWAVE ENERGY GENERATING ASSEMBLY 180 AND FOR AN ADDITIONAL APPROXIMATELY 20 MINUTES THEREAFTER.

8. (FIG. 21G) OPERATE MICROWAVE ENERGY GENERATING ASSEMBLY 180 FOR 15 SECONDS AND ALSO OPERATE STIRRING MOTOR 406 AS FOLLOWS:

OPERATE STIRRING MOTOR FOR MULTIPLE CYCLES, EACH CYCLE OF 0.02 SECOND FOLLOWED BY A REST PERIOD OF 0.2 SECOND FOR THE DURATION OF OPERATION OF THE MICROWAVE ENERGY GENERATING ASSEMBLY 180.

OPERATE FANS 186 AND 189 DURING OPERATION OF MICROWAVE ENERGY GENERATING ASSEMBLY 180 AND FOR AN ADDITIONAL APPROXIMATELY 20 MINUTES THEREAFTER.

9. (FIG. 21G) OPERATE MICROWAVE ENERGY GENERATING ASSEMBLY 180 FOR 5 SECONDS AND ALSO OPERATE STIRRING MOTOR 406 AS FOLLOWS:

OPERATE STIRRING MOTOR 406 FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY 180.

OPERATE FANS 186 AND 189 DURING OPERATION OF MICROWAVE ENERGY GENERATING ASSEMBLY 180 AND FOR AN ADDITIONAL APPROXIMATELY 20 MINUTES THEREAFTER.

10. (FIG. 21G) OPERATE MICROWAVE ENERGY GENERATING ASSEMBLY 180 FOR 5 SECONDS AND ALSO OPERATE STIRRING MOTOR 406 AS FOLLOWS:

OPERATE STIRRING MOTOR 406 FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY 180.

OPERATE FANS 186 AND 189 DURING OPERATION OF MICROWAVE ENERGY GENERATING ASSEMBLY 180 AND FOR AN ADDITIONAL APPROXIMATELY 20 MINUTES THEREAFTER.

11. (FIG. 21G) OPERATE MICROWAVE ENERGY GENERATING ASSEMBLY 180 FOR 5 SECONDS AND ALSO OPERATE STIRRING MOTOR 406 AS FOLLOWS:

OPERATE STIRRING MOTOR 406 FOR MULTIPLE CYCLES, EACH CYCLE OF 0.02 SECOND FOLLOWED BY A REST PERIOD OF 0.2 SECOND FOR THE DURATION OF OPERATION OF THE MICROWAVE ENERGY GENERATING ASSEMBLY 180.

OPERATE FANS 186 AND 189 DURING OPERATION OF MICROWAVE ENERGY GENERATING ASSEMBLY 180 AND FOR AN ADDITIONAL APPROXIMATELY 20 MINUTES THEREAFTER.

12. (FIG. 2G) OPERATE MICROWAVE ENERGY GENERATING ASSEMBLY 180 FOR 5 SECONDS AND ALSO OPERATE STIRRING MOTOR 406 AS FOLLOWS:

OPERATE STIRRING MOTOR 406 FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY 180.

OPERATE FANS 186 AND 189 DURING OPERATION OF MICROWAVE ENERGY GENERATING ASSEMBLY 180 AND FOR AN ADDITIONAL APPROXIMATELY 20 MINUTES THEREAFTER.

13. (FIG. 21G) OPERATE MICROWAVE ENERGY GENERATING ASSEMBLY 180 FOR 5 SECONDS AND ALSO OPERATE STIRRING MOTOR 406 AS FOLLOWS:

OPERATE STIRRING MOTOR 406 FOR MULTIPLE CYCLES, EACH CYCLE OF 0.02 SECOND FOLLOWED BY A REST PERIOD OF 0.2 SECOND FOR THE DURATION OF OPERATION OF MICROWAVE ENERGY GENERATING ASSEMBLY 180.

OPERATE FANS 186 AND 189 DURING OPERATION OF MICROWAVE ENERGY GENERATING ASSEMBLY 180 AND FOR AN ADDITIONAL APPROXIMATELY 20 MINUTES THEREAFTER.

14. (FIG. 21J) OPERATE OLIVE OIL PUMP 900 TO SUPPLY 18 GRAMS OF OLIVE OIL.

15. STAND BY FOR 30 SECONDS.

RECIPE—COUSCOUS

DRY INGREDIENTS

| GRAMS | ITEMS |
|---|---|
| 57 | INSTANT MEDIUM SIZE COUSCOUS |
| 12 | DRIED CRANBERRIES |
| 12 | FREEZE DRIED ROASTED SMALL UNPEELED |
| | ALMONDS |
| 10 | FREEZE DRIED PRE-COOKED HADAS CHICKPEAS |
| 5 | FREEZE DRIED DICED CARROTS |
| 2 | SALT |
| 0.4 | GROUND CINNAMON |
| 0.3 | FREEZE DRIED CORIANDER LEAF FLAKES |
| 0.2 | GROUND CURCUMIN |
| 0.2 | GROUND HOT PAPRIKA |

220 GRAMS OF WATER ARE SUBSEQUENTLY ADDED DURING COOKING.

12 GRAMS OF OLIVE OIL ARE SUBSEQUENTLY ADDED DURING COOKING.

It will be appreciated by persons skilled in the art that the present invention is not limited by what has been particularly shown and described hereinabove but includes generalizations and alternatives thereof which are not shown in the prior art.

1. An automated, computer-controlled, cooking system for use with user selectable ones of a plurality of different pre-sealed computerized cooking containers containing dry contents (PSCCCCDC) useful in preparing corresponding different food products, the system comprising:
a microwave heater;
a PSCCCCDC support for supporting a user-selected one of said plurality of different PSCCCCDCs during cooking;
a computer-controlled liquid supply subsystem for supplying liquid to said user selected one of said plurality of different PSCCCCDCs;
a computer-controlled stirrer subsystem for producing stirring of said dry contents of said PSCCCCDC together with said liquid; and
a computer controller operative to control operation of at least said computer-controlled liquid supply subsystem, said computer-controlled stirrer subsystem and said microwave heater in a predetermined sequence corresponding to and specifically adapted for cooking the contents of said user-selected one of said plurality of different PSCCCCDCs.

2. An automated, computer-controlled, cooking system according to claim 1 and wherein said predetermined sequence defines a computer implementable cooking protocol which comprises a sequence of cooking sub-protocols each of which defines at least one parameter relating to operation of said microwave heater and at least one of a parameter relating to operation of said computer-controlled liquid supply subsystem and at least one parameter relating to operation of said computer-controlled stirrer subsystem.

3. An automated, computer-controlled, cooking system according to claim 1 and wherein said predetermined sequence defines a computer implementable cooking protocol which comprises a sequence of cooking sub-protocols each of which defines at least one parameter relating to operation of said microwave heater and at least one parameter relating to operation of said computer-controlled liquid supply subsystem.

4. An automated, computer-controlled, cooking system according to claim 1 and wherein said predetermined sequence defines a computer implementable cooking protocol which comprises a sequence of cooking sub-protocols each of which defines at least one parameter relating to operation of said microwave heater and at least one parameter relating to operation of said computer-controlled stirrer subsystem.

5. An automated, computer-controlled, cooking system according to claim 1 and wherein said predetermined sequence defines a computer implementable cooking protocol which comprises a sequence of cooking sub-protocols each of which defines at least one parameter relating to operation of said microwave heater, at least one parameter relating to operation of said computer-controlled liquid supply subsystem and at least one parameter relating to operation of said computer-controlled stirrer subsystem.

6. An automated, computer-controlled, cooking system according to claim 1 and wherein said computer-controlled liquid supply subsystem for supplying liquid to said user selected one of said plurality of different PSCCCCDCs comprises a first water pump for pumping cold water and at least one second water pump for pumping heated water.

7. An automated, computer-controlled, cooking system according to claim 1 and wherein said computer-controlled liquid supply subsystem for supplying liquid to said user selected one of said plurality of different PSCCCCDCs comprises a heated water and/or steam generator.

8. An automated, computer-controlled, cooking system according to claim 1 and wherein said computer-controlled stirrer subsystem for producing stirring of said dry contents of said PSCCCCDC together with said liquid is operative to effect stirring of contents of said user selected PSCCCCDC only by moving said PSCCCCDC.

9. An automated, computer-controlled, cooking system according to claim 1 and wherein said computer-controlled stirrer subsystem for producing stirring of said dry contents of said PSCCCCDC together with said liquid includes a rotary drive motor and a linkage which are together operative to displace said PSCCCCDC support in reciprocal motion.

10. An automated, computer-controlled, cooking system according to claim 1 and wherein said computer-controlled stirrer subsystem for producing stirring of said dry contents of said PSCCCCDC together with said liquid includes a PSCCCCDC rotator which is operative to displace said PSCCCCDC in rotational motion relative to said PSCCCCDC support.

11. An automated, computer-controlled, cooking system for use with user selectable ones of a plurality of different pre-sealed computerized cooking containers containing dry contents (PSCCCCDCs) useful in preparing corresponding different food products, the system comprising:
a microwave heater; and
a PSCCCCDC support for supporting a user selected one of said plurality of different PSCCCCDCs during cooking and including a passive, microwave heatable portion, which is positioned for conduction heating of said PSCCCCDC.

12. An automated, computer-controlled, cooking system according to claim 11 and wherein said passive, microwave heatable portion comprises a layer of silicon carbide.

13. An automated, computer-controlled, cooking system according to claim 11 and also comprising a computer-controlled liquid supply subsystem for supplying heated liquid to said user selected one of said plurality of different PSCCCCDCs.

14. An automated, computer-controlled, cooking system according to claim 11 and also comprising a computer-controlled stirrer subsystem for producing stirring of said dry contents of said PSCCCCDC together with said liquid by moving said PSCCCCDC support.

15. An automated, computer-controlled, cooking system according to claim 11 and also comprising a computer controller operative to control operation of at least said microwave heater in a predetermined sequence corresponding to and specifically adapted for cooking the contents of said user-selected one of said plurality of different PSCCCCDCs.

16. An automated, computer-controlled, cooking system for use with user selectable ones of a plurality of different pre-sealed computerized cooking containers containing dry contents (PSCCCCDC) useful in preparing corresponding different food products, according to claim 1 and wherein said PSCCCCDC support comprises a passive, microwave heatable portion, which is positioned for conduction heating of said PSCCCCDC.

17. An automated, computer-controlled, cooking system according to claim 16 and wherein said passive, microwave heatable portion comprises a layer of silicon carbide.

18. An automated, computer-controlled, cooking system according to claim 16 and also comprising a computer-controlled liquid supply subsystem for supplying heated liquid to said user selected one of said plurality of different PSCCCCDCs.

19. An automated, computer-controlled, cooking system according to claim 16 and also comprising a computer-controlled stirrer subsystem for producing stirring of said dry contents of said PSCCCCDC together with said liquid by moving said PSCCCCDC support.

20. An automated, computer-controlled, cooking system according to claim 11 and also comprising a computer controller operative to control operation of at least said microwave heater in a predetermined sequence corresponding to and specifically adapted for cooking the contents of said user-selected one of said plurality of different pre-sealed PSCCCCDCs.

21-209. (canceled)
